(19) United States
(12) Patent Application Publication
(10) Pub. No.: US 2025/0350327 A1
(43) Pub. Date: Nov. 13, 2025

(54) METHOD AND APPARATUS FOR TRANSMITTING AND RECEIVING SIGNALS IN WIRELESS COMMUNICATION SYSTEMS

(71) Applicant: Samsung Electronics Co., Ltd., Suwon-si (KR)

(72) Inventors: Seongmok LIM, Suwon-si (KR); Youngrok JANG, Suwon-si (KR); Hyoungju JI, Suwon-si (KR)

(21) Appl. No.: 19/203,520

(22) Filed: May 9, 2025

(30) Foreign Application Priority Data
May 10, 2024 (KR) 10-2024-0062193

(51) Int. Cl. H04B 7/0456; H04L 5/00; H04W 72/1268; H04W 72/23

(52) U.S. Cl. CPC H04B 7/0486; H04L 5/0048; H04L 5/0055; H04W 72/1268; H04W 72/23

(57) ABSTRACT

A method performed by a user equipment (UE) is provided. The method includes receiving, from a base station, via a radio resource control (RRC) signaling, information related to sounding reference signal (SRS) resource set and phase tracking reference signal (PTRS) uplink (UL) configuration information including a parameter indicating a maximum number of UL PTRS ports, receiving a downlink control information (DCI) format 0_1 including a SRS resource set indicator (SRSI) field and a first PTRS-demodulation reference signal (DMRS) association field, when two SRS resource sets associated with a usage of value ‘nonCodeBook’ or ‘CodeBook’ are configured based on the information related to SRS resource set, determining a number of bits of the SRSI field as 2bits, and based on the 2bits SRSI field and the parameter indicating the maximum number of ports, determining a number of bits of the first PTRS-DMRS association field as 1 bit or 2 bits.

### CROSS-REFERENCE TO RELATED APPLICATION(S)

This application is based on and claims priority under 35 U.S.C. § 119(a) of a Korean patent application number 10-2024-0062193, filed on May 10, 2024, in the Korean Intellectual Property Office, the disclosure of which is incorporated by reference herein in its entirety.

### BACKGROUND

### 1. Field

The disclosure relates to operations of a user equipment (UE) and a base station (BS) in a wireless communication system (or, a mobile communication system). More particularly, the disclosure relates to, in a wireless communication system, a method of performing uplink transmission by using a plurality of antennas, a method of configuring a reference signal for phase tracking in reference signal transmission for a corresponding operation, a method of transmitting a configured reference signal with a scheduled uplink channel, and an apparatus for performing the methods.

### 2. Description of Related Art

A 5^{th} generation (5G) mobile communication technology defines a broad frequency band to enable a high date rate and new services, and may be implemented not only in a ‘Sub 6 GHz’ band including 3.5 GHz but also in an ultra high frequency band (‘Above 6 GHz’) referred to as millimeter wave (mmWave) including 28 GHz, 39 GHz, and the like. In addition, for a 6^{th} generation (6G) mobile communication technology referred to as a system beyond 5G communication (beyond 5G), in order to achieve a data rate fifty times faster than the 5G mobile communication technology and ultra-low latency one-tenth of the 5G mobile communication technology, implementation of the 6G mobile communication technology in the terahertz band (e.g., the 95 GHz to 3 THz band) is being considered.

In the early phase of the development of the 5G mobile communication technology, in order to support services and satisfy performance requirements of enhanced mobile broadband (eMBB), ultra reliable low latency communications (URLLC), and massive machine-type communications (mMTC), there has been ongoing standardization about beamforming and massive multiple input multiple output (MIMO) for mitigating pathloss of radio waves and increasing transmission distances of radio wave in a mmWave band, supporting numerologies (for example, operation of multiple subcarrier spacings) for efficiently utilizing mmWave resources and dynamic operation of slot formats, initial access technologies for supporting multi-beam transmission and broadband, definition and operation of bandwidth part (BWP), new channel coding methods, such as a low density parity check (LDPC) code for a large amount of data transmission and a polar code for highly reliable transmission of control information, layer 2 (L2) pre-processing, and network slicing for providing a dedicated network specialized to a specific service.

Currently, there are ongoing discussions about improvement and performance enhancement of initial 5G mobile communication technologies based on services to be supported by the 5G mobile communication technology, and there has been physical layer standardization of technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) that is UE-satellite direct communication for providing coverage in an area in which communication with terrestrial networks is unavailable, and positioning.

Moreover, there has been ongoing standardization of air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR), and standardization of system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

When the 5G mobile communication system is commercialized, connected devices being on a rapidly increasing trend are being predicted to be connected to communication networks, and therefore, it is predicted that enhancement of functions and performance of the 5G mobile communication system and integrated operations of the connected devices are required. To this end, new researches are scheduled for extended reality (XR) for efficiently supporting augmented reality (AR), virtual reality (VR), and the like, 5G performance improvement and complexity reduction by utilizing artificial intelligence (AI) and machine learning (ML), AI service support, metaverse service support, drone communication, and the like.

In addition, such development of the 5G mobile communication system will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of the 6G mobile communication technologies and improving system networks, AI-based communication technology for implementing system optimization by utilizing satellites and AI from a design stage and internalizing end-to-end AI support functions, and next-generation distributed computing technology for implementing services at levels of complexity exceeding the limit of UE operation capability by utilizing ultra-high-performance communication and computing resources.

With the development of a communication system, researches are conducted for an uplink transmission and reception procedure using a plurality of panels, and in particular, there is an increasing demand for particularly implementing uplink simultaneous transmission using the plurality of panels.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for efficiently providing a service in a mobile communication system. Various embodiments of the disclosure provide a method of configuring a phase tracking reference signal for simultaneously transmitting a plurality of uplink channels by using a plurality of panels, and transmitting the phase tracking reference signal together in the uplink channel transmission, in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, via a radio resource control (RRC) signaling, information related to sounding reference signal (SRS) resource set and phase tracking reference signal (PTRS) uplink configuration information including a parameter indicating a maximum number of uplink (UL) PTRS ports, receiving a downlink control information (DCI) format 0_1 including a SRS resource set indicator (SRSI) field and a first PTRS-demodulation reference signal (DMRS) association field, when two SRS resource sets associated with a usage of value ‘nonCodeBook’ or ‘CodeBook’ are configured based on the information related to SRS resource set, determining a number of bits of the SRSI field as 2bits, and based on the 2bits SRSI field and the parameter indicating the maximum number of ports, determining a number of bits of the first PTRS-DMRS association field as 1 bit or 2 bits.

The number of bits of the first PTRS-DMRS association field may be determined as 2 bits, when one PTRS port is configured based on the parameter indicating the maximum number of ports included in the PTRS uplink configuration information, the SRSI field is present and equals “00” or “01”, a maximum rank or a maximum number of MIMO layers configured for the UE is 2 or 3 and a parameter related to multi panel scheme is not configured for the UE.

The number of bits of the first PTRS-DMRS association field may be determined as 2 bits, when one PTRS port is configured based on the parameter indicating the maximum number of ports included in the PTRS uplink configuration information, the SRSI field is present and equals “10” or “11”, a maximum rank or a maximum number of MIMO layers configured for the UE is 2, and a parameter related to multi panel scheme is not configured for the UE.

A most significant bit (MSB) of the first PTRS-DMRS association field may indicate an association between PTRS port and DMRS port corresponding to a first SRS resource indicator (SRI) and/or a first precoding information, and a least significant bit (LSB) of the first PTRS-DMRS association field may indicate an association between PTRS port and DMRS port corresponding to a second SRI and/or a second precoding information.

The number of bits of the first PTRS-DMRS association field may be determined as 2 bits, and a number of bits of a second PTRS-DMRS association field may be determined as 2 bits, when one PTRS port is configured based on the parameter indicating the maximum number of ports included in the PTRS uplink configuration information, the SRSI field is present and equals “10” or “11”, a maximum rank or a maximum number of MIMO layers configured for the UE is 3, and a parameter related to multi panel scheme is not configured for the UE.

The first PTRS-DMRS association field may indicate an association between PTRS port and DMRS port corresponding to a first SRI and/or a first precoding information, and the second PTRS-DMRS association field may indicate an association between PTRS port and DMRS port corresponding to a second SRI and/or a second precoding information.

The number of bits of the first PTRS-DMRS association field may be determined as 1 bit, when two PTRS ports are configured based on the parameter indicating the maximum number of ports included in the PTRS uplink configuration information, the SRSI field is present and equals “00” or “01”, a maximum rank or a maximum number of MIMO layers configured for the UE is 2 or 3, and a parameter related to multi panel scheme is not configured for the UE.

The number of bits of the first PTRS-DMRS association field may be determined as 1 bit, and a number of bits of a second PTRS-DMRS association field may be determined as 1 bit, when two PTRS ports are configured based on the parameter indicating the maximum number of ports included in the PTRS uplink configuration information, the SRSI field is present and equals “10” or “11”, a maximum rank or a maximum number of MIMO layers configured for the UE is 2 or 3, and a parameter related to multi panel scheme is not configured for the UE.

The first PTRS-DMRS association field may indicate an association between PTRS port and DMRS port corresponding to a first SRI and/or a first precoding information, and the second PTRS-DMRS association field may indicate an association between PTRS port and DMRS port corresponding to a second SRI and/or a second precoding information.

In accordance with another aspect of the disclosure, a method performed by a base station in a wireless communication system is provided. The method includes transmitting, to a user equipment (UE), via a radio resource control (RRC) signaling, information related to sounding reference signal (SRS) resource set and phase tracking reference signal (PTRS) uplink configuration information including a parameter indicating a maximum number of UL PTRS ports, transmitting, to the UE, a downlink control information (DCI) format 0_1 including a SRS resource set indicator (SRSI) field and a first PTRS-Demodulation Reference Signal (DMRS) association field, when two SRS resource sets associated with a usage of value ‘nonCodeBook’ or ‘CodeBook’ are configured based on the information related to SRS resource set, determining a number of bits of the SRSI field as 2bits, and based on the 2bits SRSI field and the parameter indicating the maximum number of ports, determining a number of bits of the first PTRS-DMRS association field as 1 bit or 2 bits.

In accordance with another aspect of the disclosure, a user equipment (UE) in a wireless communication system is provided. The UE includes memory storing a program or one or more instructions, and at least one processor configured to execute the program or the one or more instructions to cause the UE to receive, from a base station, via a radio resource control (RRC) signaling, information related to sounding reference signal (SRS) resource set and phase tracking reference signal (PTRS) uplink configuration information including a parameter indicating a maximum number of UL PTRS ports, receive a downlink control information (DCI) format 0_1 including a SRS resource set indicator (SRSI) field and a first PTRS-demodulation reference signal (DMRS) association field, when two SRS resource sets associated with a usage of value ‘nonCodeBook’ or ‘CodeBook’ are configured based on the information related to SRS resource set, determine a number of bits of the SRSI field as 2bits, and based on the 2bits SRSI field and the parameter indicating the maximum number of ports, determine a number of bits of the first PTRS-DMRS association field as 1 bit or 2 bits.

The number of bits of the first PTRS-DMRS association field may be determined as 2 bits, when one PTRS port is configured based on the parameter indicating the maximum number of ports included in the PTRS uplink configuration information, the SRSI field is present and equals “00” or “01”, and a maximum rank or a maximum number of MIMO layers configured for the UE is 2 or 3, and a parameter related to multi panel scheme is not configured for the UE.

The number of bits of the first PTRS-DMRS association field may be determined as 2 bits, when one PTRS port is configured based on the parameter indicating the maximum number of ports included in the PTRS uplink configuration information, the SRSI field is present and equals “10” or “11”, a maximum rank or a maximum number of MIMO layers configured for the UE is 2, and a parameter related to multi panel scheme is not configured for the UE.

A most significant bit (MSB) of the first PTRS-DMRS association field may indicate an association between PTRS port and DMRS port corresponding to a first SRS resource indicator (SRI) and/or a first precoding information, and a least significant bit (LSB) of the first PTRS-DMRS association field may indicate an association between PTRS port and DMRS port corresponding to a second SRI and/or a second precoding information. [0=7]The number of bits of the first PTRS-DMRS association field may be determined as 2 bits, and a number of bits of a second PTRS-DMRS association field may be determined as 2 bits, when one PTRS port is configured based on the parameter indicating the maximum number of ports included in the PTRS uplink configuration information, the SRSI field is present and equals “10” or “11”, a maximum rank or a maximum number of MIMO layers configured for the UE is 3, and a parameter related to multi panel scheme is not configured for the UE.

The first PTRS-DMRS association field may indicate an association between PTRS port and DMRS port corresponding to a first SRI and/or a first precoding information, and the second PTRS-DMRS association field may indicate an association between PTRS port and DMRS port corresponding to a second SRI and/or a second precoding information.

The number of bits of the first PTRS-DMRS association field may be determined as 1 bit, when two PTRS ports are configured based on the parameter indicating the maximum number of ports included in the PTRS uplink configuration information, the SRSI field is present and equals “00” or “01”, and a maximum rank or a maximum number of MIMO layers configured for the UE is 2 or 3, and a parameter related to multi panel scheme is not configured for the UE.

The number of bits of the first PTRS-DMRS association field may be determined as 1 bit, and a number of bits of a second PTRS-DMRS association field may be determined as 1 bit, when two PTRS ports are configured based on the parameter indicating the maximum number of ports included in the PTRS uplink configuration information, the SRSI field is present and equals “10” or “11”, a maximum rank or a maximum number of MIMO layers configured for the UE is 2 or 3, and a parameter related to multi panel scheme is not configured for the UE.

The first PTRS-DMRS association field may indicate an association between PTRS port and DMRS port corresponding to a first SRI and/or a first precoding information, and the second PTRS-DMRS association field may indicate an association between PTRS port and DMRS port corresponding to a second SRI and/or a second precoding information.

In accordance with another aspect of the disclosure, a base station (BS) in a wireless communication system is provided. The BS includes memory storing a program or one or more instructions, and at least one processor configured to execute the program or the one or more instructions to cause the base station to transmit, to a user equipment (UE), via a radio resource control (RRC) signaling, information related to sounding reference signal (SRS) resource set and phase tracking reference signal (PTRS) uplink configuration information including a parameter indicating a maximum number of UL PTRS ports, transmit, to the UE, a downlink control information (DCI) format 0_1 including a SRS resource set indicator (SRSI) field and a first PTRS-demodulation reference signal (DMRS) association field, when two SRS resource sets associated with a usage of value ‘nonCodeBook’ or ‘CodeBook’ are configured based on the information related to SRS resource set, determine a number of bits of the SRSI field as 2bits, and based on the 2bits SRSI field and the parameter indicating the maximum number of ports, determine a number of bits of the first PTRS-DMRS association field as 1 bit or 2 bits.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a base station (BS) beam allocation according to transmission configuration indicator (TCI) state configuration in a wireless communication system according to an embodiment of the disclosure;

FIG. 2 is a diagram illustrating a physical uplink shared channel (PUSCH) repetitive transmission type B in a wireless communication system according to an embodiment of the disclosure;

FIG. 3 is a diagram illustrating a method of allocating comb offset and a cyclic shift in sounding reference signal (SRS) transmission, according to an embodiment of the disclosure;

FIG. 4 is a diagram illustrating a beam application time that may be considered when a unified TCI framework is used in a wireless communication system, according to an embodiment of the disclosure;

FIG. 5 is a diagram illustrating a medium access control-control element (MAC-CE) structure for activation and indication of joint TCI state or separate downlink (DL) or uplink (UL) TCI state in a wireless communication system according to an embodiment of the disclosure;

FIG. 6 is a diagram illustrating a MAC-CE structure for activation and indication of joint TCI state or separate DL or ULTCI state in a wireless communication system according to an embodiment of the disclosure;

FIG. 7 is a diagram illustrating a MAC-CE structure for activation and indication of a plurality of joint TCI states or separate DLs or UL TCI states in a wireless communication system according to an embodiment of the disclosure;

FIG. 8 is a diagram illustrating a structure of a user equipment (UE) in a wireless communication system according to an embodiment of the disclosure; and

FIG. 9 is a diagram illustrating a structure of a BS in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Hereinafter, embodiments of the disclosure will now be described more fully with reference to the accompanying drawings.

In the following descriptions of embodiments of the disclosure, descriptions of techniques that are well known in the art and are not directly related to the disclosure are omitted. By omitting unnecessary descriptions, the essence of the disclosure may not be obscured and may be explicitly conveyed.

For the same reason, some elements in the drawings are exaggerated, omitted, or schematically illustrated. In addition, the size of each element does not entirely reflect the actual size. In the drawings, the same or corresponding elements are denoted by the same reference numerals.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein. Rather, these embodiments are provided so that the disclosure will be thorough and complete and will fully convey the concept of the disclosure to one of ordinary skill in the art, and the disclosure will only be defined by the appended claims. Throughout the specification, like reference numerals denote like elements. In the descriptions of the disclosure, detailed explanations of the related art are omitted when it is deemed that they may unnecessarily obscure the essence of the disclosure. The terms used in the specification are defined based on functions used in the disclosure, and can be changed according to the intent or commonly used methods of users or operators. Accordingly, definitions of the terms are understood based on the entire descriptions of the specification.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used in the embodiment refers to a software or hardware element, such as field-programmable gate array (FPGA) or application-specific integrated circuit (ASIC), which performs certain tasks. However, the term “. . . unit” does not mean to be limited to software or hardware. A “ . . . unit” may be configured to be in an addressable storage medium or configured to operate one or more processors. Thus, according to an embodiment of the disclosure, a “ . . . unit” may include, by way of example, elements, such as software elements, object-oriented software elements, class elements, and task elements, processes, functions, attributes, procedures, subroutines, segments of program code, drivers, firmware, microcode, circuitry, data, databases, data structures, tables, arrays, and variables. The functionality provided in the elements and “ . . . units“may be combined into fewer elements and”. . . units” or further separated into additional elements and “ . . . units”. Further, the elements and “ . . . units” may be implemented to operate one or more central processing units (CPUs) in a device or a secure multimedia card. In addition, according to an embodiment of the disclosure, a “ . . . unit” may include one or more processors.

Wireless communication systems providing voice-based services in early stages are being developed to broadband wireless communication systems providing high-speed and high-quality packet data services according to communication standards, such as high speed packet access (HSPA), long term evolution (LTE) or evolved universal terrestrial radio access (E-UTRA), LTE-advanced (LTE-A), LTE-Pro of 3^{rd} generation partnership project (3G PP), high rate packet data (H RPD), ultra mobile broadband (UMB) of 3^{rd} generation partnership project 2 (3G PP2), and 802.16e of the institute of electrical and electronics engineers (IE EE).

As a representative example of the broadband wireless communication systems, LTE systems employ orthogonal frequency division multiplexing (OFDM) for a downlink (DL) and employs single carrier-frequency division multiple access (SC-FDMA) for an uplink (UL). The UL refers to a radio link for transmitting data or a control signal from a terminal (e.g., a UE or an M S) to a base station (e.g., an eNB or a BS), and the DL refers to a radio link for transmitting data or a control signal from the base station to the terminal. The above-described multiple access schemes identify data or control information of each user in a manner that time-frequency resources for carrying the data or control information of each user are allocated and managed not to overlap each other, that is, to achieve orthogonality therebetween.

As post-LTE communication systems, i.e., 5G communication systems need to support services capable of freely reflecting and simultaneously satisfying various requirements of users, service providers, and the like. Services considered for the 5G systems include enhanced mobile broadband (eMBB), massive machine-type communication (mM TC), ultra-reliability low-latency communication (URLLC) services, or the like.

The eMBB aims to provide an improved data rate than a data rate supported by the legacy LTE, LTE-A, or LTE-Pro. For example, in a 5G communication system, the eMBB should be able to provide a peak data rate of 20 G bps in a DL and a peak data rate of 10 Gbps in an UL at one BS. In addition, the 5G communication system has to simultaneously provide a peak data rate and an increased user-perceived data rate of a terminal. In order to satisfy such requirements, there is a need for improvement in various transmission/reception technologies including an improved multiple-input multiple-output (MIMO) transmission technology. In addition, a data rate required in the 5G communication system may be satisfied by using a frequency bandwidth wider than 20 MHz in the 3 GHz to 6 GHz or 6 GHz or more frequency band, instead of the LTE transmitting a signal by using maximum 20 MHz in the 2 GHz band.

In addition, the mMTC is being considered to support application services, such as IoT in the 5G communication system. In order to efficiently provide the IoT, the mM TC may require the support for a large number of terminals in a cell, improved coverage for a terminal, improved battery time, reduced costs of a terminal, and the like. Because the IoT is attached to various sensors and various devices to provide a communication function, the mM TC should be able to support a large number of terminals (e.g., 1,000,000 terminals/km\hat{ }2) in a cell. In addition, because a terminal supporting the mM TC is likely to be located in a shadow region failing to be covered by the cell, such as the basement of a building, due to the characteristics of the service, the terminal may require wider coverage than other services provided by the 5G communication system. The terminal supporting the mM TC should be configured as a low-cost terminal and may require a very long battery life time of 10 to 15 years because it is difficult to frequently replace the battery of the terminal.

The URLLC refers to cellular-based wireless communication services used for mission-critical purposes. For example, services for remote control of robots or machinery, industrial automation, unmanned aerial vehicles, remote health care, emergency alerts, and the like may be considered. Therefore, the URLLC should provide communications providing very low latency and very high reliability. For example, a service supporting the URLLC should satisfy air interface latency of less than 0.5 milliseconds, and simultaneously has a requirement for a packet error rate of 10-5 or less. Thus, for the service supporting the URLLC, the 5G system should provide a transmit time interval (TTI) smaller than other services and may simultaneously have a design requirement for allocating wide resources in a frequency band so as to ensure reliability of a communication link.

The three services of the 5G, i.e., the eMBB, the URLLC, and the mM TC may be multiplexed and transmitted in one system. Here, in order to satisfy different requirements of the services, the services may use different transceiving schemes and different transceiving parameters. Obviously, the 5G is not limited to the afore-described three services.

Hereinafter, a base station is an entity that allocates resources to a terminal, and may be at least one of a next-generation node B (gNode B), an evolved node B (eNode B), a Node B, a base station (BS), a radio access unit, a BS controller, or a node on a network. A terminal may include a user equipment (UE), a mobile station (MS), a cellular phone, a smartphone, a computer, or a multimedia system capable of performing a communication function. In the disclosure, a downlink (DL) is a wireless transmission path of a signal transmitted from a BS to a UE, and an uplink (UL) is a wireless transmission path of a signal transmitted from a UE to a BS. Although a long term evolution (LTE) or LTE-Advanced (LTE-A) system is mentioned as an example in the following description, embodiments of the disclosure may also be applied to other communication systems having similar technical backgrounds or channel types. For example, a 5^{th} generation (5G/New Radio (NR)) mobile communication technology developed after LTE-A may be included therein, and hereinafter, 5G may refer to a concept including legacy LTE, LTE-A, and other similar communication services. In addition, an embodiment of the disclosure is applicable to other communication systems through modification at the discretion of one of ordinary skill in the art without greatly departing from the scope of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (C P, e.g., a modem), a graphical processing unit (GPU), a neural processing unit (N PU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, a/b may be understood as at least one of a or b.

Quasi co-location (QCL),TCI state

One or more different antenna ports (which may be substituted with one or more channels, signals, or combinations thereof, but for convenience of descriptions in the disclosure, collectively called different antenna ports) may be associated with each other according to Quasi co-location (QCL) configurations described in Table 1 below in a wireless communication system. The TCI state is to announce/indicate a QCL relation between a physical downlink control channel (PDCCH) (or PDCCH demodulation reference signal (DMRS)) and other RS or channel, and when a reference antenna port A (reference RS #A) and other target antenna port B (target RS #B) are QCLed with each other, it means that the UE is allowed to apply some or all of large-scale channel parameters estimated from the antenna port A to measurement of channels from the antenna port B. QCL may need to associate different parameters depending on a situation, such as 1) time tracking affected by average delay and delay spread, 2) frequency tracking affected by Doppler shift and Doppler spread, 3) radio resource management (RRM) affected by an average gain, 4) beam management affected by a spatial parameter, or the like. Accordingly, the NR supports four types of QCL relations as in Table 1 below.

TABLE 1

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Receiver (Rx) parameter |

The spatial RX parameter may collectively refer to some or all of various parameters, such as angle of arrival (AoA), power angular spectrum (PAS) of AoA, angle of departure (AoD), PAS of AoD, transmit/receive channel correlation, transmit/receive beamforming, spatial channel correlation, or the like.

The QCL relation may be configured for the UE via an RRC parameter TCI-state and QCL-Info as described in Table 2 below. Referring to Table 2, the BS may configure the U with one or more TCI states to notify the U maximally up to two QCL relations (qcl-Type1 and qcl-Type2) for an RS that refers to an ID of the TC state, i.e., a target RS. Here, QCL information (QCL-Info) included in each of the TC states includes a BWP index and a serving cell index of a reference RS indicated by the QCL information, a type and ID of the reference RS, and a QCL type as in Table 1 above.

TABLE 2

| TCI-State ::= | SEQUENCE { |
|---|---|
| tci-StateID | TCI-StateID, |
| (ID of corresponding TCI state) | |
| qcl-Type1 | QCL-Info, |
| (QCL information of first reference RS of RS (target RS) | |
| referring to corresponding TCI state ID) | |
| qcl-Type2 | QCL-Info |
| OPTIONAL, -- Need R | |
| (QCL information of second reference RS of RS (target | |
| RS) referring to corresponding TCI state ID) | |
| ... | |
| } | |
| QCL-Info ::= | SEQUENCE { |
| cell | ServCellIndex |
| OPTIONAL, -- Need R | |
| (serving cell index of reference RS indicated by | |
| corresponding QCL information) | |
| bwp-Id | BWP-Id |
| OPTIONAL, -- Cond CSI-RS-Indicated | |
| (BWP index of reference RS indicated by corresponding | |
| QCL information) | |
| referenceSignal | CHOICE { |
| csi-rs | NZP-CSI-RS- |
| ResourceID, | |
| ssb | SSB- |
| Index | |
| (one of CSI-RS ID or SSB ID indicated by | |
| corresponding QCL information) | |
| }, | |
| qcl-Type | ENUMERATED |

{typeA, typeB, typeC, typeD},
...
}

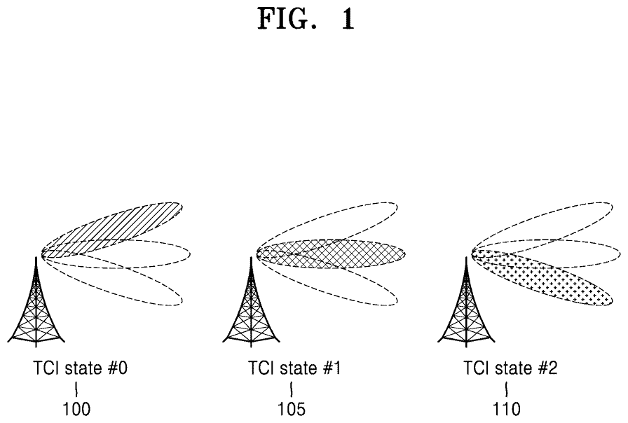

FIG. 1 is a diagram illustrating a BS beam allocation according to TCI state configuration in a wireless communication system according to an embodiment of the disclosure.

Referring to FIG. 1, the BS may transmit information about N different beams to the UE via N different TCI states. For example, in a case of N=3 as shown in F IG. 1, the BS may associate qcl-Type2 parameters included in three TCI states 100, 105, and 110 with CSI-RSs or SSBs corresponding to the different beams and may configure the qci-Type2 parameters as QCL type D. By doing so, the BS may announce/indicate that antenna ports referring to the different TCI states 100, 105, and 110 are associated with different spatial Rx parameters, i.e., different beams.

Tables 3 to 7 below represent valid TCI state configurations according to target antenna port types.

Table 3 represents a valid TCI state configuration when the target antenna port is a CSI-RS for tracking (TRS). The TRS refers to non-zero-power (NZP) CSI-RS in which a repetition parameter is not configured but trs-Info is configured to true among CSI-RSs. In Table 3, configuration no. 3 may be used for an aperiodic TRS.

TABLE 3

| Valid TCI state | | | DL RS 2 | qcl-Type 2 |
|---|---|---|---|---|
| configuration | DL RS 1 | qcl-Type 1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 4 represents valid TCI state configuration when the target antenna port is a CSI-RS for CSI. The CSI-RS for CSI refers to an NZP CSI-RS in which a parameter indicating repetition (e.g., a repetition parameter) is not configured and trs-Info is not configured to true among CSI-RSs.

TABLE 4

| Valid TCI state | | | DL RS 2 | qcl-Type 2 |
|---|---|---|---|---|
| configuration | DL RS 1 | qcl-Type 1 | (if configured) | (if configured) |
| 1 | TRS | QCL-TypeA | SSB | QCL-TypeD |
| 2 | TRS | QCL-TypeA | CSI-RS for | QCL-TypeD |
| | | | BM | |
| 3 | TRS | QCL-TypeA | TRS (same as | QCL-TypeD |
| | | | DL RS 1) | |
| 4 | TRS | QCL-TypeB | | |

Table 5 represents valid TCI state configuration when the target antenna port is a CSI-RS for beam management (meaning the same as BM, CSI-RS for L1 reference signal received power (RSRP) reporting). The CSI-RS for BM refers to NZP CSI-RS in which a repetition parameter is configured and which has a value of ‘On’ or ‘Off’ and in which trs-Info is not configured to true among CSI-RSs.

TABLE 5

| Valid TCI state | | | DL RS 2 | qcl-Type 2 |
|---|---|---|---|---|
| configuration | DL RS 1 | qcl-Type 1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 6 represents valid TCI state configuration when the target antenna port is a PDCCH DMRS.

TABLE 6

| Valid TCI | | | | |
|---|---|---|---|---|
| state | | | DL RS 2 | qcl-Type 2 |
| configuration | DL RS 1 | qcl-Type 1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS (CSI) | QCL-TypeA | CSI-RS (same | QCL-TypeD |
| | | | as DL RS 1) | |

Table 7 represents valid TCI state configuration when the target antenna port is a physical downlink shared channel (PDSCH) DMRS.

TABLE 7

| Valid | | | DL RS | qcl-Type |
|---|---|---|---|---|
| TCI state | DL | | 2 (if | 2 (if |
| configuration | RS 1 | qcl-Type 1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

A representative QCL configuration method according to Tables 3 to 7 above is to configure and operate a target antenna port and a reference antenna port in each stage as “SSB”->“TRS”->“CSI-RS for CSI, or CSI-RS for BM, or PDCCH DMRS, or PDSCH DMRS”. By doing so, it is possible to help a reception operation by the UE by associating statistical characteristics that may be measured from the SSB and TRS with the respective antenna ports. [0 ml]PDCCH: related to DCI

Next, DL control information (DCI) in the 5G system will now be described in detail.

In the 5G system, scheduling information for UL data (or PUSCH) or D L data (or PDSCH) is transmitted in the DCI from the BS to the UE. The UE may monitor a fallback DCI format and a non-fallback DCI format for PUSCH or PDSCH. The fallback DCI format may include a fixed field predefined between the BS and the UE, and the non-fallback DCI format may include a configurable field.

DCI may be transmitted on a PDCCH after channel coding and modulation processes. Cyclic redundancy check (CRC) may be added to a DCI message payload, and the CRC may be scrambled by a radio network temporary identifier (RNTI) that corresponds to an ID of the UE. Depending on a purpose of the DCI message, e.g., UE-specific data transmission, power control command, random access response, or the like, different RN TIs may be used. For example, the RNTI may not be explicitly transmitted but may be transmitted in a CRC calculation process. Upon reception of a DCI message transmitted on the PDCCH, the UE may check CRC by using an allocated RNTI, and may identify that the DCI message is transmitted to the UE, based on a result of the C RC checking.

For example, DCI that schedules a PDSCH for system information (SI) may be scrambled by SI-RNTI. DCI that schedules a PDSCH for a random access response (RAR) message may be scrambled by an RA-RNTI. DCI that schedules a PDSCH for a paging message may be scrambled by a P-RNTI. DCI that notifies a slot format indicator (SFI) may be scrambled by an SFI-RNTI. DCI that notifies a transmit power control (TPC) may be scrambled by a TPC-RNTI. DCI that schedules UE-specific PDSCH or PUSCH may be scrambled by a Cell RNTI (C-RNTI).

DCI format 0_0 may be used for the fallback DCI that schedules a PUSCH, and here, the CRC may be scrambled by a C-RNTI. The DCI format 0_0 in which the CRC is scrambled by the C-RNTI may include a plurality of pieces of information as in Table 8 below.

```
TABLE 8
  Identifier for DCI formats - [1] bit
  $Frequency domain resource assigment ‐ [ ⌈ {log}_{2} ( {N}_{RB}^{UL , BWP} ( {N}_{RB}^{UL , BWP} +$
1)/2)┐bits
  Time domain resource assignment - X bits
  Frequency hopping flag - 1 bit.
  Modulation and coding scheme - 5 bits
  New data indicator - 1 bit
  Redundancy version - 2 bits
  HARQ process number - 4 bits
  TPC command for scheduled PUSCH - [2] bits
  UL/SUL indicator - 0 or 1 bit
```

DCI format 0_1 may be used for the non-fallback DCI that schedules a PUSCH, and here, the CRC may be scrambled by a C-RNTI. The DCI format 0_1 in which the CRC is scrambled by the C-RNTI may include a plurality of pieces of information as in Table 9 below.

```
TABLE 9
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
  $For resource allocation type 0 , ⌈ {N}_{RB}^{UL , BWP} / P ⌉ bits$
  $For resource allocation type 1 , ⌈ {log}_{2} ( {N}_{RB}^{UL , BWP} ( {N}_{RB}^{UL , BWP} + 1 ) / 2 ⌉ bits$
  Time domain resource assignment - 1, 2, 3, or 4 bits
  Virtual resource block (VRB)-to-physical resource block (PRB) mapping
0 or 1 bit, only for resource allocation type 1.
  0 bit if only resource allocation type 0 is configured;
  1 bit otherwise.
  Frequency hopping flag - 0 or 1 bit, only for resource allocation type 1.
  0 bit if only resource allocation type 0 is configured;
  1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
  1 bit for semi-static HARQ-ACK codebook;
  2 bits for dynamic HARQ-ACK codebook with single HARQ-ACK
codebook.
  2nd downlink assignment index - 0 or 2 bits
  2 bits for dynamic HARQ-ACK codebook with two HARQ-ACK sub-
codebooks;
  0 bit otherwise.
  TPC command for scheduled PUSCH - 2 bits
  $SRS resource indicator ‐ ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉ bits$
  $⌈ {log}_{2} ( {\sum }_{k = 1}^{{L}_{max} \sum } ( \begin{matrix}{N}_{SRS} \\ k\end{matrix} ) ) ⌉ bits for non ‐ codebook based PUSCH$
transmission;
  ┌log₂(N_{SRS})┐ bits for codebook based PUSCH transmission.
  Precoding information and number of layers - up to 6 bits
  Antenna ports - up to 5 bits
  SRS request - 2 bits
  Channel state information (CSI) request - 0, 1, 2, 3, 4, 5, or 6 bits
  Code block group (CBG) transmission information - 0, 2, 4, 6, or 8 bits
  Phase tracking reference signal (PTRS)-DMRS association - 0 or 2 bits.
  beta_offset indicator - 0 or 2 bits
  DMRS sequence initialization - 0 or 1 bit
```

DCI format 1_0 may be used for the fallback DCI that schedules a PDSCH, and here, the CRC may be scrambled by a C-RNTI The DCI format 1_0 in which the CRC is scrambled by the C-RNTI may include a plurality of pieces of information as in Table 10 below.

```
TABLE 10
  Identifier for DCI formats - [1] bit
  $Frequency domain resource assigment ‐ [ ⌈ {log}_{2} ( {N}_{RB}^{DL , BWP} ( {N}_{RB}^{DL , BWP} +$
1)/2)┐] bits
  Time domain resource assignment - X bits
  VRB-to-PRB mapping - 1 bit.
  Modulation and coding scheme - 5 bits
  New data indicator - 1 bit
  Redundancy version - 2 bits
  HARQ process number - 4 bits
  Downlink assignment index - 2 bits
  TPC command for scheduled PUCCH - [2] bits
  PUCCH resource indicator - 3 bits
  PDSCH-to-HARQ feedback timing indicator - [3] bits
```

DCI format 1 1 may be used for the non-fallback DCI that schedules a PDSCH, and here, the CRC may be scrambled by a C-RNTI. The DCI format 11 in which the CRC is scrambled by the C-RNTI may include a plurality of pieces of information as in Table 11 below.

```
TABLE 11
  Carrier indicator - 0 or 3 bits
  Identifier for DCI formats - [1] bits
  Bandwidth part indicator - 0, 1 or 2 bits
  Frequency domain resource assignment
  $For resource allocation type 0 , ⌈ {N}_{RB}^{DL , BWP} / P ⌉ bits$
  $For resource allocation type 1 , ⌈ {log}_{2} ( {N}_{RB}^{DL , BWP} ( {N}_{RB}^{DL , BWP} + 1 ) / 2 ⌉ bits$
  Time domain resource assignment -1, 2, 3, or 4 bits
  VRB-to-PRB mapping - 0 or 1 bit, only for resource allocation type 1.
  0 bit if only resource allocation type 0 is configured;
  1 bit otherwise.
  PRB bundling size indicator - 0 or 1 bit
  Rate matching indicator - 0, 1, or 2 bits
  ZP CSI-RS trigger - 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

PUSCH: related to transmission scheme

Hereinafter, a PUSCH transmission scheduling scheme will now be described. PUSCH transmission may be dynamically scheduled by UL grant in DCI or may be operated by configured grant Type 1 or Type 2. Dynamic scheduling indication for PUSCH transmission may be indicated by DCI format 0_0 or 0_1.

Configured grant Type 1 PUSCH transmission may be semi-statically configured not by receiving UL grant in DCI but by receiving configuredGrantConfig including rrc-Configured Uplink Grant of Table 12 below by higher layer signaling. Configured grant Type 2 PUSCH transmission may be semi-persistently scheduled by UL grant in DCI after receiving configuredGrantConfig that does not include rrc-Configured Uplink Grant of Table 12 by higher layer signaling. When the PUSCH transmission is operated by configured grant, parameters to be applied to the PUSCH transmission are applied by higher layer signaling configuredGrantConfig of Table 13 except for data Scramblingldentity PUSCH, txConfig, codebookSubset, maxRank, scaling of UCI-OnPUSCH provided by higher layer signaling that is pusch-Config of Table 12. When the UE receives transformPrecoder in higher layer signaling that is configuredGrantConfig of Table 12, the UE applies tp-pi2BPSK in pusch-Config of Table 13 to the PUSCH transmission operated by the configured grant.

TABLE 12

| | |
|---|---|
| ConfiguredGrantConfig ::= | SEQUENCE { |

| | |
|---|---|
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |

| | |
|---|---|
| transformPrecoder | ENUMERATED {enabled, disabled} |

OPTIONAL, -- Need S

| | |
|---|---|
| nrofHARQ-Processes | INTEGER(1..16), |

| | |
|---|---|
| repK | ENUMERATED {n1, n2, n4, n8}, |

| | |
|---|---|
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |

| | |
|---|---|
| srs-ResourceIndicator | INTEGER (0..15) |

OPTIONAL, -- Need R

| | |
|---|---|
| mcsAndTBS | INTEGER (0..31), |

| | |
|---|---|
| frequencyHoppingOffset | INTEGER (1.. |

| | |
|---|---|
| maxNrofPhysicalResourceBlocks-1) | OPTIONAL, -- Need R |
| pathlossReferenceIndex | INTEGER (0..maxNrofPUSCH- |

PathlossReferenceRSs-1),
...

| | |
|---|---|
| } | OPTIONAL, -- |

Need R
...
}

Hereinafter, a PUSCH transmission method will now be described. A DMRS antenna port for PUSCH transmission is equal to an antenna port for SRS transmission. The PUSCH transmission may follow a codebook based transmission method and a non-codebook based transmission method, respectively, according to whether a value of txConfig in pusch-Config of Table 13 which is higher layer signaling is ‘codebook’ or ‘nonCodebook’.

As described above, PUSCH transmission may be dynamically scheduled by DCI format 0_0 or 0_1, or may be semi-statically configured by the configured grant. If the UE receives an indication of scheduling of PUSCH transmission by DCI format 0_0, the UE performs beam configuration for PUSCH transmission by using PUCCH-spatial Relation info ID corresponding to a UE-specific physical uplink control channel (PUCCH) resource corresponding to a smallest ID in an activated UL BWP in the serving cell, and in this regard, the PUSCH transmission is based on a single antenna port. The UE does not expect scheduling for the PUSCH transmission by DCI format 0_0 in a BWP on which a PUCCH resource including PUCCH-spatial Relation info is not configured. If the UE is not configured with txConfig in pusch-Config of Table 13, the UE does not expect scheduling by DCI format 0_1.

TABLE 13

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |

| | |
|---|---|
| UplinkConfig } | OPTIONAL, -- Need M |

| | |
|---|---|
| dmrs-UplinkForPUSCH-MappingTypeB | SetupRelease { DMRS- |

| | |
|---|---|
| UplinkConfig } | OPTIONAL, -- Need M |

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER |

(1.. maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}

OPTIONAL, --

Cond codebookBased

| | | |
|---|---|---|
| maxRank | INTEGER (1..4) | OPTIONAL, |

-- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Hereinafter, codebook based PUSCH transmission will now be described. Codebook based PUSCH transmission may be dynamically scheduled by DCI format 0_0 or 0_1, or may be semi-statically operated by the configured grant. When the codebook based PUSCH transmission is dynamically scheduled by DCI format 0_1 or semi-statically configured by the configured grant, the UE determines a precoder for PUSCH transmission based on an SRS resource indicator (SRI), a transmission precoding matrix indicator (TPMI), and a transmission rank (the number of PUSCH transmission layers).

Here, the SRI may be given by an SRS resource indicator that is afield in DCI or may be configured by SRS-Resourcelndicator that is higher layer signaling. The UE may be configured with at least one SRS resource for codebook based PUSCH transmission, and may be configured with up to two SRS resources. When the UE receives the SRI by DCI, an SRS resource indicated by the SRI refers to an SRS resource corresponding to the SRI among SRS resources transmitted before the PDCCH including the SRI. In addition, the TPMI and the transmission rank may be given by precoding information and number of layers that is a field in the DCI or may be configured by precoding And Number Of Layers that is higher layer signaling. The TPMI is used to indicate a precoder to be applied to PUSCH transmission. If the UE is configured with one SRS resource, the TPMI is used to indicate a precoder to be applied in the configured one SRS resource. If the UE is configured with a plurality of SRS resources, the TPMI is used to indicate a precoder to be applied in the SRS resource indicated by the SRI.

The precoder to be used in PUSCH transmission is selected from a UL codebook having the same number of antenna ports as a value of nrofSRS-Ports in SRS-Config that is higher layer signaling. In the codebook based PUSCH transmission, the UE determines a codebook subset based on the TPMI and codebookSubset in pusch-Config that is higher layer signaling. The codebookSubset in the pusch-Config that is higher layer signaling may be configured as one of ‘fullyAndPartialAndNonCoherent’, ‘partialAndNonCoherent’, and ‘nonCoherent’, based on the UE capability reported by the UE to the BS. If the UE reports ‘partialAndNonCoherent’ in the UE capability, the UE does not expect that a value of codebookSubset that is higher layer signaling is configured to be ‘fullyAndPartialAndNonCoherent’. If the UE reports ‘nonCoherent’ in the UE capability, the UE does not expect that a value of codebookSubset that is higher layer signaling is configured to be ‘fullyAndPartialAndNonCoherent‘ or’partialAndNonCoherent’. When nrofSRS-Ports in SRS-ResourceSet that is higher layer signaling indicates two SRS antenna ports, the UE does not expect that a value of codebookSubset that is higher layer signaling is configured to be ‘partialAndNonCoherent’.

The UE may be configured with one SRS resource set with a value of the usage in SRS-ResourceSet that is higher layer signaling being configured to ‘codebook’, and one SRS resource in the SRS resource set may be indicated by the SRI. If several SRS resources are configured in the SRS resource set in which a value of the usage in SRS-ResourceSet that is higher layer signaling is configured to ‘codebook’, the UE expects that nrofSRS-Ports in SRS-Resource that is higher layer signaling is configured to have the same value for all SRS resources.

The UE transmits, to the BS, one or multiple SRS resources included in the SRS resource set with a value of the usage configured to ‘codebook’ by higher layer signaling, and the BS selects one of the SRS resources transmitted from the UE and indicates the UE to perform PUSCH transmission by using transmission beam information of the SRS resource. Here, for the codebook based PUSCH transmission, the SRI is used as information for selecting an index of the one SRS resource and is included in DCI. In addition, the BS may add, to the DCI, information indicating a TPMI and a rank to be used by the UE for PUSCH transmission. The UE performs, by using the SRS resource indicated by the SRI, PUSCH transmission by applying the precoder indicated by the rank and the TPMI indicated based on the transmission beam of the SRS resource.

Hereinafter, non-codebook based PUSCH transmission will now be described. Non-codebook based PUSCH transmission may be dynamically scheduled by DCI format 0_0 or 0_1, or semi-statically operated by the configured grant. When at least one SRS resource in an SRS resource set in which a value of the usage in SRS-ResourceSet that is higher layer signaling is configured to ‘nonCodebook’ is configured, the UE may be scheduled for non-codebook based PUSCH transmission by DCI format 0_1.

For the SRS resource set with a value of the usage in SRS-ResourceSet that is higher layer signaling being configured to ‘nonCodebook’, the UE may be configured with one associated non-zero power CSI-RS (NZP CSI-RS) resource. The UE may perform calculation on a precoder for SRS transmission by measuring the NZP CSI-RS resource associated with the SRS resource set. If a difference between a last reception symbol of an aperiodic NZP CSI-RS resource associated with the SRS resource set and a first symbol of aperiodic SRS transmission from the UE is less than 42 symbols, the UE does not expect that information about the precoder for SRS transmission is to be updated.

When a value of resourceType in SRS-ResourceSet that is higher layer signaling is configured to ‘aperiodic’, an associated NZP CSI-RS is indicated by the field SRS request in DCI format 0_1 or 1_1. Here, when the associated NZP CSI-RS resource is an aperiodic NZP CSI-RS resource, it indicates existence of an NZP CSI-RS associated for a case where the value of the field SRS request in DCI format 0_1 or 1_1 is not ‘00’. Here, the DCI shall not indicate cross carrier or cross BWP scheduling. In addition, if the value of the SRS request indicates the existence of the NZP CSI-RS, the NZP CSI-RS is located in a slot in which a PDCCH including the SRS request field is transmitted. Here, TCI states configured for a scheduled subcarrier are not configured to QCL-TypeD.

If a periodic or semi-persistent SRS resource set is configured, an associated N ZP CSI-RS maybe indicated by associated CSI-RS in higher layer signaling SRS-ResourceSet. For non-codebook based transmission, the UE does not expect both the spatialRelationInfo that is higher layer signaling for an SRS resource and associatedCSI-RS in the SRS-ResourceSet that is higher layer signaling to be configured.

When the UE is configured with a plurality of SRS resources, the UE may determine a precoder and a transmission rank to be applied to PUSCH transmission, based on the SRI indicated by the BS. Here, the SRI may be indicated by a SRS resource indicator that is a field in DCI or may be configured by srs-Resourcelndicator that is higher layer signaling. Likewise, in regard to the codebook based PUSCH transmission, when the UE is provided the SRI by DCI, an SRS resource indicated by the SRI refers to an SRS resource corresponding to the SRI among SRS resources transmitted before the PDCCH including the SRI. The UE may use one or more SRS resources in SRS transmission, and a maximum number of SRS resources available for simultaneous transmission on the same symbol in one SRS resource set and a maximum number of SRS resources are determined based on UE capability reported by the UE to the BS. In this case, the SRS resources simultaneously transmitted by the UE occupy a same RB. The UE configures one SRS port for each SRS resource. Only one SRS resource set with a value of the usage in SRS-ResourceSet that is higher layer signaling is configured to ‘nonCodebook’ may be configured, and maximally up to four SRS resources for non-codebook based PUSCH transmission may be configured.

The BS transmits one N ZP-CSI-RS associated with the SRS resource set to the UE, and the UE calculates a precoder to be used in transmission of one or more SRS resources in the SRS resource set, based on a result of measurement performed in reception of the NZP_CSI-RS. The UE applies the calculated precoder to transmit, to the BS, one or more SRS resources in the SRS resource set with the usage configured to ‘nonCodebook’, and the BS selects one or more SRS resources from among the received one or more SRS resources. Here, for the non-codebook based PUSCH transmission, the SRI may indicate an index that can represent a combination of one or more SRS resources, and may be included in DCI. Here, the number of SRS resources indicated by the SRI transmitted from the BS may be the number of transmission layers of the PUSCH, and the UE transmits the PUSCH by applying, to each layer, the precoder applied to SRS resource transmission.

PUSCH: preparation procedure time

Hereinafter, a PUSCH preparation procedure time will now be described. When the BS schedules the UE to transmit a PUSCH by using DCI format 0_0, 0_1 or 0_2, the UE may need a PUSCH preparation procedure time to transmit the PUSCH by applying a transmission method (an SRS resource transmission precoding method, the number of transmission layers, or a spatial domain transmission filter) indicated by DCI. Based on information above, NR defines a PUSCH preparation procedure time. The PUSCH preparation procedure time of the UE may be calculated using Equation 1 below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad Equation 1$$

Variables in T_{proc,2} expressed in Equation 1 may have the following meanings.
N₂: the number of symbols determined according to UE processing capability 1 or 2 and numerology p. When the UE capability 1 is reported in a UE capability report, it may have a value based on Table 14, and when the UE capability 2 is reported in the UE capability report and when it is configured, by higher layer signaling, that the UE capability 2 is available, it may have a value based on Table 15.

TABLE 14

| | PUSCH preparation |
|---|---|
| μ | time N₂ [symbols] |
| 0 | 10 |
| 1 | 12 |
| 2 | 23 |
| 3 | 36 |

TABLE 15

| | PUSCH preparation |
|---|---|
| μ | time N₂ [symbols] |
| 0 | 5 |
| 1 | 5.5 |
| 2 | 11 for frequency |
| | range 1 |

d_{2,1}: the number of symbols which is determined to be 0 when resource elements of the first OFDM symbol are all configured to consist of DMRSs, or 1 otherwise.
η: 64
μ: This follows a value of μ_{DL}or μ_{UL} which makes T_{proc,2} larger. μ_{DL}refers to numerology of a DL in which a PDCCH including DCI that schedules the PUSCH is transmitted, and μ_{UL} refers to numerology of a UL in which the PUSCH is transmitted.
TC: 1/(Δfₘₐₓ·N_{f}), Δfₘₐₓ=480·10³ Hz, N_{f}=4096
d_{2,2}: This may follow a BWP switching time when the DCI that schedules the PUSCH indicates BWP switching, or may have ‘0′ otherwise.
d₂: When OFDM symbols of a PUCCH, a PUSCH having a high priority index and a PUCCH having a low priority index overlap on the time domain, a d₂ value of the PUSCH having the high priority index is used. Otherwise, d₂ is 0.
Tₑₓₜ: When the UE uses a shared spectrum channel access scheme, the UE may calculate Tₑₓₜ and may apply Tₑₓₜ to the PUSCH preparation procedure time. Otherwise, Tₑₓₜ is assumed to be 0.
T_{switch}: When a UL switching interval is triggered, T_{switch} is assumed as a switching interval time. Otherwise, T_{switch} is assumed to be 0.

Based on time-axis resource mapping information of the PUSCH scheduled by the DCI and an impact of timing advance between the UL and the DL, the BS and the UE determines that the PUSCH preparation procedure time is not sufficient when a first symbol of the PUSCH starts before a first UL symbol on which CP starts after T_{proc,2} from a last symbol of the PDCCH including the DCI that schedules the PUSCH. Otherwise, the BS and the UE determines that the PUSCH preparation procedure time is sufficient. Only when the PUSCH preparation procedure time is sufficient, the UE may transmit the PUSCH, and when the PUSCH preparation procedure time is not sufficient, the UE may ignore the DCI that schedules the PUSCH.

PUSCH: related to repetitive transmission

Hereinafter, UL data channel repetitive transmissions in the 5G system will now be described in detail. The 5G system supports two types of UL data channel repetitive transmission methods that are PUSCH repetitive transmission type A and PUSCH repetitive transmission type B. The UE may be configured with one of the PUSCH repetitive transmission types A or B by higher layer signaling.

1 PUSCH repetitive transmission type A
As described above, symbol length and a start symbol position of a UL data channel may be determined in a time domain resource allocation method in one slot, and the BS may notify the UE of the number of repetitive transmissions by higher layer signaling (e.g., RRC signaling) or L1 signaling (e.g., DCI).
The UE may repetitively transmit a UL data channel having a same length and start symbol as those of the UL data channel in consecutive slots, based on the number of repetitive transmissions received from the BS. In this case, when a slot configured by the BS for the UE in a DL or at least one of symbols of a UL data channel configured for the UE is configured for DL, the UE skips UL data channel transmission but counts the number of repetitive transmissions of the UL data channel.

2. PUSCH repetitive transmission type B
As described above, a start symbol and length of a UL data channel may be determined in a time domain resource allocation method in one slot, and the BS may notify the UE of numberofrepetitions that is the number of repetitive transmissions by higher layer signaling (e.g., RRC signaling) or L1 signaling (e.g., DCI).
Based on the start symbol and length of the UL data channel which are previously configured, nominal repetition of the UL data channel is determined as below. A slot in which n-^{th} nominal repetition starts is given by

$${K}_{s} + ⌊ \frac{S + n \cdot L}{{N}_{symb}^{slot}} ⌋$$

and is given by

$${K}_{s} + ⌊ \frac{S + ( n + 1 ) \cdot L - 1}{{N}_{symb}^{slot}} ⌋ ,$$

and a symbol that ends in the slot is given by

$$mod ( S + ( n + 1 ) \cdot L - 1 , {N}_{symb}^{slot} ) .$$

Here, n=0, . . . , numberofrepetitions-1, S indicates a start symbol of the configured UL data channel, and L indicates symbol length of the configured UL data channel. ^{K}, indicates a slot in which the PUSCH transmission starts, and

$${N}_{symb}^{slot}$$

indicates the number of symbols per slot.

The UE determines an invalid symbol for the PUSCH repetitive transmission type B. A symbol configured for DL by TDD-UL-DL-ConfigurationCommon or TDD-UL-DL-ConfigurationDedicated is determined as an invalid symbol for the PUSCH repetitive transmission type B. In addition, the invalid symbol may be configured by a higher layer parameter (e.g., InvalidSymbolPattern). The higher layer parameter (e.g., InvalidSymbolPattern) may provide a symbol-level bitmap spanning one slot or two slots such that the invalid symbol may be configured. In the bitmap, ‘1′ representsthe invalid symbol. In addition, periodicity and a pattern of the bitmap may be configured by a higher layer parameter (e.g., periodicityA ndPattern). If the higher layer parameter (e.g., InvalidSymbolPattern) is configured and parameter InvalidSymbolPatternlndicator-ForDCIFormat0_1 or InvalidSymbolPatternlndicator-ForDCIFormat0_2 indicates ‘1′, the UE applies an invalid symbol pattern, and when the parameter indicates ‘0′, the UE does not apply the invalid symbol pattern. If the higher layer parameter (e.g., InvalidSymbolPattern) is configured and the parameter InvalidSymbolPatternlndicator-ForDCIFormat0_1 or InvalidSymbolPatternlndicator-ForDCIFormat0_2 is not configured, the UE applies the invalid symbol pattern.

After the invalid symbol is determined, the UE may consider symbols other than the invalid symbol as valid symbols for each nominal repetition. When one or more valid symbols are included in each nominal repetition, the nominal repetition may include one or more actual repetitions. Here, each of the actual repetitions includes a set of consecutive valid symbols available for the PUSCH repetitive transmission type B in one slot.

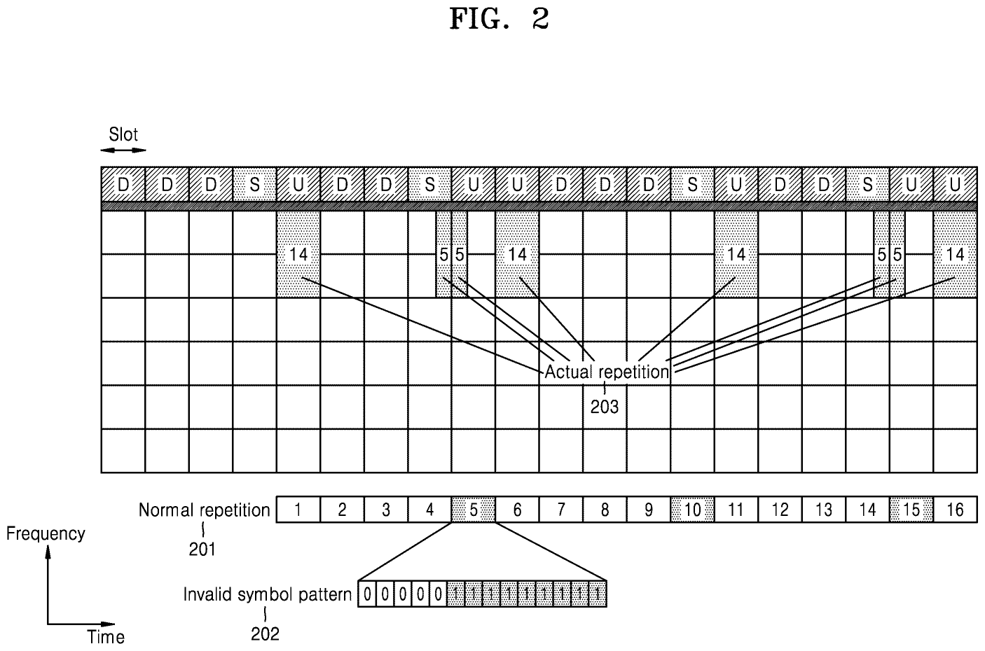

FIG. 2 is a diagram illustrating a PUSCH repetitive transmission type B in a wireless communication system according to an embodiment of the disclosure.

Referring to FIG. 2, the UE may be configured with a start symbol S of a UL data channel as 0, may be configured with length L of the UL data channel as 14, and may be configured with the number of repetition times as 16. In this case, nominal repetition 201 is performed in 16 consecutive slots. Afterward, the UE may determine a symbol configured as a DL symbol in each nominal repetition 201 as an invalid symbol. In addition, the UE determines symbols configured to ‘1′ in an invalid symbol pattern 202 as invalid symbols. In a case where valid symbols other than the invalid symbols are configured as one or more consecutive symbols in a slot in each nominal repetition, the one or more consecutive symbols are configured and transmitted as actual repetition 203.

In addition, for PUSCH repetitive transmission, the NR release 16 may define additional methods below for UL-grant based PUSCH transmission and configured-grant based PUSCH transmission that over a slot boundary.

Method 1 (mini-slot level repetition): two or more PUSCH repetitive transmissions in one slot or over boundaries of consecutive slots are scheduled by one UL grant. For Method 1, time domain resource allocation information in DCI indicates a resource for the first repetitive transmission. In addition, time domain resource information of the remaining repetitive transmissions may be determined according to the time domain resource information of the first repetitive transmission and the UL or DL direction determined for each symbol of each slot. Each repetitive transmission occupies consecutive symbols.

Method 2 (multi-segment transmission): two or more PUSCH repetitive transmissions in consecutive slots are scheduled by one UL grant. Here, one-time transmission is designated for each slot, and a start point or a repetitive length may vary for each transmission. In addition, in Method 2, time domain resource allocation information in DCI indicates start points and repetition lengths of all the repetitive transmissions. In addition, in a case where repetitive transmissions are performed in one slot according to Method 2, when there are several groups of consecutive UL symbols in the slot, each repetitive transmission is performed per each of the UL symbol groups. If there is one group of consecutive UL symbols in the slot, PUSCH repetitive transmission is performed one time according to the method of NR Release 15.
Method 3: two or more PUSCH repetitive transmissions in consecutive slots are scheduled by two or more UL grants. Here, one-time transmission is designated for each slot, and nth UL grant may be received before PUSCH transmission scheduled by n−1^{st} UL grant ends.
Method 4: one or more PUSCH repetitive transmissions in one slot or two or more PUSCH repetitive transmissions over the boundaries of consecutive slots may be supported by one UL grant or one configured grant. The number of repetitions indicated by the BS to the UE is a nominal value, and an actual number of PUSCH repetitions performed by the UE may be greater than the nominal number of repetitions. Time domain resource allocation information in DCI or configured grant indicates a resource of first repetitive transmission indicated by the BS. Time domain resource information of the rest of repetitive transmissions may be determined by referring to at least the resource information of the first repetitive transmission and UL or DL direction of symbols. If the time domain resource information of the repetitive transmission indicated by the BS span boundaries of slots or includes a UL/DL transition point, the repetitive transmission may be divided into a plurality of repetitive transmissions. Here, one repetitive transmission may be included in each UL period in one slot.

### Related to SRS

Hereinafter, a UL channel estimation method using sounding reference signal (SRS) transmission of the UE will now be described. The BS may configure the UE with at least one SRS configuration for each UL BWP so as to transmit configuration information for SRS transmission, and may configure the UE with at least one SRS resource set for each SRS configuration. For example, the BS and the UE may exchange higher layer signaling information to deliver information about the SRS resource set.
srs-ResourceSetID: SRS resource set index
srs-ResourceldList: a set of SRS resource indexes referred to from the S R S resource set
resourceType: time-axis transmission configuration of an SRS resource referred to from the SRS resource set, which may be configured to one of ‘periodic’, ‘semi-persistent’, and ‘aperiodic’. If resourceType is configured to ‘periodic’ or ‘semi-persistent’, associated CSI-RS information may be provided according to the usage of the SRS resource set. If resourceType is configured to ‘aperiodic’, an aperiodic SRS resource trigger list and slot offset information may be provided, and associated C SI-RS information may be provided according to the usage of the SRS resource set.
usage: configuration of the usage of an SRS resource referred to from the SRS resource set, which may be configured to one of ‘beamManagement’, ‘codebook’, ‘nonCodebook’, and ‘antennaSwitching’.
alpha, p0, pathlossReferenceRS, srs-PowerControlAdjustmentStates: provides parameter configuration for transmission power control for an SRS resource referred to from the SRS resource set.

The UE may determine that an SRS resource included in a set of SRS resource indexes referred to from the SRS resource set follows information configured for the SRS resource set.

In addition, the BS and the UE may transmit or receive higher layer signaling information for delivering individual configuration information for an SRS resource. For example, the individual configuration information for the SRS resource may include time-frequency axis mapping information in a slot of the SRS resource, and the time-frequency axis mapping information may include information about intra-slot or inter-slot frequency hopping of the SRS resource. Furthermore, the individual configuration information for the SRS resource may include time-axis transmission configuration for the SRS resource, which may be configured to one of ‘periodic’, ‘semi-persistent’, and ‘aperiodic’. This may be limited to having the same time-axis transmission configuration as the SRS resource set including the SRS resource. If the time-axis transmission configuration for the SRS resource is configured to ‘periodic’ or ‘semi-persistent’, additional SRS resource transmission periodicity and slot offset (e.g., periodicityAndOffset) may be included in the time-axis transmission configuration.

The BS may activate or deactivate, or trigger SRS transmission to the UE by higher layer signaling including RRC signaling or MAC CE signaling, or L1 signaling (e.g., DCI). For example, the BS may activate or deactivate periodic SRS transmission to the UE by higher layer signaling. The BS may indicate activation of an SRS resource set for which resourceType is configured to ‘periodic’ by higher layer signaling, and the UE may transmit an SRS resource referred to from the activated SRS resource set. Time-frequency axis resource mapping of the SRS resource to be transmitted in a slot follows resource mapping information configured for the SRS resource, and slot mapping including transmission periodicity and slot offset follows periodicityAndOffset configured for the SRS resource. Furthermore, a spatial domain transmission filter applied to the SRS resource to be transmitted may refer to spatial relation info configured for the SRS resource or may refer to associated CSI-RS information configured for the SRS resource set including the SRS resource. The UE may transmit the SRS resource in a UL BWP activated for the periodic SRS resource activated by higher layer signaling.

For example, the BS may activate or deactivate semi-persistent SRS transmission to the UE by higher layer signaling. The BS may indicate activation of an SRS resource set by MAC CE signaling, and the UE may transmit an SRS resource referred to from the activated SRS resource set. The SRS resource set activated by M A C CE signaling may be limited to an SRS resource set for which the resourceType is configured to ‘semi-persistent’. Intra-slottime-frequency axis resource mapping of the SRS resource to be transmitted follows resource mapping information configured for the SRS resource, and slot mapping including transmission periodicity and slot offset follows periodicityAndOffset configured for the SRS resource. Furthermore, a spatial domain transmission filter applied to the SRS resource to be transmitted may refer to spatial relation info configured for the SRS resource or may refer to associated CSI-RS information configured for the SRS resource set including the SRS resource. If spatial relation info is configured for the SRS resource, the spatial domain transmission filter may not follow the spatial relation info but may be determined by referring to configuration information about spatial relation info delivered by MAC CE signaling that activates semi-persistent SRS transmission. The UE may transmit the SRS resource in a UL BWP activated for the semi-persistent SRS resource activated by higher layer signaling.

For example, the BS may trigger aperiodic SRS transmission to the UE by DCI. The BS may indicate one of aperiodic SRS resource triggers (aperiodicSRS-ResourceTrigger) via an SRS request field of the DCI. The UE may identify/determine that an SRS resource set including the aperiodic SRS resource trigger indicated by the DCI in an aperiodic SRS resource trigger list among configuration information of the SRS resource set has been triggered. The UE may transmit an SRS resource referred to from the triggered SRS resource set. Intra-slot time-frequency axis resource mapping of the SRS resource to be transmitted follows resource mapping information configured for the SRS resource. In addition, slot mapping of the SRS resource to be transmitted may be determined by a slot offset between a PD CC H including the DCI and the SRS resource, and may be referred to a value (or values) included in a slot offset set configured for the SRS resource set. In more detail, for the slot offset between the PDCCH including the DCI and the SRS resource, a value indicated by a time domain resource assignment field of the DCI among offset value(s) included in the slot offset set configured for the SRS resource set may be applied. Furthermore, a spatial domain transmission filter applied to the SRS resource to be transmitted may refer to spatial relation info configured for the SRS resource or may refer to associated CSI-RS information configured for the SRS resource set including the SRS resource. The UE may transmit the SRS resource in a UL BWP activated for the aperiodic SRS resource triggered by the DCI.

When the BS triggers aperiodic SRS transmission to the UE by DCI, a minimum time interval between a PDCCH including the DCI that triggers the aperiodic SRS transmission and an SRS to be transmitted may be required for the UE to transmit the SRS by applying configuration information for the SRS resource. The time interval for SRS transmission of the UE may be defined with the number of symbols between the last symbol of the PDCCH including the DCI that triggers the aperiodic SRS transmission and the first symbol to which an SRS resource to be first transmitted among SRS resource(s) is mapped. The minimum time interval may be determined by referring to a PUSCH preparation procedure time required for the UE to prepare PUSCH transmission. In addition, the minimum time interval may have a different value according to the usage of the SRS resource set including the SRS resource to be transmitted. For example, the minimum time interval may be determined to be N2 symbols defined by referring to a PUSCH preparation procedure time of the UE and considering a UE processing capability based on the UE capability. In addition, when the usage of the SRS resource set is configured to ‘codebook’ or ‘antennaSwitching’ by considering the usage of the SRS resource set including the SRS resource to be transmitted, the minimum time interval may be determined to be N 2 symbols, and when the usage of the SRS resource set is configured to ‘nonCodebook’ or‘beamManagement’, the minimum time interval may be determined to be N 2+14 symbols. When the time interval for aperiodic SRS transmission is equal to or greater than the minimum time interval, the UE may transmit an aperiodic SRS, and when the time interval for aperiodic SRS transmission is smaller than the minimum time interval, the UE may ignore the DCI that triggers the aperiodic SRS.

TABLE 16

| | |
|---|---|
| SRS-Resource ::= | SEQUENCE { |
| srs-ResourceId | SRS-ResourceID, |
| nrofSRS-Ports | ENUMERATED {port1, ports2, |
| | ports4}, |

| | |
|---|---|
| ptrs-PortIndex | ENUMERATED |
| | {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceM apping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
      ...
    },
```

| | |
|---|---|
| semi-persistent | SEQUENCE { |

| | |
|---|---|
| periodicityAndOffset-sp | SRS-PeriodicityAndOffset, |

```
      ...
    },
```

| | |
|---|---|
| periodic | SEQUENCE { |

| | |
|---|---|
| periodicityAndOffset-p | SRS-PeriodicityAndOffset, |

```
      ...
    }
  },
```

| | |
|---|---|
| sequenceID | INTEGER (0..1023), |

| | |
|---|---|
| spatialRelationInfo | SRS- |
| | SpatialRelationInfo |

OPTIONAL, -- Need R
...
}

Configuration information of spatialRelationInfo in Table 16 above is to refer to one reference signal and apply beam information of the reference signal to a beam used for the SRS transmission. For example, the configuration of spatialRelationInfo may include information as in Table 17 below.

TABLE 17

| | |
|---|---|
| SRS-SpatialRelationInfo ::= | SEQUENCE { |
| servingCellID | ServCellIndex OPTIONAL, -- Need S |
| referenceSignal | CHOICE { |
| ssb-Index | SSB-Index, |
| csi-RS-Index | NZP-CSI-RS-ResourceID, |
| srs | SEQUENCE { |
| resourceID | SRS-ResourceID, |
| uplinkBWP | BWP-Id |

```
    }
  }
}
```

Referring to the spatial RelationInfo configuration, in order to use beam information of a particular reference signal, an SS/PBCH block index, a CSI-RS index or an SRS index may be configured as an index of a reference signal to be referred to. Higher layer signaling referenceSignal is configuration information indicating which beam information of a reference signal is to be referred to for the SRS transmission, and ssb-index refers to an index of an SS/PBCH, csi-R S-index refers to an index of a CSI-RS, and SRS refers to an index of an SRS. If a value of the higher layer signaling referenceSignal is configured to ‘ssb-Index’, the UE may apply a reception beam, which has been used to receive an SS/PBCH block corresponding to the ssb-index, to a transmission beam for corresponding SRS transmission. If a value of the higher layer signaling referenceSignal is configured to ‘csi-RS-Index’, the UE may apply a reception beam, which has been used to receive a CSI-RS corresponding to the csi-RS-index, to a transmission beam for corresponding SRS transmission. If a value of the higher layer signaling referenceSignal is configured to ‘SRS’, the UE may apply a transmission beam, which has been used to transmit an SRS corresponding to the SRS, to a transmission beam for corresponding SRS transmission.

### Related to UL PTRS

The UE may be configured with phaseTrackingRS that is a higher layer parameter for PTRS, on a higher layer parameter of DMRS-UplinkConfig. When the UE transmits a PUSCH to the BS, the UE may transmit a PTRS for phase tracking with respect to a UL channel. A procedure in which the UE transmits a UL PTRS may be determined according to whether to perform transform precoding in PUSCH transmission. When a transformPrecoderEnabled area is configured in a higher layer parameter of PTRS-UplinkConfig as the transform precoding is performed, sampleDensity in the transformPrecoderEnabled area may indicate sample density thresholds represented by N_{RB0} to N_{RB4} of Table below. When the transformPrecoderEnabled area is configured in the higher layer parameter of PTRS-UplinkConfig as the transform precoding is performed, the UE may determine a PT-RS group pattern for a scheduled resource N_{RB} according to Table 18. In addition, when the transform precoder is applied to PUSCH transmission, the number of bits in a PTRS-DMRS association for indicating association between a PTRS in a DCI format 01 or 0_2and a DMRS.

TABLE 18

| | Number | Number of |
|---|---|---|
| | of PT-RS | samples per |
| Scheduled bandwidth | groups | PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

When the transform precoding is not applied to the PUSCH transmission, and phaseTrackingRS that is a higher layer parameter is configured, in a transformPrecoderDisabled area in a higher layer parameter, PTRS-UplinkConfig, frequecyDensity indicates N_{RB0}to N_{RB1}, and timeDensity indicates ptrs-MCS₁ to ptrs-MCS₃. The UE may determine PT-RS density of a time domain L_{PT-RS} and PT-RS density (K_{PT-RS}) of a frequency domain, according to MCS (I_{MCS}) and RB (N_{RB}) of the scheduled PUSCH, as shown in Tables 19 and 20. In Table 19, ptrs-MCS₄ is not indicated as a higher layer parameter, but the BS and the UE may identify that it is 29 or 28, according to MCS Table.

TABLE 19

| | Time Density |
|---|---|
| Scheduled MCS | (L_{PT-RS}) |
| I_{MCS} < ptrs-MCS₁ | PT-RS is |
| | not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 20

| | Frequency density |
|---|---|
| Scheduled bandwidth | (K_{PT-RS}) |
| N_{RB} < N_{RB0} | PT-RS is |
| | not present |
| N_{RB0} ≤ NRB < N_{RB1} | 2 |
| N_{RB1} ≤ NRB | 4 |

When the transform precoder is not applied to the PUSCH transmission and the PTRS-UplinkConfig is configured, the BS may configure the UE with 2 bits in the ‘PTRS-DMRS association’ area so as to indicate association between a PTRS in a DCI format 0_1 or 0_2 and a DMRS. The indicated ‘PTRS-DMRS association’ area with 2 bits may be applied to Table 21 or 22, according to a maximum number of PTRS ports which is configured by maxNrofPorts in the higher layer parameter of PTRS-UplinkConfig. If the maximum number of PTRS ports is 1, the UE may determine association between the PTRS and the DMRS which is indicated by Table 21 and 2 bits in the PTRS-DMRS association area, and may transmit the PTRS according to the determined association. If the maximum number of PTRS ports is 2, the UE may determine association between the PTRS and the DMRS which is indicated by Table 22 and 2 bits in the PTRS-DMRS association area, and may transmit the PTRS according to the determined association.

TABLE 21

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 22

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

DMRS ports in Tables 21 and 22 may be determined via Table determined by higher layer parameter configuration and an ‘Antenna ports' area which are indicated by the same DCI as DCI indicating the PTRS-DMRS association. In a case where the transform precoder is not configured by higher layer configuration of the PUSCH, dmrs-Type is set to 1 and max Length is set to 2 with respect to the DMRS, and a rank of the PUSCH is 2, the Up may determine a DMRS port by Table about ‘Antenna port(s)’ as Table 23 and a bit indicated in the ‘Antenna ports' area. When a noncodebook based PUSCH is supported, the UE may determine a value of a rank by referring to a SRI area indicated by the same DCI as DCI including the ‘Antenna ports' area (that is, when the SRI area does not exist, the rank may be regarded as 1). When a codebook based PUSCH is supported, the UE may determine a value of a rank by referring to a TPMI area indicated by the same DCI as DCI including the ‘Antenna ports' area. Table 23 is an example of Table of antenna ports referred to in the PUSCH configuration described above, and if a PUSCH is configured by a different parameter, a DMRS port may be determined according to Table of antenna ports according to the configuration and a bit of the ‘Antenna ports' area which is indicated by DCI.

TABLE 23

| | Number of DMRS code | | |
|---|---|---|---|
| | division multiplexing | | Number of |
| | (CDM) group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

1^{st} scheduled DMRS to 4^{th} scheduled DMRS of Table 21 may be defined as values obtained by sequentially mapping bits of an antenna ports area of DCI and DMRS ports indicated by Table of antenna ports according to higher layer configuration. For example, when a bit of the antenna ports area of the DCI is 0001, and a DMRS port is determined based on Table 23 above, the scheduled DMRS port may be 0 and 1, the DMRS port 0 may be defined as 1st scheduled DMRS, and the DMRS port 1 may be defined as 2^{nd} scheduled DMRS. This may be similarly applied to a DMRS port determined based on a different bit of the antenna ports area and Table of antenna ports according to different higher layer configuration. The UE may determine one DMRS port to be associated with a PTRS port by referring to a bit indicated by PTRS-DMRS association in DCI among the DMRS ports defined as above, and may transmit a PTRS via the determined DMRS port.

In Table 22, a DMRS port sharing PTRS port 0 and a DMRS port sharing PTRS port 1 may be defined according to codebook based PUSCH transmission or non-codebook based PUSCH transmission. If the UE transmits a PUSCH based on partial-coherent or non-coherent codebook, a UL layer transmitted via PUSCH antenna ports 1000 and 1002 is associated with PTRS port 0, and a UL layer transmitted via PUSCH antenna ports 1001 and 1003 is associated with PTRS port 1. According to a particular example, when layer 3: TPMI=2 is selected for codebook based PUSCH transmission, a first layer is transmitted via PUSCH antenna ports 1000 and 1002 and thus is associated with PTRS port 0, and a second layer is transmitted via PUSCH antenna port 1001 and a third layer is transmitted via PUSCH antenna port 1002, such that the second and third layers are associated with PTRS port 1. The three layers respectively indicate DMRS ports, and a DMRS port for the first layer corresponds to ‘1^{st} DMRS port which shares PTRS port 0′ in Table 22, a DMRS port for the second layer corresponds to ‘1^{st} DMRS port which shares PTRS port 1’ in Table 22, and a DMRS port for the third layer corresponds to ‘2^{nd} DMRS port which shares PTRS port 1’ in Table 22. Similarly, a DMRS port associated with PTRS port 0 and a DMRS port associated with PTRS port 1 may be determined according to a different number of layers and TPMI.

If the UE transmits a PUSCH based on non-codebook, the DMRS port associated with PTRS port 0 and the DMRS port associated with PTRS port 1 may be distinguished therebetween, according to an SRI and antenna ports indicated by DCI. In more detail, an SRS resource included in an SRS resource set whose usage is ‘nonCodebook’ is configured to be associated with PTRS port 0 or PTRS port 1 by a higher layer parameter of ptrs-PortIndex. The BS indicates an SRS resource by an SRI so as to transmit a non-codebook based PUSCH. Here, a port of each indicated SRS resource is one-to-one mapped to each PUSCH DMRS port. An association relation between a PUSCH DMRS port and a PTRS port is determined according to ptrs-PortIndex that is a higher layer parameter of the SRS resource mapped to the DMRS port. According to a particular example, it is assumed that ptrs-PortIndex is configured as n0, n0, n1, and n1 respectively for SRS resources 1 to 4 included in an SRS resource set whose usage is nonCodebook. In addition, it is assumed that it is indicated by the SRI so as to transmit a PUSCH via SRS resources 1, 2, and 4, and DMRS ports 0, 1, and 2 are indicated as antenna port areas. Ports of respective SRS resources 1, 2, and 4 are mapped to DMRS ports 0, 1, and 2. According to ptrs-PortIndex in an SRS resource, DMRS ports 0 and 1 are associated with PTRS port 0, and DMRS port 2 is associated with PTRS port 1. Therefore, in Table 22, DMRS port 0 corresponds to ‘1^{st} DMRS port which shares PTRS port 0′, DMRS port 1 corresponds to ‘2^{nd} DMRS port which shares PTRS port 0′, and DMRS port2 corresponds to ‘1^{st} DMRS port which shares PTRS port 1′. Similarly, a DMRS port associated with PTRS port 0 and a DMRS port associated with PTRS port 1 may be determined according to a method of configuring ptrs-PortIndex in an SRS resource with a different pattern, and a different SRI value. With respect to two PTRS ports, the UE determines an association relation between a DMRS port and a PTRS port as described above. Afterward, the UE determines a DMRS port to be associated with PTRS port 0 by considering an MSB bit of PTRS-DMRS association among a plurality of DMRS ports having relations with each PTRS port, determines a DMRS port to be associated with PTRS port 1 by referring to an LSB bit, and transmits a PTRS.

SRS comb offset/cyclic shift configuration method

A comb offset and cyclic shift configuration method in SRS transmission of the UE w ill now be described.

The UE may be configured with an SRS resource through higher layer signaling SRS-Resource or SRS-PosResource from the BS, and may include the following items:
For a case of an SRS-Resource, the UE may be configured with the number of antenna ports for each SRS resource, and its value may be defined as

$${N}_{ap}^{SRS}$$

∈ {1,2,4,8} and may be configured by nrofSRS-Ports or nrofSRS-Ports-n8 which is higher layer signaling. If usage that is higher layer signaling in SRS-ResourceSet is configured as a value other than nonCodebook, pᵢ=1000+i may indicate a number of ith antenna port, and i may be 0 to an integer of

$${N}_{ap}^{SRS} - 1.$$

If usage that is higher layer signaling in SRS-ResourceSet is configured as nonCodebook, each SRS resource may be configured with

$${N}_{ap}^{SRS} = 1$$

antenna ports, and an antenna port of i+1th SRS resource in SRS-ResourceSet may be defined as pᵢ=1000+i. SRS-PosResource may be defined as

$${N}_{ap}^{SRS} = 1.$$

The UE may be configured with the number of consecutive symbols on which SRS is transmitted, by nr of Symbols in resource Mapping that is higher layer signaling from the BS, and its value may be defined as

$${N}_{symb}^{SRS}$$

∈ {1,2,4,8,10,12,14}.
The UE may be configured with a position of a start symbol on which SRS is transmitted in one slot, by start Position in resource Mapping that is higher layer signaling from the BS, and its value may be defined as

$${l}_{0} = {N}_{symb}^{slot} - 1 - {l}_{offset} .$$

### Here,

$${N}_{symb}^{slot}$$

may indicate the number of symbols in a slot, and its value may be 14 in a case of normal cyclic prefix and may be 12 in a case of extended cyclic prefix. l_{offset} ∈ {0,1, . . . ,13} may indicate an offset value obtained by inversely counting the number of symbols starting from a symbol positioned at the end of a slot. Here,

$${l}_{offset} \geq {N}_{symb}^{SSR} - 1$$

may be satisfied.
k₀ may indicate a start position of a frequency resource on which SRS is transmitted.

An SRS sequence that may be generated via an SRS resource defined based on the information may be defined by Equation 2 below.

$${r}^{( {p}_{i} )} ( n , {l}^{′} ) = {w}_{TDM}^{( {p}_{i} )} ( {l}^{′} ) {r}_{u , v}^{( {α}_{i} , δ )} ( n ) \qquad Equation 2$$

$$0 \leq n \leq {M}_{sc , b}^{SRS} - 1$$

$${l}^{′} ∈ \{ 0 , 1 , … , {N}_{symb}^{SRS} - 1 \}$$

Here,

$${M}_{sc , b}^{SRS} = {m}_{SRS , b} {N}_{sc}^{RB} / ( {K}_{TC} {P}_{F} )$$

indicates the length of the SRS sequence. m_{SRS,b} may be determined based on Table 25 below, and may be determined by b-SRS and c-SRS which are higher layer signaling. Here, when b-SRS is configured, B_{SRS} ∈ {0,1,2,3}value in Table 25 below may be determined, and a value of b that is a subscript of m_{SRS,b}, and when b-SRS is not configured, it is possible that B_{SRS}=0 c-SRS may determine C_{SRS} ∈ {0,1, . . . ,63}value in Table 25 below. PF E {2,4} may be determined by FreqScalingFactor that is higher layer signaling, and when the corresponding parameter is not configured, it is possible that PF=1. When FreqScalingFactor that is higher layer signaling is configured, the UE may expect that the length of the SRS sequence is a multiple of 6.

Definition of δ=log₂(K_{TC}) may be possible, and K_{TC} ∈ {2,4,8} may determine a size of comb. Here, the size of the comb may indicate a gap between REs in which SRS is transmitted on a frequency resource, and for example, when the size of the comb is K_{TC}=2, it may mean that a gap between REs in which the SRS is transmitted is 2 REs. The UE may be configured with the size of the comb by transmissionComb that is higher layer signaling. l′∈

$$\{ 0 , 1 , … , {N}_{symb}^{SRS} - 1 \}$$

may indicate a symbol index in symbols on which an SRS resource is transmitted. The UE may determine

$${n}_{SRS}^{cs , max}$$

that is a maximum cyclic shift value, according to K_{TC} value, as in Table 24 below.

TABLE 24

| K_{TC} | n_{SRS}^{cs, max} |
|---|---|
| 2 | 8 |
| 4 | 12 |
| 8 | 6 |

$${r}_{u , v}^{( {α}_{i} , δ )} ( n )$$

may be defined as below via αᵢ indicating a cyclic shift of an ith antenna port and r̅_{u,v}(n) that is a basic sequence.

$${r}_{u , v}^{( {α}_{i} , δ )} ( n ) = {e}^{j {α}_{i} n} {\overline{r}}_{u , v} ( n ) , 0 \leq n < {M}_{ZC}$$

Here,

$${M}_{Z C} = {mN}_{sc}^{RB} / {2}^{δ}$$

may indicate the length of the SRS sequence. For one basic sequence, a plurality of SRS sequences may be generated according to different αᵢ and δ values.

A plurality of basic sequences may be divided into groups, an index of a group may be defined as u ∈ {0,1, . . . ,29}, and v may indicate an index of a basic sequence in the group. If it is 1/2<m/2^{δ}<5, each group may include one basic sequence, and in this regard, v=0. If it is 6<m/2^{δ}, each group may include two basic sequences, and in this regard, v=0,1. The definition of r̅_{u,v}(n) may vary according to a value of M_{ZC} which is a length of a sequence.

When a length of a basic sequence is equal to or greater than 36, i.e., when it is

$${M}_{Z C} \geq 3 {N}_{sc}^{RB} , {\overline{r}}_{u , v} ( n )$$

that is the basic sequency may be defined as below. Here, N_{ZC} may be a maximum decimal less than M_{ZC}

$${\overline{r}}_{u , v} ( n ) = {x}_{q} ( n mod {N}_{Z C} )$$

$${x}_{q} ( m ) = {e}^{- j \frac{π q m ( m + 1 )}{{N}_{ZC}}}$$

$$q = ⌊ \overline{q} + 1 / 2 ⌋ + v \cdot {( - 1 )}^{⌊ 2 \overline{q} ⌋}$$

$$\overline{q} = {N}_{Z C} \cdot ( u + 1 ) / 31$$

When the length of the basic sequence is 6, 12, 18, 24, i.e., when M_{ZC} ∈ {6,12,18,24}, r̅_{u,v}(n) that is the basic sequence may be defined as below.

$${\overline{r}}_{u , v} ( n ) = {e}^{j φ ( n ) π / 4} , 0 \leq n \leq {M}_{Z C} - 1$$

Here, a value of φ(n) may be defined based on Table 26 to Table 29 below.

When the length of the basic sequence is 30, i.e., when M_{ZC}=30, r̅_{u,v}(n) that is the basic sequence may be defined as below.

$${\overline{r}}_{u , v} ( n ) = {e}^{- j \frac{π ( u + 1 ) ( n + 1 ) ( n + 2 )}{31}} , 0 \leq n \leq {M}_{Z C} - 1$$

If the UE is configured with ports8tdm as nrofSRS-Ports-n8 that is higher layer signaling,

$${w}_{TDM}^{( {p}_{i} )} ( {l}^{′} )$$

may be defined as below, and otherwise, it may be defined as

$${w}_{TDM}^{( {p}_{i} )} ( {l}^{′} ) = 0 .$$

If l′ ∈

$$\{ 0 , 2 , … , {N}_{symb}^{S R S} - 2 \}$$

and pᵢ ∈ {1000,1001,1004,1005}, it may be defined as

$${w}_{TDM}^{( {p}_{i} )} ( {l}^{′} ) = 1 .$$

If l′ ∈

$$\{ 1 , 3 , … , {N}_{s y m b}^{S R S} - 1 \}$$

and pᵢ ∈ {1002,1003,1006,1007}, it may be defined as

$${w}_{T D M}^{( {p}_{i} )} ( {l}^{′} ) = 1 .$$

When two cases above are not true, it may be defined as

$${w}_{T D M}^{( {p}_{i} )} ( {l}^{′} ) = 0 .$$

αᵢ that indicates a cyclic shift corresponding to antenna port pᵢ may be defined as below.

$${α}_{i} = 2 π \frac{{n}_{S R S}^{cs , i}}{{n}_{S R S}^{cs , max}}$$

Here,

$${n}_{S R S}^{cs , i}$$

may be defined as below.
When

$${\overline{N}}_{ap}^{{}_{SRS}} = 8 and {n}_{S R S}^{cs , max} = 6 ,$$

it may be defined as

$${n}_{S R S}^{cs , i} = ( {n}_{S R S}^{cs} + \frac{{n}_{SRS}^{cs , max} ⌊ ( {\overline{p}}_{i} - 10 \; 00 ) / 4 ⌋}{{\overline{N}}_{ap}^{{}_{SRS}} / 4} ) mod {n}_{S R S}^{cs , max} .$$

When

$${\overline{N}}_{ap}^{{}_{SRS}} = 4 and {n}_{S R S}^{cs , max} = 6 , or {\overline{N}}_{ap}^{{}_{SRS}} = 8 and {n}_{S R S}^{cs , max} = 12 ,$$

may be defined as

$${n}_{S R S}^{cs , i} = ( {n}_{S R S}^{c s} + \frac{{n}_{S R S}^{cs , max} ⌊ ( {\overline{p}}_{i} - 10 \; 00 ) / 2 ⌋}{{\overline{N}}_{ap}^{{}_{SRS}} / 2} ) mod {n}_{S R S}^{cs , max} .$$

When two cases above are not true, it may be defined as

$${n}_{S R S}^{cs , i} = ( {n}_{S R S}^{c s} + \frac{{n}_{S R S}^{cs , max} ( {\overline{p}}_{i} - 1000 )}{{\overline{N}}_{ap}^{{}_{SRS}}} ) mod {n}_{S R S}^{cs , max} .$$

Here,

$${n}_{S R S}^{c s} ∈ \{ 0 , 1 , … , {n}_{S R S}^{cs , max} - 1 \}$$

as a parameter for determining a cyclic shift value may be configured by cyclicShift-n2, cyclicShift-n4, or cyclicShift-n8 in higher layer signaling of transmissionComb, and

$${n}_{S R S}^{cs , max}$$

may be determined based on Table 24 above.

$${\overline{N}}_{ap}^{{}_{SRS}}$$

and p̅ᵢ may be determined as below.
If nrofSRS-Ports-n8 that is higher layer signaling is configured as ports8tdm, it may be defined as

$${\overline{N}}_{ap}^{{}_{SRS}} = 4 ,$$

and in a case of p̅ᵢ, it may be defined as p̅ᵢ=1000+pᵢ mod 2 when pᵢ-1000<4, and it may be defined as p̅ᵢ=1000+pᵢ mod 2+2 when pᵢ-1000≥4. For example, when the UE performs transmission using a TDM scheme with respect to an SRS resource configured with 8 antenna ports, it may be defined as p̅ᵢ=1000, 1001, 1002, and 1003 respectively for pi=1000, 1001, 1004, and 1005 that are antenna ports to be transmitted on a first symbol, and it may be defined as pᵢ=1000, 1001, 1002, and 1003 respectively for pᵢ=1002, 1003, 1006, and 1007 that are antenna ports to be transmitted on a second symbol, so that, when a resource is allocated for different 4 antenna ports transmitted on each symbol, a resource allocation scheme for an SRS resource configured with 4 antenna ports may be changelessly applied.
Except for the case above, i.e., in a case in which nrofSRS-Ports-n8 that is higher layer signaling is not configured as ports8tdm, it may be defined as

$${\overline{N}}_{ap}^{{}_{SRS}} = {N}_{ap}^{{}_{SRS}}$$

and p̅ᵢ=pᵢ.

$${k}_{0}^{( {p}_{i} )}$$

that indicates a start position in a frequency domain of SRS corresponding to an ith antenna port may be defined as below.

$${k}_{0}^{( {p}_{i} )} = {\overline{k}}_{0}^{( {p}_{i} )} + {n}_{offset}^{FH} + {n}_{offset}^{RPFS}$$

Here,

$${\overline{k}}_{0}^{( {p}_{i} )}$$

may be defined as below.

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} )$$

Here,

$${k}_{TC}^{( {p}_{i} )}$$

may be defined as below.
When

$${\overline{N}}_{ap}^{SRS} = 8 , {\overline{p}}_{i} ∈ \{ 1003 , 1007 \} , and {n}_{SRS}^{cs , max} = 6 ,$$

it may be defined as

$${k}_{TC}^{( {p}_{i} )} = ( {\overline{k}}_{TC} + 3 {K}_{TC} / 4 ) mod {K}_{TC} .$$

When

$${\overline{N}}_{ap}^{SRS} = 8 , {\overline{p}}_{i} ∈ \{ 1002 , 1006 \} , and {n}_{SRS}^{cs , max} = 6 ,$$

it may be defined as

$${k}_{TC}^{( {p}_{i} )} = ( {\overline{k}}_{TC} + {K}_{TC} / 2 ) mod {K}_{TC} .$$

When

$${\overline{N}}_{ap}^{SRS} = 8 , {\overline{p}}_{i} ∈ \{ 1001 , 1005 \} , and {n}_{SRS}^{cs , max} = 6 ,$$

it may be defined as

$${k}_{TC}^{( {p}_{i} )} = ( {\overline{k}}_{TC} + {K}_{TC} / 4 ) mod {K}_{TC} .$$

When

$${\overline{N}}_{ap}^{SRS} = 8 , {\overline{p}}_{i} ∈ \{ 1001 , 1003 , 1005 , 1007 \} , and {n}_{SRS}^{cs , max} = 12 ,$$

it may be defined as

$${k}_{TC}^{( {p}_{i} )} = ( {\overline{k}}_{TC} + {K}_{TC} / 2 ) mod {K}_{TC} .$$

When

$${\overline{N}}_{ap}^{SRS} = 8 , {\overline{p}}_{i} ∈ \{ 1001 , 1003 , 1005 , 1007 \} , {n}_{SRS}^{cs , max} = 8 , and$$

$${n}_{SRS}^{cs} \geq {n}_{SRS}^{cs , max} / 2 , {k}_{TC}^{( {p}_{i} )} = ( {\overline{k}}_{TC} + {K}_{TC} / 2 ) mod {K}_{TC} Cambria Math$$

When

$${\overline{N}}_{ap}^{SRS} = 4 , {\overline{p}}_{i} ∈ \{ 1001 , 1003 \} , and {n}_{SRS}^{cs , max} = 6 ,$$

it may be defined as

$${k}_{TC}^{( {p}_{i} )} = ( {\overline{k}}_{TC} + {K}_{TC} / 2 ) mod {K}_{TC} .$$

when

$${\overline{N}}_{ap}^{SRS} = 4 , {\overline{p}}_{i} ∈ \{ 1001 , 1003 \} , {n}_{SRS}^{cs , max} ∈ \{ 8 , 12 \} , and {n}_{SRS}^{cs} \geq {n}_{SRS}^{cs , max} / 2 ,$$

it by be defined as

$${k}_{TC}^{( {p}_{i} )} = ( {\overline{k}}_{TC} + {K}_{TC} / 2 ) mod {K}_{TC} .$$

In a case except the above case, it may be defined as

$${k}_{TC}^{( {p}_{i} )} = {\overline{k}}_{TC} .$$

Here,

$${n}_{offset}^{FH}$$

may be defined as below.

$${n}_{offset}^{FH} = {\sum }_{b = 0}^{{B}_{SRS}} {m}_{SRS , b} {N}_{sc}^{RB} {n}_{b}$$

Here

$${n}_{offset}^{RPFS}$$

may be defined as below.

$${n}_{offset}^{RPFS} = {N}_{sc}^{RB} {m}_{SRS , {B}_{SRS}} ( ( {k}_{F} + {k}_{hop} ) mod {P}_{F} ) / {P}_{F}$$

k_{F} ∈ {0,1, . . . , P_{F}−1} may be configured by StartRBIndex that is higher layer signaling, and when not configured, it may be defined as k_{F}=0.

kₕₒₚ may be determined via Table 30 below based on k̅ₕₒₚ and N_{b}_{ₕₒₚ}values below for a case in which EnableStartRBHopping that is higher layer signaling is configured, and otherwise, it may be defined as kₕₒₚ=0.

$${\overline{k}}_{hop} = ⌊ \frac{{n}_{SRS}}{{\prod }_{{b}^{′} = {b}_{hop}}^{{B}_{SRS}} {N}_{b ′}} ⌋ mod {P}_{F} , {N}_{{b}_{hop}} = 1$$

If SRS transmission is performed based on SRS-PosResource,

$${k}_{offset}^{{l}^{′}}$$

above may be defined based on Table 31 below, and otherwise (if SRS transmission is performed based on SRS-Resource), it may be defined as

$${k}_{offset}^{{l}^{′}} = 0.$$

n_{shift} is an offset value that determines a location from which SRS is to be transmitted relative to a reference location on the frequency domain, and may be configured by freqDomainShift that is higher layer signaling. k̅_{TC} ∈ {0,1, . . . ,K_{TC}−1}indicating Comb offset value may be configured by combOffset-n2, combOffset-n4, or combOffset-n8 in transmissionComb that is higher layer signaling.

As higher layer signaling related to frequency hopping of SRS, b-hop in freqHoping may be configured, and may be defined as bₕₒₚ ∈ {0,1,2,3}.

n_{b} is a value indicating an index of a frequency position, and may be defined as below.
If bₕₒₚ>B_{SRS}, frequency hopping of SRS is not supported, and n_{b}indicating an index of a frequency position may have a constant value during all

$${N}_{symb}^{SRS}$$

symbol that had may have a have good.

$${n}_{b} = ⌊ 4 {n}_{RRC} / {m}_{SRS , b} ⌋ mod {N}_{b}$$

Here, n_{RRC} is a value configured by freqDomainPosition that is higher layer signaling, and if not configured, its value may be 0.
If bₕₒₚ<B_{SRS}, frequency hopping of SRS is supported, and n_{b} may be defined as below.

If b<bₕₒₚ, it may be defined as n_{b}=[4n_{RRC}/m_{SRS,b}] mod N_{b}. Otherwise, it may be defined as n_{b}=F_{b}(n_{SRS})+[4n_{RRC}/m_{SRS,b}] mod N_{b}. Here, if N_{b}is an even number, F_{b}(n_{SRS}) may be defined as

$${F}_{b} ( {n}_{SRS} ) = ( \frac{{N}_{b}}{2} ) ⌊ \frac{{n}_{SRS} mod {\prod }_{{b}^{′} = {b}_{hop}}^{b} {N}_{b ′}}{{\prod }_{{b}^{′} = {b}_{hop}}^{b - 1} {N}_{b ′}} ⌋ + ⌊ \frac{{n}_{SRS} mod {\prod }_{{b}^{′} = {b}_{hop}}^{b} {N}_{b ′}}{2 {\prod }_{{b}^{′} = {b}_{hop}}^{b - 1} {N}_{b ′}} ⌋ ,$$

and if N_{b} is an odd number, it may be defined as

$${F}_{b} ( {n}_{SRS} ) = ⌊ \frac{{N}_{b}}{2} ⌋ ⌊ \frac{{n}_{SRS}}{{\prod }_{{b}^{′} = {b}_{hop}}^{b - 1} {N}_{b ′}} ⌋ \cdot {N}_{{b}_{hop}}$$

n_{SRS} may be defined as a parameter for counting the number of SRS transmissions. If the UE transmits aperiodic SRS resource, it may be defined as n_{SRS}=[l′/(sR)]in

$${N}_{symb}^{SRS}$$

symbols in a particular slot. Here, s may be defined as s=2 when nrofSRS-Ports-n8 that is higher layer signaling is configured as ports8tdm, and otherwise, it may be defined as s=1. Here,

$$R \leq {N}_{symb}^{SRS} / 2$$

may be a value configured by repetitionFactor that is higher layer signaling, and if not configured, it may be defined as

$$R = {N}_{symb}^{SRS} .$$

If the UE transmits periodic or semi-persistent SRS resource, n_{SRS} may be defined as below in slots that satisfy

$$( {N}_{slot}^{frame , μ} {n}_{f} + {n}_{s , f}^{μ} - {T}_{offset} ) mod {T}_{SRS} = 0 .$$

$${n}_{SRS} = ( \frac{{N}_{slot}^{frame , μ} {n}_{f} + {n}_{s , f}^{μ} - {T}_{offset}}{{T}_{SRS}} ) ( \frac{{N}_{symb}^{SRS}}{sR} ) + ⌊ \frac{l ′}{sR} ⌋$$

Here, T_{SRS} and T_{offset} may respectively indicate a period of periodic or semi-persistent SRS and a slot offset.

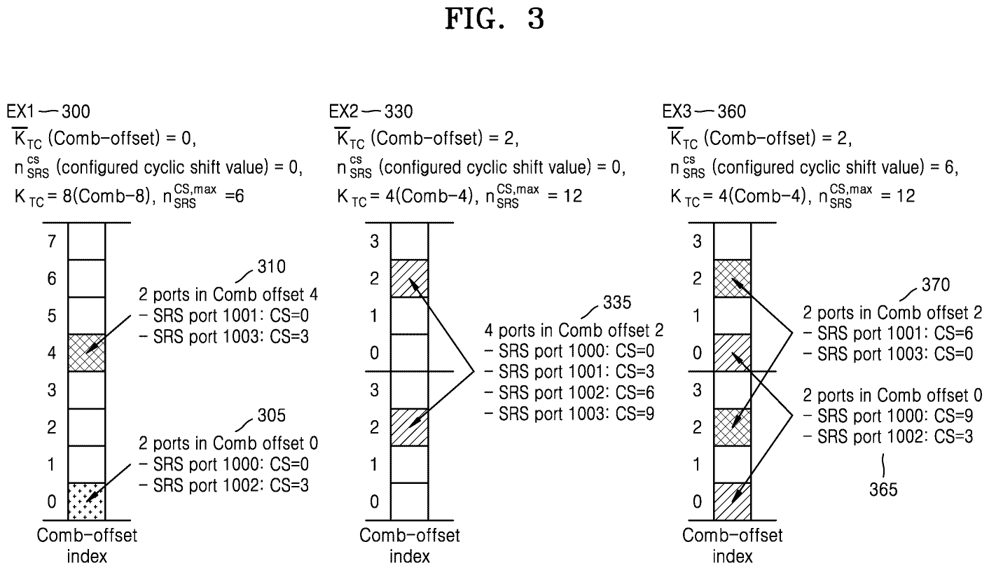

FIG. 3 is a diagram illustrating a method of allocating comb offset and a cyclic shift in SRS transmission, according to an embodiment of the disclosure.

Referring to FIG. 3, in the first example 300, a situation may be assumed, in which the UE is configured with k̅_{TC}=0 (comb offset value),

$${n}_{SRS}^{cs} = 0 ( cyclic shift value ) ,$$

K_{TC}=8 (comb size value) and

$${n}_{SRS}^{cs , ma x} = 6 ( maximum cyclic shift value )$$

for an SRS resource configured with 4 antenna ports.

In this case, the UE may define

$${n}_{SRS}^{cs , 0} = 0 and {n}_{SRS}^{cs , 2} = 3$$

as cyclic shift values respectively allocated to p_{L}=1000 and 1002, and may define

$${k}_{TC}^{( {p}_{i} )} = 0$$

as a comb offset value for all of p̅ᵢ=1000 and 1002 (305). In addition, the UE may define

$${n}_{SRS}^{cs , 1} = 0 and {n}_{SRS}^{cs , 3} = 3$$

as cyclic shift values respectively allocated to p̅ᵢ=1001 and 1003, and may define

$${k}_{TC}^{( {p}_{i} )} = 4$$

as a comb offset value for all of p̅ᵢ=1001 and 1003 (310). Therefore, two antenna ports among the four antenna ports are allocated to the same comb offset each, and in order to separate two antenna ports in the same comb offset, a gap between cyclic shifts corresponding to the two antenna ports may be determined to be

$$\frac{{n}_{SRS}^{cs , m ax}}{2} = 3 ,$$

so that the gap may be maximum.

In the second example 330, a situation may be assumed, in which the UE is configured with k̅_{TC}=2 (comb offset value),

$${n}_{SRS}^{cs} = 0 ( cyclic shift value ) ,$$

K_{TC}=4 (comb size value) and

$${n}_{SRS}^{cs , ma x} = 12 ( maximum cyclic shift value )$$

for an SRS resource configured with 4 antenna ports.

In this case, the UE may define

$${n}_{SRS}^{cs , 0} = 0 , {n}_{SRS}^{cs , 1} = 3 , {n}_{SRS}^{cs , 2} = 6 ,$$

and

$${n}_{SRS}^{cs , 3} = 9$$

as cyclic shift values respectively allocated to p̅ᵢ=1000, 1001, 1002, and 1003, and may define

$${k}_{TC}^{( {p}_{i} )} = 2$$

as a comb offset value for all of p̅ᵢ=1000, 1001, 1002,
and 1003 (335). Therefore, all four antenna ports are allocated to the same comb offset, and in order to separate four antenna ports in the same comb offset, a gap between cyclic shifts corresponding to the four antenna ports may be determined to be

$$\frac{{n}_{SRS}^{cs , max}}{4} = 3 ,$$

so that the gap may be maximum.

In the third example 360, a situation may be assumed, in which the UE is configured with k̅_{TC}=2 (comb offset value),

$${n}_{SRS}^{cs} = 6 ( cyclic shift value ) ,$$

K_{TC}=4 (comb size value) and

$${n}_{SRS}^{cs , max} = 12 ( maximum cyclic shift value )$$

for an SRS resource configured with 4 antenna ports.

In this case, the UE may define

$${n}_{SRS}^{cs , 0} = 9 and {n}_{SRS}^{cs , 2} = 3$$

as cyclic shift values respectively allocated to p̅ᵢ=1000 and 1002, and may define

$${k}_{TC}^{( {p}_{i} )} = 0$$

as a comb offset value for all of p̅ᵢ=1000 and 1002 (365). In addition, the UE may define

$${n}_{SRS}^{cs , 1} = 6 and {n}_{SRS}^{cs , 3} = 0$$

as cyclic shift values respectively allocated to p̅ᵢ=1001 and 1003, and may define

$${k}_{TC}^{( {p}_{i} )} = 2$$

as a comb offset value for all of pᵢ=1001 and 1003 (370). Therefore, two antenna ports among the four antenna ports are allocated to the same comb offset each, and in order to separate two antenna ports in the same comb offset, a gap between cyclic shifts corresponding to the two antenna ports may be determined to be

$$\frac{{n}_{SRS}^{cs , max}}{2} = 6 ,$$

so that the gap may be maximum.

TABLE 25

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | M_{SRS, 1} | N₁ | m_{SRS, 2} | N₂ | M_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

TABLE 26

| | |
|---|---|
| u | φ(0), . . . , φ(5) |

| | | | | | | |
|---|---|---|---|---|---|---|
| 0 | −3 | −1 | 3 | 3 | −1 | −3 |
| 1 | −3 | 3 | −1 | −1 | 3 | −3 |
| 2 | −3 | −3 | −3 | 3 | 1 | −3 |
| 3 | 1 | 1 | 1 | 3 | −1 | −3 |
| 4 | 1 | 1 | 1 | −3 | −1 | 3 |
| 5 | −3 | 1 | −1 | −3 | −3 | −3 |
| 6 | −3 | 1 | 3 | −3 | −3 | −3 |
| 7 | −3 | −1 | 1 | −3 | 1 | −1 |
| 8 | −3 | −1 | −3 | 1 | −3 | −3 |
| 9 | −3 | −3 | 1 | −3 | 3 | −3 |
| 10 | −3 | 1 | 3 | 1 | −3 | −3 |
| 11 | −3 | −1 | −3 | 1 | 1 | −3 |
| 12 | 1 | 1 | 3 | −1 | −3 | 3 |
| 13 | 1 | 1 | 3 | 3 | −1 | 3 |
| 14 | 1 | 1 | 1 | −3 | 3 | −1 |
| 15 | 1 | 1 | 1 | −1 | 3 | −3 |
| 16 | −3 | −1 | −1 | −1 | 3 | −1 |
| 17 | −3 | −3 | −1 | 1 | −1 | −3 |
| 18 | −3 | −3 | −3 | 1 | −3 | −1 |
| 19 | −3 | 1 | 1 | −3 | −1 | −3 |
| 20 | −3 | 3 | −3 | 1 | 1 | −3 |
| 21 | −3 | 1 | −3 | −3 | −3 | −1 |
| 22 | 1 | 1 | −3 | 3 | 1 | 3 |
| 23 | 1 | 1 | −3 | −3 | 1 | −3 |
| 24 | 1 | 1 | 3 | −1 | 3 | 3 |
| 25 | 1 | 1 | −3 | 1 | 3 | 3 |
| 26 | 1 | 1 | −1 | −1 | 3 | −1 |
| 27 | 1 | 1 | −1 | 3 | −1 | −1 |
| 28 | 1 | 1 | −1 | 3 | −3 | −1 |
| 29 | 1 | 1 | −3 | 1 | −1 | −1 |

TABLE 27

| u | φ(0), . . . , φ(11) | | | | | | | | | | | |
|---|---|---|---|---|---|---|---|---|---|---|---|---|
| 0 | −3 | 1 | −3 | −3 | −3 | 3 | −3 | −1 | 1 | 1 | 1 | −3 |
| 1 | −3 | 3 | 1 | −3 | 1 | 3 | −1 | −1 | 1 | 3 | 3 | 3 |
| 2 | −3 | 3 | 3 | 1 | −3 | 3 | −1 | 1 | 3 | −3 | 3 | −3 |
| 3 | −3 | −3 | −1 | 3 | 3 | 3 | −3 | 3 | −3 | 1 | −1 | −3 |
| 4 | −3 | −1 | −1 | 1 | 3 | 1 | 1 | −1 | 1 | −1 | −3 | 1 |
| 5 | −3 | −3 | 3 | 1 | −3 | −3 | −3 | −1 | 3 | −1 | 1 | 3 |
| 6 | 1 | −1 | 3 | −1 | −1 | −1 | −3 | −1 | 1 | 1 | 1 | −3 |
| 7 | −1 | −3 | 3 | −1 | −3 | −3 | −3 | −1 | 1 | −1 | 1 | −3 |
| 8 | −3 | −1 | 3 | 1 | −3 | −1 | −3 | 3 | 1 | 3 | 3 | 1 |
| 9 | −3 | −1 | −1 | −3 | −3 | −1 | −3 | 3 | 1 | 3 | −1 | −3 |
| 10 | −3 | 3 | −3 | 3 | 3 | −3 | −1 | −1 | 3 | 3 | 1 | −3 |
| 11 | −3 | −1 | −3 | −1 | −1 | −3 | 3 | 3 | −1 | −1 | 1 | −3 |
| 12 | −3 | −1 | 3 | −3 | −3 | −1 | −3 | 1 | −1 | −3 | 3 | 3 |
| 13 | −3 | 1 | −1 | −1 | 3 | 3 | −3 | −1 | −1 | −3 | −1 | −3 |
| 14 | 1 | 3 | −3 | 1 | 3 | 3 | 3 | 1 | −1 | 1 | −1 | 3 |
| 15 | −3 | 1 | 3 | −1 | −1 | −3 | −3 | −1 | −1 | 3 | 1 | −3 |
| 16 | −1 | −1 | −1 | −1 | 1 | −3 | −1 | 3 | 3 | −1 | −3 | 1 |
| 17 | −1 | 1 | 1 | −1 | 1 | 3 | 3 | −1 | −1 | −3 | 1 | −3 |
| 18 | −3 | 1 | 3 | 3 | −1 | −1 | −3 | 3 | 3 | −3 | 3 | −3 |
| 19 | −3 | −3 | 3 | −3 | −1 | 3 | 3 | 3 | −1 | −3 | 1 | −3 |
| 20 | 3 | 1 | 3 | 1 | 3 | −3 | −1 | 1 | 3 | 1 | −1 | −3 |
| 21 | −3 | 3 | 1 | 3 | −3 | 1 | 1 | 1 | 1 | 3 | −3 | 3 |
| 22 | −3 | 3 | 3 | 3 | −1 | −3 | −3 | −1 | −3 | 1 | 3 | −3 |
| 23 | 3 | −1 | −3 | 3 | −3 | −1 | 3 | 3 | 3 | −3 | −1 | −3 |
| 24 | −3 | −1 | 1 | −3 | 1 | 3 | 3 | 3 | −1 | −3 | 3 | 3 |
| 25 | −3 | 3 | 1 | −1 | 3 | 3 | −3 | 1 | −1 | 1 | −1 | 1 |
| 26 | −1 | 1 | 3 | −3 | 1 | −1 | 1 | −1 | −1 | −3 | 1 | −1 |
| 27 | −3 | −3 | 3 | 3 | 3 | −3 | −1 | 1 | −3 | 3 | 1 | −3 |
| 28 | 1 | −1 | 3 | 1 | 1 | −1 | −1 | −1 | 1 | 3 | −3 | 1 |
| 29 | −3 | 3 | −3 | 3 | −3 | −3 | 3 | −1 | −1 | 1 | 3 | −3 |

TABLE 28

| u | φ(0), . . . , φ(17) | | | | | | | | | | | | | | | | | |
|---|---|---|---|---|---|---|---|---|---|---|---|---|---|---|---|---|---|---|
| 0 | −1 | 3 | −1 | −3 | 3 | 1 | −3 | −1 | 3 | −3 | −1 | −1 | 1 | 1 | 1 | −1 | −1 | −1 |
| 1 | 3 | −3 | 3 | −1 | 1 | 3 | −3 | −1 | −3 | −3 | −1 | −3 | 3 | 1 | −1 | 3 | −3 | 3 |
| 2 | −3 | 3 | 1 | −1 | −1 | 3 | −3 | −1 | 1 | 1 | 1 | 1 | 1 | −1 | 3 | −1 | −3 | −1 |
| 3 | −3 | −3 | 3 | 3 | 3 | 1 | −3 | 1 | 3 | 3 | 1 | −3 | −3 | 3 | −1 | −3 | −1 | 1 |
| 4 | 1 | 1 | −1 | −1 | −3 | −1 | 1 | −3 | −3 | −3 | 1 | −3 | −1 | −1 | 1 | −1 | 3 | 1 |
| 5 | 3 | −3 | 1 | 1 | 3 | −1 | 1 | −1 | −1 | −3 | 1 | 1 | −1 | 3 | 3 | −3 | 3 | −1 |
| 6 | −3 | 3 | −1 | 1 | 3 | 1 | −3 | −1 | 1 | 1 | −3 | 1 | 3 | 3 | −1 | −3 | −3 | −3 |
| 7 | 1 | 1 | −3 | 3 | 3 | 1 | 3 | −3 | 3 | −1 | 1 | 1 | −1 | 1 | −3 | −3 | −1 | 3 |
| 8 | −3 | 1 | −3 | −3 | 1 | −3 | −3 | 3 | 1 | −3 | −1 | −3 | −3 | −3 | −1 | 1 | 1 | 3 |
| 9 | 3 | −1 | 3 | 1 | −3 | −3 | −1 | 1 | −3 | −3 | 3 | 3 | 3 | 1 | 3 | −3 | 3 | −3 |
| 10 | −3 | −3 | −3 | 1 | −3 | 3 | 1 | 1 | 3 | −3 | −3 | 1 | 3 | −1 | 3 | −3 | −3 | 3 |
| 11 | −3 | −3 | 3 | 3 | 3 | −1 | −1 | −3 | −1 | −1 | −1 | 3 | 1 | −3 | −3 | −1 | 3 | −1 |
| 12 | −3 | −1 | −3 | −3 | 1 | 1 | −1 | −3 | −1 | −3 | −1 | −1 | 3 | 3 | −1 | 3 | 1 | 3 |
| 13 | 1 | 1 | −3 | −3 | −3 | −3 | 1 | 3 | −3 | 3 | 3 | 1 | −3 | −1 | 3 | −1 | −3 | 1 |
| 14 | −3 | 3 | −1 | −3 | −1 | −3 | 1 | 1 | −3 | −3 | −1 | −1 | 3 | −3 | 1 | 3 | 1 | 1 |
| 15 | 3 | 1 | −3 | 1 | −3 | 3 | 3 | −1 | −3 | −3 | −1 | −3 | −3 | 3 | −3 | −1 | 1 | 3 |
| 16 | −3 | −1 | −3 | −1 | −3 | 1 | 3 | −3 | −1 | 3 | 3 | 3 | 1 | −1 | −3 | 3 | −1 | −3 |
| 17 | −3 | −1 | 3 | 3 | −1 | 3 | −1 | −3 | −1 | 1 | −1 | −3 | −1 | −1 | −1 | 3 | 3 | 1 |
| 18 | −3 | 1 | −3 | −1 | −1 | 3 | 1 | −3 | −3 | −3 | −1 | −3 | −3 | 1 | 1 | 1 | −1 | −1 |
| 19 | 3 | 3 | 3 | −3 | −1 | −3 | −1 | 3 | −1 | 1 | −1 | −3 | 1 | −3 | −3 | −1 | 3 | 3 |
| 20 | −3 | 1 | 1 | −3 | 1 | 1 | 3 | −3 | −1 | −3 | −1 | 3 | −3 | 3 | −1 | −1 | −1 | −3 |
| 21 | 1 | −3 | −1 | −3 | 3 | 3 | −1 | −3 | 1 | −3 | −3 | −1 | −3 | −1 | 1 | 3 | 3 | 3 |
| 22 | −3 | −3 | 1 | −1 | −1 | 1 | 1 | −3 | −1 | 3 | 3 | 3 | 3 | −1 | 3 | 1 | 3 | 1 |
| 23 | 3 | −1 | −3 | 1 | −3 | −3 | −3 | 3 | 3 | −1 | 1 | −3 | −1 | 3 | 1 | 1 | 3 | 3 |
| 24 | 3 | −1 | −1 | 1 | −3 | −1 | −3 | −1 | −3 | −3 | −1 | −3 | 1 | 1 | 1 | −3 | −3 | 3 |
| 25 | −3 | −3 | 1 | −3 | 3 | 3 | 3 | −1 | 3 | 1 | 1 | −3 | −3 | −3 | 3 | −3 | −1 | −1 |
| 26 | −3 | −1 | −1 | −3 | 1 | −3 | 3 | −1 | −1 | −3 | 3 | 3 | −3 | −1 | 3 | −1 | −1 | −1 |
| 27 | −3 | −3 | 3 | 3 | −3 | 1 | 3 | −1 | −3 | 1 | −1 | −3 | 3 | −3 | −1 | −1 | −1 | 3 |
| 28 | −1 | −3 | 1 | −3 | −3 | −3 | 1 | 1 | 3 | 3 | −3 | 3 | 3 | −3 | −1 | 3 | −3 | 1 |
| 29 | −3 | 3 | 1 | −1 | −1 | −1 | −1 | 1 | −1 | 3 | 3 | −3 | −1 | 1 | 3 | −1 | 3 | −1 |

TABLE 29

| u | φ(0), . . . , φ(23) | | | | | | | | | | | | | | | | | | | | | | | |
|---|---|---|---|---|---|---|---|---|---|---|---|---|---|---|---|---|---|---|---|---|---|---|---|---|
| 0 | −1 | −3 | 3 | −1 | 3 | 1 | 3 | −1 | 1 | −3 | −1 | −3 | −1 | 1 | 3 | −3 | −1 | −3 | 3 | 3 | 3 | −3 | −3 | −3 |
| 1 | −1 | −3 | 3 | 1 | 1 | −3 | 1 | −3 | −3 | 1 | −3 | −1 | −1 | 3 | −3 | 3 | 3 | 3 | −3 | 1 | 3 | 3 | −3 | −3 |
| 2 | −1 | −3 | −3 | 1 | −1 | −1 | −3 | 1 | 3 | −1 | −3 | −1 | −1 | −3 | 1 | 1 | 3 | 1 | −3 | −1 | −1 | 3 | −3 | −3 |
| 3 | 1 | −3 | 3 | −1 | −3 | −1 | 3 | 3 | 1 | −1 | 1 | 1 | 3 | −3 | −1 | −3 | −3 | −3 | −1 | 3 | −3 | −1 | −3 | −3 |
| 4 | −1 | 3 | −3 | −3 | −1 | 3 | −1 | −1 | 1 | 3 | 1 | 3 | −1 | −1 | −3 | 1 | 3 | 1 | −1 | −3 | 1 | −1 | −3 | −3 |
| 5 | −3 | −1 | 1 | −3 | −3 | 1 | 1 | −3 | 3 | −1 | −1 | −3 | 1 | 3 | 1 | −1 | −3 | −1 | −3 | 1 | −3 | −3 | −3 | −3 |
| 6 | −3 | 3 | 1 | 3 | −1 | 1 | −3 | 1 | −3 | 1 | −1 | −3 | −1 | −3 | −3 | −3 | −3 | −1 | −1 | −1 | 1 | 1 | −3 | −3 |
| 7 | −3 | 1 | 3 | −1 | 1 | −1 | 3 | −3 | 3 | −1 | −3 | −1 | −3 | 3 | −1 | −1 | −1 | −3 | −1 | −1 | −3 | 3 | 3 | −3 |
| 8 | −3 | 1 | −3 | 3 | −1 | −1 | −1 | −3 | 3 | 1 | −1 | −3 | −1 | 1 | 3 | −1 | 1 | −1 | 1 | −3 | −3 | −3 | −3 | −3 |
| 9 | 1 | 1 | −1 | −3 | −1 | 1 | 1 | −3 | 1 | −1 | 1 | −3 | 3 | −3 | −3 | 3 | −1 | −3 | 1 | 3 | −3 | 1 | −3 | −3 |
| 10 | −3 | −3 | −3 | −1 | 3 | −3 | 3 | 1 | 3 | 1 | −3 | −1 | −1 | −3 | 1 | 1 | 3 | 1 | −1 | −3 | 3 | 1 | 3 | −3 |
| 11 | −3 | 3 | −1 | 3 | 1 | −1 | −1 | −1 | 3 | 3 | 1 | 1 | 1 | 3 | 3 | 1 | −3 | −3 | −1 | 1 | −3 | 1 | 3 | −3 |
| 12 | 3 | −3 | 3 | −1 | −3 | 1 | 3 | 1 | −1 | −1 | −3 | −1 | 3 | −3 | 3 | −1 | −1 | 3 | 3 | −3 | −3 | 3 | −3 | −3 |
| 13 | −3 | 3 | −1 | 3 | −1 | 3 | 3 | 1 | 1 | −3 | 1 | 3 | −3 | 3 | −3 | −3 | −1 | 1 | 3 | −3 | −1 | −1 | −3 | −3 |
| 14 | −3 | 1 | −3 | −1 | −1 | 3 | 1 | 3 | −3 | 1 | −1 | 3 | 3 | −1 | −3 | 3 | −3 | −1 | −1 | −3 | −3 | −3 | 3 | −3 |
| 15 | −3 | −1 | −1 | −3 | 1 | −3 | −3 | −1 | −1 | 3 | −1 | 1 | −1 | 3 | 1 | −3 | −1 | 3 | 1 | 1 | −1 | −1 | −3 | −3 |
| 16 | −3 | −3 | 1 | −1 | 3 | 3 | −3 | −1 | 1 | −1 | −1 | 1 | 1 | −1 | −1 | 3 | −3 | 1 | −3 | 1 | −1 | −1 | −1 | −3 |
| 17 | 3 | −1 | 3 | −1 | 1 | −3 | 1 | 1 | −3 | −3 | 3 | −3 | −1 | −1 | −1 | −1 | −1 | −3 | −3 | −1 | 1 | 1 | −3 | −3 |
| 18 | −3 | 1 | −3 | 1 | −3 | −3 | 1 | −3 | 1 | −3 | −3 | −3 | −3 | −3 | 1 | −3 | −3 | 1 | 1 | −3 | 1 | 1 | −3 | −3 |
| 19 | −3 | −3 | 3 | 3 | 1 | −1 | −1 | −1 | 1 | −3 | −1 | 1 | −1 | 3 | −3 | −1 | −3 | −1 | −1 | 1 | −3 | 3 | −1 | −3 |
| 20 | −3 | −3 | −1 | −1 | −1 | −3 | 1 | −1 | −3 | −1 | 3 | −3 | 1 | −3 | 3 | −3 | 3 | 3 | 1 | −1 | −1 | 1 | −3 | −3 |
| 21 | 3 | −1 | 1 | −1 | 3 | −3 | 1 | 1 | 3 | −1 | −3 | 3 | 1 | −3 | 3 | −1 | −1 | −1 | −1 | 1 | −3 | −3 | −3 | −3 |
| 22 | −3 | 1 | −3 | 3 | −3 | 1 | −3 | 3 | 1 | −1 | −3 | −1 | −3 | −3 | −3 | −3 | 1 | 3 | −1 | 1 | 3 | 3 | 3 | −3 |
| 23 | −3 | −1 | 1 | −3 | −1 | −1 | 1 | 1 | 1 | 3 | 3 | −1 | 1 | −1 | 1 | −1 | −1 | −3 | −3 | −3 | 3 | 1 | −1 | −3 |
| 24 | −3 | 3 | −1 | −3 | −1 | −1 | −1 | 3 | −1 | −1 | 3 | −3 | −1 | 3 | −3 | 3 | −3 | −1 | 3 | 1 | 1 | −1 | −3 | −3 |
| 25 | −3 | 1 | −1 | −3 | −3 | −1 | 1 | −3 | −1 | −3 | 1 | 1 | −1 | 1 | 1 | 3 | 3 | 3 | −1 | 1 | −1 | 1 | −1 | −3 |
| 26 | −1 | 3 | −1 | −1 | 3 | 3 | −1 | −1 | −1 | 3 | −1 | −3 | 1 | 3 | 1 | 1 | −3 | −3 | −3 | −1 | −3 | −1 | −3 | −3 |
| 27 | 3 | −3 | −3 | −1 | 3 | 3 | −3 | −1 | 3 | 1 | 1 | 1 | 3 | −1 | 3 | −3 | −1 | 3 | −1 | 3 | 1 | −1 | −3 | −3 |
| 28 | −3 | 1 | −3 | 1 | −3 | 1 | 1 | 3 | 1 | −3 | −3 | −1 | 1 | 3 | −1 | −3 | 3 | 1 | −1 | −3 | −3 | −3 | −3 | −3 |
| 29 | 3 | −3 | −1 | 1 | 3 | −1 | −1 | −3 | −1 | 3 | −1 | −3 | −1 | −3 | 3 | −1 | 3 | 1 | 1 | −3 | 3 | −3 | −3 | −3 |

TABLE 30

| | kₕₒₚ | | |
|---|---|---|---|
| k̅ₕₒₚ | P_{F} = 1 | P_{F} = 2 | P_{F} = 4 |
| 0 | 0 | 0 | 0 |
| 1 | | 1 | 2 |
| 2 | | | 1 |
| 3 | | | 3 |

TABLE 31

| | ${k}_{offset}^{0} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | | |
| 4 | | 0, 2 | 0, 2, 1, 3 | 0, 2, 1, 3, 0, 2, 1, 3 | 0, 2, 1, 3, 0, 2, 1, 3, 0, 2, 1, 3 |
| 8 | | | 0, 4, 2, 6 | 0, 4, 2, 6, 1, 5, 3, 7 | 0, 4, 2, 6, 1, 5, 3, 7, 0, 4, 2, 6 |

Related to UE capability report

In LTE and NR, the UE may perform a procedure for reporting a capability supported by the UE to a serving BS while the UE is connected to the serving BS. In descriptions below, this procedure is referred to as a UE capability report.

The BS may transmit, to the UE in a connected state, a UE capability enquiry message requesting to report a UE capability report. The message may include a UE capability request for each radio access technology (RAT) type of the BS. The request for each RAT type may include supported frequency band combination information, or the like. In addition, for the UE capability enquiry message, UE capability for each of the plurality of RAT types may be requested by an RRC message container transmitted by the BS, or the BS may transmit the UE capability enquiry message including a UE capability request for each RAT type which is repeated multiple times. For example, the UE capability enquiry is repeated multiple times in one message, and the UE may configure a corresponding UE capability information message corresponding thereto and may report it multiple times. In the next generation mobile communication system, a UE capability request for multi-RAT dual connectivity (MR-DC) as well as NR, LTE, E-UTRA-NR dual connectivity (EN-DC) may be performed. In addition, it is common that the UE capability enquiry message is transmitted in an initial stage after the UE is connected to the BS, but the UE capability enquiry message may be requested in any condition when the BS needs.

When the UE receives a request to report the UE capability from the BS, the UE configures a UE capability according to an RAT type and band information requested from the BS. A method by which the UE configures a UE capability in the N R system is summarized below.
1. If the UE receives an LTE and/or NR band list in the request for UE capability from the BS, the UE may configure a band combination (BC) for EN-DC and NR stand-alone (SA). For example, a candidate BC list for the E N-DC and NR SA based on the frequency bands requested from the BS in FreqBandList is compiled. Priorities of the bands may be set in the order of being listed in FreqBandList.
2. When the BS requests a UE capability report by setting a flag “eutra-nr-only” or “eutra”, the UE completely removes what are related to NR SA BCs from the configured candidate BC list. This operation may occur only when an LTE BS (eNB) requests a “eutra” capability.
3. Afterward, the UE removes fallback BCs from the configured candidate BC list. Here, the fallback BC refers to a BC that is obtainable by removing a band corresponding to at least one SCell from a random BC, and may be omitted because the BC before the band corresponding to the at least one SCell being removed may already cover the fallback BC. This operation is also applied in M R-DC, i.e., even to LTE bands. BCs that remain after this operation are a final “candidate BC list”.
4. The UE selects BCs to be reported, by selecting BCs being appropriate for a requested RAT type from the final “candidate BC list”. In this operation, the UE configures supportedBandCombinationList in a defined order. For example, the UE may configure BCs and UE capability to be reported, in order of preset RAT-types. (nr->eutra-nr->eutra). Furthermore, the UE may configure featureSetCombination for the configured supportedBandCombinationList, and configure a “candidate feature set combination” list from the candidate BC list from which a list of the fallback BCs (including equal or low-level capability) is removed. The “candidate feature set combinations” include all feature set combinations for NR and EUTRA-N R BCs, and may be obtained from feature set combinations of UE-NR-Capabilities and UE-M RDC-Capabilities containers.
5. In addition, if the requested RAT type is eutra-nr and has an impact on the list, featureSetCombinations are all included in both two containers that are the UE-M RDC-Capabilities and UE-NR-Capabilities. However, the feature set of the N R includes only UE-NR-Capabilities.
After the UE capability is configured, the UE transmits, to the BS, a UE capability information message including the UE capability. The BS performs scheduling and transmission/reception management appropriate for the UE, based on the UE capability received from the UE.
   Unified TCI state

A single TCI sate indication and activation method based on a unified TCI scheme will now be described. The unified TCI scheme may refer to a scheme to manage transmission and reception beam management schemes distinguished into a TCI state scheme used in DL reception of the UE and a spatial relation info scheme used in UL transmission in the existing Rel-15 and 16 by integrating them into the TCI state. Therefore, when the UE receives an indication from the BS, based on the unified TCI scheme, the UE may perform beam management by using the TCI state even for the UL transmission. In a case that the UE is configured by the BS with a TCI-State, which is higher layer signaling having higher layer signaling tci-stateID-r17, the UE may perform an operation based on the unified TCI scheme by using the TCI-State. The TCI-State may exist in two types: joint TCI state or separate TCI state.

The first type is the joint TCI state, in which case the UE may receive an indication of all the TCI states to be applied to UL transmission and DL reception through the one TCI-State from the BS. If the UE receives an indication of joint TCI state based TCI-State, the UE may receive an indication of a parameter to be used in DL channel estimation using a reference signal (RS) corresponding to qcl-Type1 in the joint TCI state based TCI-state, and a parameter to be used as a DL reception beam or reception filter using an RS corresponding to qcl-Type2. If the UE receives an indication of joint TCI state based TCI-State, the UE may receive an indication of a parameter to be used as a UL transmission beam or transmission filter using an RS corresponding to qcl-Type2 in the joint DL/UL TCI state based TCI-State. In this case, if the UE receives an indication of the joint TCI state, the UE may apply the same beam both to UL transmission and DL reception.

The second type is the separate TCI state, in which case the UE may separately receive, from the BS, indications of UL TCI state to be applied in UL transmission and a DL TCI state to be applied in DL reception. If the UE receives an indication of the UL TCI state, the UE may receive an indication of a parameter to be used as a UL transmission beam or transmission filter using a reference RS or source RS set in the UL TCI state. If the UE receives an indication of the DL TCI state, the UE may receive an indication of a parameter to be used in DL channel estimation using an RS corresponding to qcl-Type1 set in the DL TCI state, and a parameter to be used as a DL reception beam or reception filter using an RS corresponding to qcl-Type2.

If the UE receives an indication of both the DL TCI state and the UL TCI state, the UE may receive an indication of a parameter to be used as a UL transmission beam or transmission filter using a reference RS or source RS set in the UL TCI state, and receive an indication of a parameter to be used in DL channel estimation using an R S corresponding to qcl-Type1 set in the DL TCI state and a parameter to be used as a DL reception beam or reception filter using an RS corresponding to qcl-Type2. Here, if reference RSs or source RSs set in the DL TCI state and UL TCI state indicated to the UE are different, the UE may apply beams for UL transmission and DL reception separately based on the indicated UL TCI state and DL TCI state.

The UE may be configured with up to 128 joint TCI states for each particular BWP in a particular cell in higher layer signaling from the BS, and configured with up to 64 or 128 DL TCI states of the separate TCI states for each particular BWP in the particular cell based on a UE capability report in higher layer signaling, and the joint TCI state and the DL TCI state of the separate TCI state may employ the same higher layer signaling structure. For example, when 128 joint TCI states are configured and 64DL TCI states of the separate TCI state are configured, the 64 DL TCI states may be included in the 128 joint TCI states.

Up to 32 or 64 UL TCI states of the separate TCI states may be configured for each particular BWP in the particular cell by higher layer signaling based on the UE capability report, and as the relationship between the joint TCI state and the DL TCI state of the separate TCI states, the joint TCI state and the UL TCI state of the separate TCI may also employ the same higher layer signaling structure, or the UL TCI state of the separate TCI may use a different higher layer signaling structure from those of the joint TCI state and the DL TCI state of the separate TCI state.

In this manner, the use of different or the same higher layer signaling structure may be defined in a standard, or may be distinguished by another higher layer signaling configured by the BS based on a UE capability report that contains information about which one of the two may be supported by the UE.

The UE may use one of the joint TCI state and the separate TCI state configured by the BS so as to receive an indication related to transmission and reception beams in a unified TCI scheme. The UE may be configured by the BS with whether to use one of the joint TCI state and the separate TCI state, by higher layer signaling.

The UE may use one of the joint TCI state and the separate TCI state selected by higher layer signaling to receive the indication related to transmission and reception beams, in which case the indication of transmission and reception beams from the BS may have two methods: an MAC-CE based indication method and an MAC-CE based activation and DCI based indication method.

If the UE uses the joint TCI state scheme by higher layer signaling to receive the indication related to transmission and reception beams, the UE may receive an MAC-CE that indicates the joint TCI state from the BS and may perform transmission and reception beam application operations, and the BS may schedule reception of a PDSCH including the MAC-CE for the UE in a PDCCH. If there is one joint TCI state included in the MAC-CE, the UE may determine a UL transmission beam or transmission filter and a DL reception beam or reception filter by using the joint TCI state indicated 3 ms after transmission of a PUCCH that includes hybrid automatic repeat request acknowledgment (HARQ-ACK) information indicating whether the reception of the PD SC H including the MAC-CE is successful, and if there are at least two joint TCI states included in the MAC-CE, the UE may identify that a plurality of joint TCI states correspond to each codepoint of TCI state field of DCI format 1_1 or 1_2, the plurality of joint TCI states being indicated by the MAC-CE 3 ms after transmission of a PUCCH that includes HARQ-ACK information indicating whether the reception of the PDSCH including the MAC-CE is successful, and may activate the plurality of the indicated joint TCI states. After this, the UE may receive the DCI format 1_or 1_2 and may apply joint TCI state indicated in the TCI state filed in the DCI to UL transmission and DL reception beams. In this case, the DCI format 11 or 12 may include DL data channel scheduling information (with DL assignment) or may not include the DL data channel scheduling information (without DL assignment).

If the UE receives an indication related to transmission and reception beams by higher layer signaling by using the separate TCI state scheme, the UE may receive an MAC-CE that indicates separate TCI state from the BS and may perform transmission and reception beam application operations, and the BS may schedule reception of a PDSCH including the MAC-CE for the UE in a PDCCH. If there is a separate TCI state set included in the MAC-CE, the UE may determine a UL transmission beam or transmission filter and a DL reception beam or reception filter by using separate TCI states included in the separate TCI state set indicated 3 ms after transmission of a PUCCH that includes HARQ-ACK information indicating whether the reception of the PDSCH is successful. Here, the separate TCI state set may refer to one or more separate TCI states that a codepoint of a TCI state field in DCI format 1_1 or 1 2 may have, and the one separate TCI state set may include one DL TCI state, one UL TCI state, or one DL TCI state and one UL TCI state. If there are two separate TCI state sets included in the MAC-CE, the UE may confirm that the plurality of separate TCI state sets indicated in the MAC-CE 3 ms after transmission of a PUCCH including HARQ-ACK information that refers to whether reception of the PDSCH is successful correspond to each codepoint in a TCI state field of DCI format 1_1 or 1_2, and activate the indicated separate TCI state set. In this case, each codepoint of the TCI state field of DCI format 1_1 or 1_2 may indicate one DL TCI state, one UL TCI state, or one DL TCI state and one UL TCI state. The UE may receive the DCI format 1_1 or 1_2 and may apply the separate TCI state set indicated in the TCI state filed in the DCI to UL transmission and DL reception beams. In this case, the DCI format 1_1 or 1_2 may include DL data channel scheduling information (with DL assignment) or may not include the DL data channel scheduling information (without DL assignment).

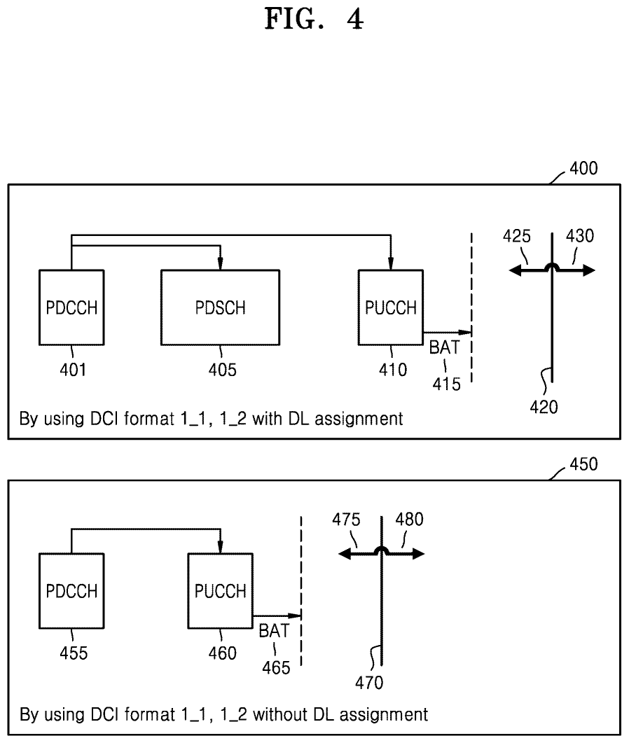

FIG. 4 is a diagram illustrating a beam application time that may be considered when a unified TCI framework is used in a wireless communication system, according to an embodiment of the disclosure.

Referring to FIG. 4, as described above, the UE may receive the DCI format 11 or 12 that includes the DL data channel scheduling information (with DL assignment) or that does not include the DL data channel scheduling information (without DL assignment), and may apply one joint TCI state or separate TCI state set indicated in the TCI state field in the DCI to UL transmission and DL reception beams.

DCI format 1_1 or 1_2 with DL assignment in 400: when the UE receives DCI format 1 or 1_2 including DL data channel scheduling information from the BS in 401, and indicates a separate TCI state set or one joint TCI state based on the unified TCI scheme, the UE may receive a PDSCH scheduled based on the received DCI in 405, and may transmit a PUCCH including HARQ-ACK that indicates whether reception of the DCI and PDSCH is successful in 410. Here, the HARQ-ACK may include meanings of whether reception of the DCI and the PD SC H is successful, and when at least one of the DCI or the PDSCH is not received, the UE may transmit NACK, and when both the two are successfully received, the UE may transmit ACK.

DCI format 1_1 or 1_2 without DL assignment in 450: when the UE receives DCI format 1_1 or 1_2 that does not include DL data channel scheduling information from the BS in 455, and indicates a separate TCI state set or one joint TCI state based on the unified TCI scheme, the UE may assume at least one combination of the following occasions for the DCI:
Including cyclic redundancy check (CRC) scrambled by using a configured scheduling (CS) radio network temporary identifier (RNTI).
All bits allocated to all fields used as a redundancy version (RV) field have a value of 1.
All bits allocated to all fields used as a modulation and coding scheme (MCS) field have a value of 1.
All bits allocated to all fields used as a new data indication (NDI) field have a value of 0.
For a frequency domain resource allocation (FDRA) type 0, all bits allocated to an FDRA field have a value of 0; for an FDRA type 1, all bits allocated to the FDRA field have a value of 1; when the FDRA type is dynamicSwitch, all bits allocated to the FDRA field have a value of 0.

The UE may transmit a PUCCH including HARQ-ACK that indicates whether reception of the DCI format 1_1 or 1_2 with the aforementioned assumptions is successful in 460.
For both the DCI format 1_or 1_2 with DL assignment in 400 and without DL assignment in 450, when a new TCI state indicated via the DCI 401 and 455 is equal to the TCI state that has already been indicated and applied to UL transmission and DL reception beams, the UE may maintain the TCI state that has already been applied, and if the new TCI state is different from the TCI state that has already been indicated, the UE may determine an application time of the joint TCI state or separate TCI state set that may be indicated in a TCI state field included in the DCI to be after (430 or 480) the first slot (420 or 470) after a beam application time (BAT) (415 or 465) passes after transmission of the PUCCH, and may use the TCI state that has already been indicated until before (425 or 475) the slot (420 or 470).
For both the DCI format 11 or 12 with DL assignment 400 and without DL assignment 450, the BAT may be a particular number of OFDM symbols and configured by higher layer signaling based on UE capability report information, and the numerology for the BAT and the first slot after the BAT may be determined based on the smallest numerology of all cells to which the joint TCI state or separate TCI state set indicated in the DCI is applied.

The UE may apply the one joint TCI state indicated in the MAC-CE or DCI to reception of control resource sets connected to all UE-specific search spaces, transmission of a PUSCH and reception of a PDSCH scheduled in a PDCCH transmitted in the corresponding control resource set, and transmission of all PUCCH resources.

When the one separate TCI state set indicated in the MAC-CE or DCI includes one DL TCI state, the UE may apply the one separate TCI state set to reception of control resource sets connected to all UE-specific search spaces and reception of a PDSCH scheduled in a PDCCH transmitted in the corresponding control resource set, and may apply the UL TCI state that has been indicated to all PUSCH and PUCCH resources.

When the one separate TCI state set indicated in the MAC-CE or DCI includes one UL TCI state, the UE may apply the one separate TCI state set to all PUSCH and PUCCH resources, and may apply the DL TCI state that has been indicated to reception of control resources sets connected to all UE-specific search spaces and reception of a PDSCH scheduled in a PDCCH transmitted in the corresponding control resource set.

When the one separate TCI state set indicated in the MAC-CE or DCI includes one DL TCI state and one UL TCI state, the UE may apply the DL TCI state to reception of control resource sets connected to all UE-specific search spaces and reception of a PDSCH scheduled in a PDCCH transmitted in the corresponding control resource set, and may apply the UL TCI state to all PUSCH and PUCCH resources.

Unified TCI state MAC-CE

Hereinafter, a single TCI sate indication and activation method based on a unified TCI scheme will now be described. The UE may be scheduled by the BS for a PDSCH that includes the following MAC-CE, and 3 slots after transmitting HARQ-ACK for the PDSCH, the UE may interpret each codepoint of a TCI state field in the DCI format 1_1 or 1_2 based on information in the MAC-CE received from the BS. In other words, the UE may activate each entry of the MAC-CE received from the BS at each codepoint of the TCI state field in the DCI format 1_1 or 1_2.

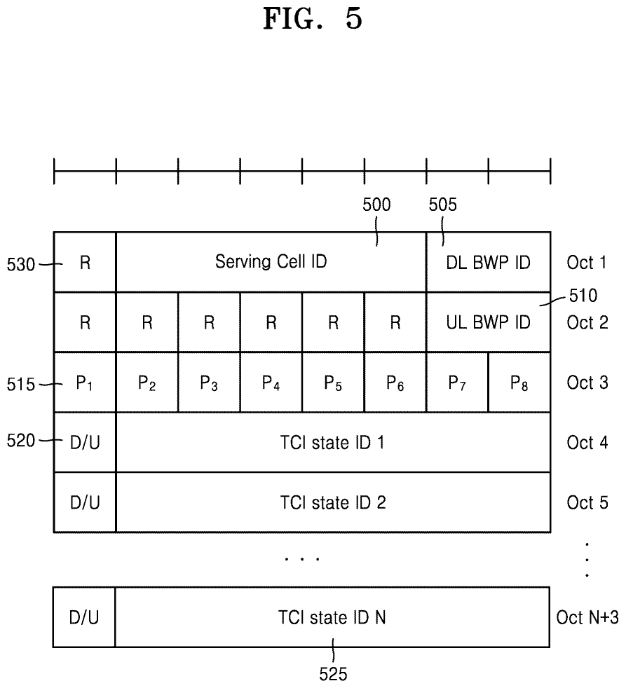

FIG. 5 is a diagram illustrating a MAC-CE structure for activation and indication of joint TCI state or separate DL or UL TCI state in a wireless communication system according to an embodiment of the disclosure.

Referring to FIG. 5, each field in the MAC-CE structure may have the following meanings:

Serving Cell ID 500: This field may indicate that to which serving cell the corresponding MAC-CE is to be applied. The length of the field may be 5 bits. If a serving cell indicated by the field is included in one or more of higher layer signaling simultaneousU-TCI-UpdateList1, simultaneousU-TCI-UpdateList2, simultaneousU-TCI-UpdateList3, orsimultaneousU-TCI-UpdateList4, the MAC-CE may beappliedto all serving cells included in a list of one or more of simultaneousU-TCI-UpdateList1, simultaneousU-TCI-UpdateList2, simultaneousU-TCI-UpdateList3, simultaneousU-TCI-UpdateList4, including the serving cell indicated by the field.
DL BWP ID 505: This field may indicate that to which DL BWP the MAC-CE is to be applied, and the meaning of each codepoint of the field may correspond to each codepoint of a bandwidth part indicator in the DCI. The length of the field may be 2 bits.
UL BWP ID 510: This field may indicate that to which UL BWP the MAC-CE is to be applied, and the meaning of each codepoint of the field may correspond to each codepoint of a bandwidth part indicator in the DCI. The length of the field may be 2 bits.
Pᵢ 515: This field may indicate whether each codepoint of the TCI state field in the DCI format 11 or 12 has a plurality of TCI states or one TCI state. If Pᵢ has a value of 1, it means that the i-th codepoint has a plurality of TCI states, which may mean that the codepoint may include the separate DL TCI state and the separate UL TCI state. If Pᵢ has a value of 0, it means that the i-th codepoint has a single TCI state, which may mean that the codepoint may include one of the joint TCI state or the separate DCI TCI state, or the separate UL TCI state.
D/U 520: This field may indicate whether a TCI state ID field in the same octet corresponds to the joint TCI state or the separate DL TCI state, or the separate UL TCI state. If the field is 1, the TCI state ID field in the same octet may correspond to the joint TCI state or the separate DL TCI state, and if the field is 0, the TCI state ID field in the same octet may correspond to the separate UL TCI state.
TCI state ID 525: This field may indicate a TCI state that may be identified by higher layer signaling TCI-StateID. If the D/U field is set to 1, the field may be used to representTCI-StateID that may be represented in 7 bits. If the D/U field is set to 0, a most significant bit (MSB) of the field may be regarded as a reserved bit and the remaining six bits may be used to represent higher layer signaling UL-TCI State-ID. The maximum number of TCI states that may be activated may be eight for the joint TCI state, and sixteen for the separate DL or UL TCI state.
R 530: It means a reserved bit and may be set to 0.

As for the M A C-CE structure of FIG. 5, the UE may include the third octet including P1, P2, . . . , P8 fields in the MAC-C E structure in FIG. 5, regardless of whether unifiedTCI-StateType-r17 in MIMOparam-r17 in ServingCellConfig that is higher layer signaling is set to ‘joint’ or ‘separate’. In this case, the UE may perform TCI state activation by using the MAC-CE structure that is stationary, regardless of higher layer signaling configured by the BS.

In an embodiment of the disclosure, as for the M A C-CE structure of FIG. 5, the UE may omit the third octet including P1, P2, . . . , P8 fields in FIG. 5, when unifiedTCI-StateType-r17 in MIMOparam-r17 in ServingCellConfig that is higher layer signaling is set to ‘joint’. In this case, the UE may save up to 8 bits of the payload of the MAC-CE depending on the higher layer signaling configured by the BS. In addition, D/U fields placed in the first bit from the fourth octet in FIG. 5 may all be regarded as field R, and may be set to bit 0.

Additional single and multiple TCI state indication and activation method based on unified TCI scheme

According to an embodiment of the disclosure, an additional single and multiple TCI state indication and activation method based on a unified TCI scheme will now be described. The UE may be scheduled by the BS for a PDSCH including a MAC-CE that may be configured as a combination of at least one of various MAC-CE structures, and 3 slots after transmitting HARQ-A CK for the PDSCH, the UE may interpret each codepoint of a TCI state field in the DCI format 1_1 or 1_2 based on information in the MAC-CE received from the BS. For example, the UE may activate each entry of the MAC-CE received from the BS at each codepoint of the TCI state field in the DCI format 1_or 2.

If the UE is configured with two different CO RESET Pool Index by higher layer signaling, and is configured with D Lor joint TCI State or UL-TCI State which is higher layer signaling, the BS and the UE may expect that the R field 530 existing in a first octet is interpreted as a field indicating CORESET Pool ID, in FIG. 5 showing one of MAC-CE structures indicating unified TCI state activation. If corresponding CORESET Pool ID is set to 0, the UE may regard that the corresponding MAC-CE is applicable to each codepoint of a TCI state field in a PDCCH transmitted in CORESET corresponding to CORESETPoolIndex 0. If corresponding CORE SET Pool ID is set to 1, the UE may regard that the corresponding MAC-CE is applicable to each codepoint of a TCI state field in a PDCCH transmitted in CORESET corresponding to CORESETPoolIndex 1.

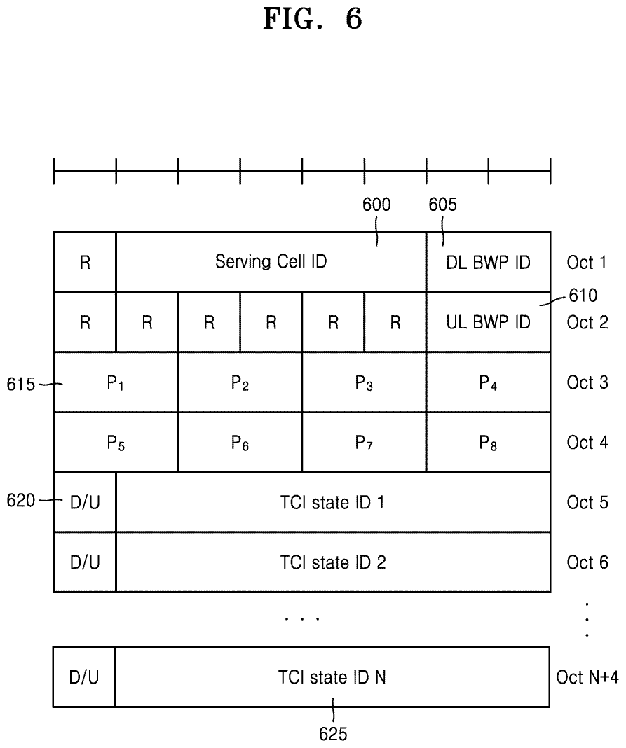

FIG. 6 is a diagram illustrating a MAC-CE structure for activation and indication of joint TCI state or separate DL or UL TCI state in a wireless communication system according to an embodiment of the disclosure.

Referring to FIG. 6, each field in the MAC-CE structure may have the following meanings:
Serving Cell ID 600: This field may indicate to which serving cell the corresponding MAC-CE is to be applied. The length of the field may be 5 bits. If a serving cell indicated by the field is included in one or more of higher layer signaling simultaneousU-TCI-UpdateList1, simultaneousU-TCI-UpdateList2, simultaneousU-TCI-UpdateList3, orsimultaneousU-TCI-UpdateList4,the MAC-CE may beappliedto all serving cells included in a list of one or more of simultaneousU-TCI-UpdateList1, simultaneousU-TCI-UpdateList2, simultaneousU-TCI-UpdateList3, simultaneousU-TCI-UpdateList4, including the serving cell indicated by the field.
DL BWP ID 605: This field may indicate that to which DL BWP the MAC-CE is to be applied, and the meaning of each codepoint of the field may correspond to each codepoint of a bandwidth part indicator in the DCI. The length of the field may be 2 bits.
UL BWP ID 610: This field may indicate that to which UL BWP the MAC-CE is to be applied, and the meaning of each codepoint of the field may correspond to each codepoint of a bandwidth part indicator in the DCI. The length of the field may be 2 bits.
Pᵢ 615: This field may indicate whether each codepoint of the TCI state field in the DCI format 1_l or 1_2 has a plurality of TCI states or one TCI state.
If unifiedTCI-StateType-r17 in MIMOparam-r17 in ServingCellConfig that is higher layer signaling is configurable to one of ‘joint’ and ‘separate’, the UE may interpret this field as below, regardless of which one of two pieces of configuration information is set.
If Pᵢ has a value of ‘00’, it means that corresponding i^{th} codepoint has a single TCI state, and it may mean that the corresponding codepoint may include one of the joint TCI state or the separate DCI TCI state, or the separate UL TCI state.
If Pᵢ has a value of ‘01′, it means that corresponding i^{th} codepoint has two TCI states, and it may mean that the corresponding codepoint may include one of two joint TCI states, one separate DL TCI state and one separate UL TCI state, two separate DL TCI states, or two separate UL TCI states.
If Pᵢ has a value of ‘10′, it means that corresponding i^{th} codepoint has three TCI states, and it may mean that the corresponding codepoint may include one separate DL TCI state and two separate UL TCI states, or two separate DL TCI states and one separate UL TCI state.
If Pᵢ has a value of ‘11′, it means that corresponding i^{th} codepoint has four TCI states, and it may mean that the corresponding codepoint may include two separate DL TCI states and two separate UL TCI states.
If the UE is configurable with one of joint, separate, and mixed mode by unifiedTCI-StateType-r17 in MIMOparam-r17 in ServingCellConfig that is higher layer signaling, this field may be interpreted as below, regardless of which configuration value among available configuration values is configured. The mixed mode may be expressed as one configuration value meaning that a general mixed mode of joint TCI state and separate DL or UL TCI state is possible, or may be expressed as a plurality of configuration values, such as ‘1joint+1DL′, ‘1joint+1UL’, etc. to indicate a particular combination of a particular number of joint TCI states and a particular number of separate DL s or UL TCI states.
If Pᵢ has a value of ‘00’, it means that corresponding i^{th} codepoint has a single TCI state, and it may mean that the corresponding codepoint may include one of the joint TCI state or the separate DCI TCI state, or the separate UL TCI state.
If Pᵢ has a value of ‘01’, it means that corresponding i^{th} codepoint has two TCI states, and it may mean that the corresponding codepoint may include one of two joint TCI states, one joint TCI state and one separate DL TCI state, one joint TCI state and one separate UL TCI state, one separate DL TCI state and one separate UL TCI state, two separate DL TCI states, or two separate UL TCI states. If the UE is configured with a value, such as a mixed mode meaning that joint TCI state and separate DL or UL TCI state is possible, by unifiedTCI-StateType-r17 in MIMOparam-r17 in ServingCellConfig that is higher layer signaling, both one joint TCI state and one separate DL TCI state, and one joint TCI state and one separate UL TCI state may be possible. If the UE is configured with one of ‘1joint+1DL‘ and’1joint+1UL’ by unifiedTCI-StateType-r17 in MIMOparam-r17 in ServingCellConfig that is higher layer signaling, only a case corresponding to a configuration value by unified TCI-StateType-r17 among one joint TCI state and one separate DL TCI state, one joint TCI state and one separate UL TCI state may be possible.
If Pᵢ has a value of ‘10′, it means that corresponding i^{th} codepoint has three TCI states, and it may mean that the corresponding codepoint may include one separate DL TCI state and two separate UL TCI states, or two separate DL TCI states and one separate UL TCI state.
If Pᵢ has a value of ‘11′, it means that corresponding i^{th} codepoint has four TCI states, and it may mean that the corresponding codepoint may include two separate DL TCI states and two separate UL TCI states.
The corresponding field may be 2 bits.
D/U: This field may indicate whether a TCI state ID field in the same octet is the joint TCI state or the separate DL TCI state, or the separate UL TCI state. If this field is 1, the TCI state ID field in the same octet may correspond to the joint TCI state or the separate DL TCI state, and if this field is 0, the TCI state ID field in the same octet may correspond to the separate UL TCI state.
TCI state ID 625: This field may indicate a TCI state that may be identified by higher layer signaling TCI-StateID. If the D/U field is set to 1, the field may be used to representTCI-StateID that may be represented in 7 bits. If the D/U field is set to 0, a MSB of the field may be regarded as a reserved bit and the remaining six bits may be used to represent higher layer signaling UL-TCIState-ID. The maximum number of TCI states that may be activated may be eight for the joint TCI state, and sixteen for the separate DL or UL TCI state.
R: This means a reserved bit, and may be set to 0.

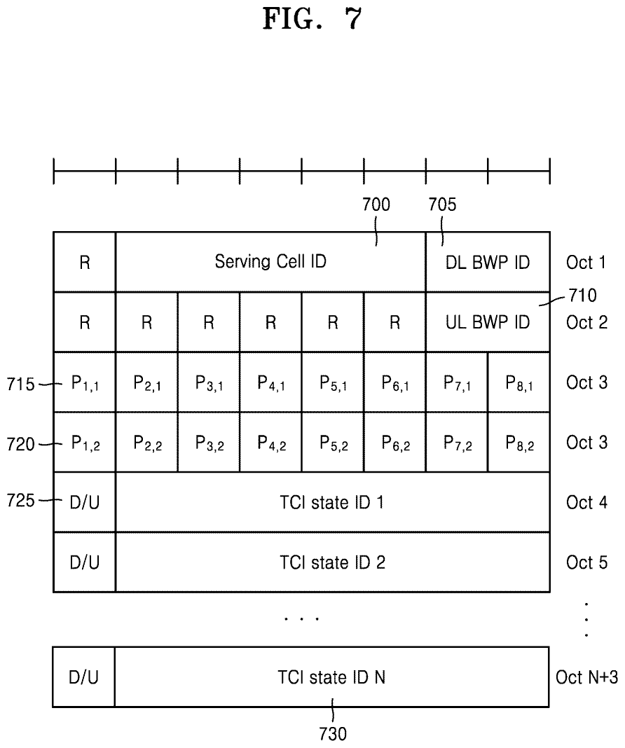

FIG. 7 is a diagram illustrating a MAC-CE structure for activation and indication of a plurality of joint TCI states or separate DLs or UL TCI states in a wireless communication system according to an embodiment of the disclosure.

Referring to FIG. 7, each field in the MAC-CE structure may have the following meanings:

Serving Cell ID 700: This field may indicate that to which serving cell the corresponding MAC-CE is to be applied. The length of the field may be 5 bits. If a serving cell indicated by the field is included in one or more of higher layer signaling simultaneousU-TCI-UpdateList1, simultaneousU-TCI-UpdateList2, simultaneousU-TCI-UpdateList3, orsimultaneousU-TCI-UpdateList4,the MAC-CE may beappliedto all serving cells included in a list of one or more of simultaneousU-TCI-UpdateList1, simultaneousU-TCI-UpdateList2, simultaneousU-TCI-UpdateList3, simultaneousU-TCI-UpdateList4, including the serving cell indicated by the field.
DL BWP ID 705: This field may indicate that to which DL BWP the MAC-CE is to be applied, and the meaning of each codepoint of the field may correspond to each codepoint of a bandwidth part indicator in the DCI. The length of the field may be 2 bits.
UL BWP ID 710: This field may indicate that to which UL BWP the MAC-CE is to be applied, and the meaning of each codepoint of the field may correspond to each codepoint of a bandwidth part indicator in the DCI. The length of the field may be 2 bits.
P_{i,1 715}, and P_{i,2 720}: This field may indicate whether each codepoint of the TCI state field in the DCI format 1_1 or 12 has a plurality of TCI states or one TCI state.
For a case in which the UE is configurable with one of joint and separate by unifiedTCI-StateType-r17 in MIMOparam-r17 in ServingCellConfig that is higher layer signaling, or is configurable with one of joint, separate, and mixed mode, if the UE is configured with joint by unifiedTCI-StateType-r17 that is higher layer signaling, 4^{th} octet including P1,2, P2,2, . . . , P8,2 fields in FIG. 7 may be skipped, and only P_{i,1} may be interpreted as below. The mixed mode may be expressed as one configuration value meaning that a general mixed mode of joint TCI state and separate DL or UL TCI state is possible, or may be expressed as a plurality of configuration values, ‘1joint+1DL’, ‘1joint+1UL’, etc. to indicate a particular combination of a particular number of joint TCI states and a particular number of separate DLs or UL TCI states.
If P_{i,1} has a value of ‘0′, it means that corresponding i^{th} codepoint has one TCI state, and it may mean that the corresponding codepoint may include one joint TCI state.
If P_{i,1} has a value of ‘1′, it means that corresponding i^{th} codepoint has two TCI states, and it may mean that the corresponding codepoint may include two joint TCI states.
For a case in which the UE is configurable with one of joint and separate by unifiedTCI-StateType-r17 in MIMOparam-r17 in ServingCellConfig that is higher layer signaling, or is configurable with one of joint, separate, and mixed mode, when the UE is configured with separate by unifiedTCI-StateType-r17 that is higher layer signaling, the UE may regard P_{i,1} of 3^{rd} octet and P_{i,2} of 4^{th} octet as 2-bit one field, and may interpret as below. The mixed mode may be expressed as one configuration value meaning that a general mixed mode of joint TCI state and separate DL or UL TCI state is possible, or may be expressed as a plurality of configuration values, such as ‘1joint+1DL’, ‘1joint+1UL’, etc. to indicate a particular combination of a particular number of joint TCI states and a particular number of separate DLs or UL TCI states.
If P_{i,1} and P_{i,2} respectively have a value of ‘0′ and a value of ‘0′, it means that corresponding i^{th} codepoint has single TCI state, and it may mean that the corresponding codepoint may include one of separate DL TCI state or separate UL TCI state.
If P_{i,1} and P_{i,2} respectively have a value of ‘0′ and a value of ‘1′, it means that corresponding i^{th} codepoint has two TCI states, and it may mean that the corresponding codepoint may include one of one separate DL TCI state and one separate UL TCI state, two separate DL TCI states, or two separate UL TCI states.
If P_{i,1} and P_{i,2} respectively have a value of ‘1′ and a value of ‘0′, it means that corresponding i^{th} codepoint has three TCI states, and it may mean that the corresponding codepoint may include one separate DL TCI state and two separate UL TCI states, or two separate DL TCI states and one separate UL TCI state.
If P_{i,1} and P_{i,2} respectively have a value of ‘1′ and a value of ‘1′, it means that corresponding i^{th} codepoint has four TCI states, and it may mean that the corresponding codepoint may include two separate DL TCI states and two separate UL TCI states.
For a case in which the UE is configurable with one of joint, separate, and mixed mode by unifiedTCI-StateType-r17 in MIMOparam-r17 in ServingCellConfig that is higher layer signaling, when the UE is configured with mixed mode by unifiedTCI-StateType-r17 that is higher layer signaling, the UE may interpret P_{i,1} of 3^{rd} octet as below, and may not transmit 4^{th} octet. The mixed mode may be expressed as one configuration value meaning that a general mixed mode of joint TCI state and separate DL or UL TCI state is possible.
If P_{i,1} has a value of ‘0′, it may mean that corresponding i^{th} codepoint includes one joint TCI state and one separate DL TCI state.
If P_{i,1} has a value of ‘1′, it may mean that corresponding i^{th} codepoint includes one joint TCI state and one separate UL TCI state.
For a case in which the UE is configurable with one of joint, separate, and mixed mode by unifiedTCI-StateType-r17 in MIMOparam-r17 in ServingCellConfig that is higher layer signaling, when the UE is configured with mixed mode by unifiedTCI-StateType-r17 that is higher layer signaling, the UE may interpret P_{i,1} of 3^{rd} octet and P_{i,2} of 4^{th} octet as below. The mixed mode may be expressed as one configuration value meaning that a general mixed mode of joint TCI state and separate DL or UL TCI state is possible.
If P_{i,1} has a value of ‘0′, it may mean that corresponding i^{th} codepoint includes only one joint TCI state. For example, as mixed mode is not used, a value of P_{i,2} may be ignored.
If P_{i,1} has a value of ‘1′, it may mean that corresponding i^{th} codepoint includes one joint TCI state and additionally includes one of one separate UL TCI state and one separate DL TCI state. For example, mixed mode may be used for the corresponding codepoint, and when a value of P_{i,2} is ‘0′, one separate UL TCI state may be additionally used, and a value of P_{i,2} is ‘1′, one separate DL TCI state may be additionally used.
D/U 725: This field may indicate whether a TCI state ID field in the same octet is joint TCI state or separate DL TCI state, or separate UL TCI state. If the field is 1, the TCI state ID field in the same octet may correspond to the joint TCI state or the separate DL TCI state, and if the field is 0, the TCI state ID field in the same octet may correspond to the separate UL TCI state.
TCI stateID 730: This field may indicate TCI state that may be identified by TCI-StateID that is higher layer signaling. If the D/U field is set to 1, the field may be used to represent TCI-StateID that may be represented in 7 bits. If the D/U field is set to 0, a most significant bit (MSB) of the field may be regarded as a reserved bit and the remaining six bits may be used to represent higher layer signaling UL-TCI State-ID. The maximum number of TCI states that may be activated may be eight for the joint TCI state, and sixteen for the separate DL or UL TCI state.
R: This means a reserved bit, and may be set to 0.

unified TCI-StateType-r17 in MIMOparam-r17 in ServingCellConfig that is higher layer signaling may be defined as a new parameter, such as unifiedTCI-StateType-r18 in MIMOparam-r18 that is higher layer signaling in ServingCellConfig, or an existing parameter may be reused.

In the specification, when it is described that a resource is transmitted/received, it may be understood that a reference signal corresponding to the resource is transmitted/received.

### First Embodiment: Method of Supporting SRS for Codebook Use for UE Supporting 3 Transmission Antennas>

According to an embodiment of the disclosure, a method of supporting an SRS for codebook use for a UE that supports 3 transmission antennas will now be described. The embodiment may be operated by being combined with at least one another embodiment described in the disclosure.

As described above, for codebook based PUSCH transmission, the UE may be configured with codebook in txConfig of higher layer signaling. In addition, the UE may be configured by the BS with a SRS resource set in which higher layer signaling ‘usage’ is set to ‘codebook’, and may be configured with up to two SRS resources in the configured SRS resource set. In this regard, an SRS resource that is configurable for codebook based PUSCH transmission by the UE that supports 3 transmission antennas may follow a combination of at least one of methods described below.

### Method 1-1

According to an embodiment of the disclosure, the UE may be configured with an SRS resource configured with 4 antenna ports so as to perform codebook based PUSCH transmission via 3 antenna ports. In more detail, the UE may expect that up to two SRS resources configured with 4 antenna ports are configured in the SRS resource set in which usage is set to codebook. For example, the SRS resource set in which usage is set to codebook may include up to two SRS resources configured with 4 antenna ports. Here, the UE may not perform transmission with respect to one antenna port among the 4 antenna ports configuring the SRS resource.

In this regard, the one antenna port via which the UE does not perform transmission may be determined as the last antenna port (e.g., an antenna port 1003) among the 4 antenna ports configuring (included in) the SRS resource.

Alternatively, the one antenna port via which the UE does not perform transmission may be determined as the first antenna port (e.g., an antenna port 1000) among the 4 antenna ports configuring (included in) the SRS resource.

Alternatively, the one antenna port via which the UE does not perform transmission may be determined as a random antenna port (e.g., any one of antenna port 1002, or antenna ports 1000 to 1003) that may be defined in the standard, among the 4 antenna ports configuring (included in) the SRS resource.

Alternatively, the one antenna port via which the UE does not perform transmission may be determined as an antenna port (e.g., non-transmission via an antenna port 1002 may be configured by the BS in higher layer signaling) determined according to a notice (combination of at least one of higher layer signaling, MAC-CE signaling, or L1 signaling) from the BS, among the 4 antenna ports configuring (included in) the SRS resource.

Hereinafter, in the disclosure, that the UE does not perform transmission with respect to a particular antenna port related to an SRS resource may mean that the UE does not perform SRS transmission via the particular antenna port. In addition, in the disclosure, that a particular antenna port related to an SRS resource is not transmitted may mean that the UE does not perform SRS transmission via the particular antenna port.

Hereinafter, in the disclosure, that the UE performs transmission with respect to a particular antenna port related to an SRS resource may mean that the UE performs SRS transmission via the particular antenna port. In addition, in the disclosure, that a particular antenna port related to an SRS resource is transmitted may mean that the UE performs SRS transmission via the particular antenna port.

According to an embodiment of the disclosure, when the UE does not perform transmission with respect to the SRS resource configured with 4 antenna ports via the last antenna port (e.g., the antenna port 1003), the UE may generate an SRS sequence based on the SRS resource, and may transmit an SRS on an allocated time and frequency resource (SRS resource) by using only comb offsets and cyclic shift values allocated to the antenna ports 1000, 1001, and 1002.

As the UE and the BS may assume that an antenna port related to the UE-transmitted SRS and a PUSCH antenna port that the BS may schedule based on the UE-transmitted SRS are equal to each other, in a case where three antenna ports 1000, 1001, and 1002 exist in association with a PUSCH transmitted from the UE, based on 3 transmission antennas, that the last antenna port 1003 among the 4 antenna ports with respect to the SRS resource configured with 4 antenna ports is not transmitted (SRS is not transmitted via the last antenna port 1003) may be the most simple scheme for the single UE and the BS which may maintain connection/association relation between an SRS antenna port and a PUSCH antenna port.

In this regard, the connection/association relation between the SRS antenna port and the PUSCH antenna port may indicate assumption in which the antenna port related to the UE-transmitted SRS and the PUSCH antenna port that the BS may schedule based on the U F-transmitted SRS are equal to each other. Here, that the connection/association relation between the SRS antenna port and the PUSCH antenna port is maintained may mean that port numbers of antenna ports configuring the SRS antenna port and port numbers of antenna ports configuring the PUSCH antenna port are equal.

For example, in a case where the port numbers of the antenna ports configuring the SRS antenna port are 1000, 1001, and 1002, if the port numbers of the antenna ports configuring the PUSCH antenna port are also 1000, 1001, and 1002, the connection/association relation between the SRS antenna port and the PUSCH antenna port may be maintained. Alternatively, in a case where the port numbers of the antenna ports configuring the SRS antenna port are 1001, 1002, and 1003, if the port numbers of the antenna ports configuring the PUSCH antenna port are also 1000, 1001, and 1002, the connection/association relation between the SRS antenna port and the PUSCH antenna port may not be maintained.

When SRS transmission is not regularly performed with respect to a particular antenna port, it may disrupt flexibility in view of scheduling by the BS.

According to an embodiment of the disclosure, when an antenna port other than the last antenna port is not transmitted with respect to the SRS resource configured with 4 antenna ports (i.e., when an SRS is not transmitted via the antenna port other than the last antenna port among 4 antenna ports configuring the SRS resource), the UE may readjust/realign/renumber numbers of remaining antenna ports as 1000, 1001, and 1002, the remaining antenna ports excluding the antenna port via which transmission is not performed.

For example, if the UE does not transmit the first antenna port (e.g., antenna port 1000), the UE may readjust/realign/renumber numbers of remaining antenna ports as 1001, 1002, and 1003, may generate an SRS sequence, and may transmit an SRS on an allocated time and frequency resource (SRS resource) by using comb offsets and cyclic shift values.

Alternatively, when the UE does not perform transmission via the second antenna port (e.g., antenna port 1001), the UE may readjust/realign/renumber numbers of remaining antenna ports so that 1002 among 1000, 1002, and 1003 may be readjusted/realigned/renumbered to 1001, and 1003 may be readjusted/realigned/renumbered to 1002.

Alternatively, when the UE does not perform transmission via the third antenna port (e.g., antenna port 1002), the UE may readjust/realign/renumber numbers 1000, 1001, and 1003 of remaining antenna ports so that 1003 may be readjusted/realigned/renumbered to 1002.

Alternatively, when the UE does not perform transmission via the fourth antenna port (e.g., antenna port 1003), as numbers of remaining antenna ports are 1000, 1001, and 1002, the UE may not perform readjustment/realignment/renumbering.

Readjusting an antenna port number may be a method of maintaining the connection/association relation between the SRS and PUSCH antenna ports, however, the method may obtain the same effect as the method of not performing transmission via the last antenna port, such that flexibility in view of scheduling by the BS may be disrupted, similarly to the method described above.

According to an embodiment of the disclosure, when the UE does not transmit the antenna port other than the last antenna port with respect to the SRS resource configured with 4 antenna ports, the UE may not readjust/realign/renumber numbers of remaining antenna ports as 1000, 1001, and 1002, the remaining antenna ports excluding the antenna port that is not transmitted.

For example, if the UE does not transmit the first antenna port (e.g., antenna port 1000), the UE may generate an SRS sequence, on the assumption that an SRS is transmitted via remaining antenna ports 1001, 1002, and 1003, and may perform transmission on an allocated time and frequency resource (SRS resource) by using comb offsets and cyclic shift values. In this case, PUSCH antenna ports are 1000, 1001, and 1002 whereas SRS antenna ports are 1001, 1002, and 1003, such that assumption between the BS and the UE, in which a PUSCH antenna port is equal to an SRS antenna port, is compromised, and thus, an additional definition with respect to connection/association relation between the PUSCH antenna and the SRS antenna port may be required.

For example, one-to-one connection relation in ascending order starting from the lowest antenna port number may be defined between PUSCH antennas and SRS antenna ports. For example, according to the additional connection relation, when indicating individual connection relation between ports (PUSCH antenna port<-+SRS antenna port), all additional connection relations may include individual connection relations, such as (1000<-+1001), (1001<-+1002), (1002<-+1003), etc.

According to an embodiment of the disclosure, in view of the BS allocating a resource to a plurality of UEs, it may be possible to flexibly allocate an antenna port of another UE, according to a scheduling situation,

Method 1-1-above may be not only applied to a UE having 3 transmission antennas but may also be similarly applied to a case of defining an SRS resource for a UE having 5, 6, and 7 transmission antennas to perform codebook based PUSCH transmission. For example, when the UE has 5, 6, and 7 transmission antennas, the UE may not perform transmission with respect to 3, 2, and 1 antenna ports, respectively, on an SRS resource configured with 8 antenna ports, and may reuse the method of not transmitting one antenna port from among 4 antenna ports, in regard to how to select 3, 2, and 1 antenna ports, respectively.

### Method 1-2

According to an embodiment of the disclosure, the UE may perform UL channel estimation for 3 antenna ports by using an SRS resource configured with one antenna port and an SRS resource configured with 2 antenna ports so as to perform codebook based PUSCH transmission via 3 antenna ports. For example, the UE may transmit an SRS to the BS via 3 antenna ports by using each of the SRS resource configured with one antenna port and the SRS resource configured with 2 antenna ports, and the BS may perform UL channel estimation by using the SRS transmitted via the 3 antenna ports. The UE may consider, in an SRS resource set in which ‘usage’ is set to ‘codebook’, the SRS resource configured with one antenna port and the SRS resource configured with 2 antenna ports as one SRS resource group, and may expect configuration of up to two SRS resource groups, each including an SRS resource configured with one antenna port and an SRS resource configured with 2 antenna ports.

For example, when the UE is configured with first and third SRS resources configured with one antenna port, and second and fourth SRS resources configured with 2 antenna ports, the UE may consider the first and second SRS resources as a first SRS resource group to be used in channel estimation with respect to 3 antenna ports, and may consider the third and fourth SRS resources as a second SRS resource group to be used in channel estimation with respect to 3 antenna ports.

The BS does not indicate the UE with an SRS resource via an SRI field in DCI but may indicate the UE with each SRS resource group. For example, as described above, in a case in which the UE is configured with the first to fourth SRS resources, the first and second SRS resources are defined as the first SRS resource group, and the third and fourth SRS resources are defined as the second SRS resource group, the UE may assume that first codepoint and second codepoint in an SRI field respectively indicate the first SRS resource group and the second SRS resource group.

### Method 1-3

According to an embodiment of the disclosure, the UE may perform UL channel estimation for 3 antenna ports by defining an SRS resource configured with 3 antenna ports so as to perform codebook based PUSCH transmission via 3 antenna ports. For example, the SRS resource configured with 3 antenna ports may be defined/configured and an SRS may be transmitted to the BS via 3 antenna port son one SRS resource configured with 3 antenna ports, and the BS may perform UL channel estimation by using the SRS transmitted via 3 antenna ports on one SRS resource. In this regard, 3 antenna ports that may be included in the SRS resource may be 1000, 1001, and 1002, respectively. The UE may expect, in an SRS resource set in which ‘usage’ is set to ‘codebook’, configuration of up to two SRS resources, each being configured with 3 antenna ports.

The UE may be configured with each of a comb offset and a cyclic shift value which may be commonly applied to 3 antenna ports. For example, when a first SRS resource including 3 antenna ports and a second SRS resource including 3 antenna ports are configured, a first comb offset and a first cyclic shift value may be configured for 3 antenna ports included in the first SRS resource, and a second comb offset and a second cyclic shift value may be configured for 3 antenna ports included in the second SRS resource.

According to an embodiment of the disclosure, when comb size is 2 (e.g., K_{TC}=2, that is,

$${n}_{SRS}^{cs , max} = 8$$

according to Table 30 above), the UE may determine comb offsets and cyclic shift values of antenna ports 1000, 1001, and 1002 by using a combination of at least one of embodiments below.

According to an embodiment of the disclosure, in a case of p̅ᵢ ∈ {1000,1001,1002}, the UE may define

$${k}_{TC}^{( {p}_{i} )} = {\overline{k}}_{TC} ,$$

and in this regard, k_{TC} ∈ {0,1, . . . , K_{TC}−1} may be configured by higher layer signaling. For example, the UE is capable of distinguishing and transmitting 3 antenna ports 1000, 1001, and 1002 on the same RE by using different cyclic shift values, and thus, excellent frequency resource allocation efficiency may be guaranteed. With respect to a cyclic shift value for p̅ᵢ ∈ {1000,1001,1002}, the UE may define and use

$${n}_{SRS}^{cs , i} = ( {n}_{SRS}^{cs} + ⌊ \frac{{n}_{SRS}^{cs , max} ( {\overline{p}}_{i} - 1000 )}{{\overline{N}}_{ap}^{SRS}} ⌋ ) mod {n}_{SRS}^{cs , max} ,$$

and in this regard,

$${n}_{SRS}^{cs} ∈ \{ 0 , 1 , … , {n}_{SRS}^{cs , max} - 1 \}$$

may be configured by higher layer signaling. Here,

$${\overline{N}}_{ap}^{SRS}$$

is the number of SRS antenna ports (=3),

$${n}_{SRS}^{cs , m ax} = 8 ,$$

for example, when

$${n}_{SRS}^{cs} = 0 ,$$

cyclic shift values for antenna ports 1000, 1001, and 1002 may be 0, 2, and 5, respectively. Hereinafter, in calculation of cyclic shift gap between antenna ports, a characteristic in which, when a cyclic shift value reaches a maximum value, the cyclic shift value returns back to 0 may be used. In more detail, when the maximum value of the cyclic shift value is 8, the cyclic shift value may return back to 0 after 0, 1, 2, 3, 4, 5, 6, and 7. In this case, as a cyclic shift gap between antenna ports 1000 and 1001 may be 2(2−0=2), acyclic shift gap between antenna ports 1001 and 1002 may be 3(5—2=3), a cyclic shift gap between antenna ports 1002 and 1000 3(8-5=3) (i.e., when calculating a cyclic shift gap between ports 1002 and 1000, a cyclic shift value of the port 1000 at which the cyclic shift value is 0 is assumed to be 8), uneven cyclic shift gaps may occur, and thus, channel estimation performance between antenna ports may vary. According to another method, for a cyclic shift value for p̅ᵢ ∈ {1000,1001,1002}, the UE may define and

$${n}_{SRS}^{cs , i} = ( {n}_{SRS}^{cs} + ⌈ \frac{{n}_{SRS}^{cs , m ax} ( {\overline{p}}_{i} - 1000 )}{{\overline{N}}_{ap}^{SRS}} ⌉ ) mod {n}_{SRS}^{cs , ma x} ,$$

and cyclic shift values for antenna ports 1000, 1001, and 1002 may be 0, 3, and 6, respectively,

$${n}_{SRS}^{cs} = 0 .$$

Hereinafter, in calculation of cyclic shift gap between antenna ports, a characteristic in which, when a cyclic shift value reaches a maximum value, the cyclic shift value returns back to 0 may be used. In more detail, when the maximum value of the cyclic shift value is 8, the cyclic shift value may return back to 0 after 0, 1, 2, 3, 4, 5, 6, and 7. In this case, similarly, as a cyclic shift gap between antenna ports 1000 and 1001 may be 2, a cyclic shift gap between antenna ports 1001 and 1002 may be 3, a cyclic shift gap between antenna ports 1002 and 1000 3 (i.e., when calculating a cyclic shift gap between ports 1002 and 1000, a cyclic shift value of the port 1000 at which the cyclic shift value is 0 is assumed to be 8), uneven cyclic shift gaps may occur, and thus, channel estimation performance between antenna ports may vary.

According to an embodiment of the disclosure, in a case of p̅ᵢ ∈ {1001}, the UE may define

$${k}_{TC}^{( {p}_{i} )} = ( {\overline{k}}_{TC} + {K}_{TC} / 2 ) mod {K}_{TC} ,$$

and in a case of p̅ᵢ ∈ {1000, 1002}, the UE may define

$${k}_{TC}^{( {p}_{i} )} = {\overline{k}}_{TC} .$$

For example, the UE may distinguish and transmit antenna ports 1000 and 1002 on the same RE location by using different cyclic shift values, and may transmit antenna port 1001 on a different RE location, so that, although a frequency resource is used twice as much, a cyclic shift gap between two antenna ports allocated in the same RE may be maximized. For a cyclic shift value for p̅ᵢ ∈ {1000,1001,1002}, the UE may define and use

$${n}_{SRS}^{cs , i} = ( {n}_{SRS}^{cs} + \frac{{n}_{SRS}^{cs , m ax} ⌊ ( {\overline{p}}_{i} - 10 \; 00 ) / 2 ⌋}{⌈ {\overline{N}}_{ap}^{SRS} / 2 ⌉} ) mod {n}_{SRS}^{cs , ma x} .$$

For example, in a case of k̅_{TC}=0, n=0,

$${n}_{SRS}^{cs} = 0 ,$$

cyclic shift values for antenna ports 1000 and 1002 at comb offset 0 location may be 0 and 4, respectively, and a cyclic shift value for an antenna port 1001 at comb offset 1 location may be 0. In this case, a cyclic shift gap between the antenna ports 1000 and 1002 is 4, and when different SRS transmission allocation from the BS does not exist, a different cyclic shift value is not allocated to the antenna port 1001, and thus, channel estimation performance between antenna ports may vary. In addition, even when an SRS is transmitted at a different comb offset location, as a gap between comb offsets is only one, that a cyclic shift value for the antenna port 1000 at comb offset 0 and a cyclic shift value for the antenna port 1001 at comb offset 1 are equal as 0 may be a factor that makes distinguishment between antenna ports difficult in channel estimation. Therefore, when the UE defines and uses a cyclic shift value of p̅ᵢ ∈ {1000,1001,1002}as

$${n}_{SRS}^{cs , i} = ( {n}_{SRS}^{cs} + \frac{{n}_{SRS}^{cs , m ax} ⌈ ( {\overline{p}}_{i} - 10 \; 00 ) / 2 ⌉}{⌈ {\overline{N}}_{ap}^{SRS} / 2 ⌉} + {k}_{TC}^{( {p}_{i} )} {n}_{SRS}^{cs , ma x} / 2 ) mod {n}_{SRS}^{cs , ma x} ,$$

in a case of k̅_{TC}=0,

$${n}_{SRS}^{cs} = 0 ,$$

cyclic shift values for the antenna ports 1000 and 1002 at comb offset 0 location may be 0 and 4, respectively, and a cyclic shift value for the antenna port 1001 at comb offset 1 location may be 8, and thus, even when comb offset difference is one, cyclic shift values at respective comb offsets are allocated not to overlap each other, and clear distinguishment between antenna ports in channel estimation may be achieved.

When comb size is 4 (e.g., K_{TC}=4, that is,

$${n}_{SRS}^{cs , ma x} = 12$$

according to Table 30 above), the UE may determine comb offset values of antenna ports 1000, 1001, and 1002 by using a combination of at least one of embodiments below.
According to an embodiment of the disclosure, in a case of pᵢ ∈ {1000,1001,1002}, the UE may define

$${k}_{TC}^{( {p}_{i} )} = {\overline{k}}_{TC} ,$$

and in this regard, k_{TC} ∈ {0,1, . . . , K_{TC}-1} may be configured by higher layer signaling. For example, the UE is capable of distinguishing and transmitting 3 antenna ports 1000, 1001, and 1002 on the same RE by using different cyclic shift values, and thus, frequency resource allocation efficiency may be guaranteed. With respect to a cyclic shift value for pᵢ E {1000,1001,1002}, the UE may define and use

$${n}_{SRS}^{cs , i} = ( {n}_{SRS}^{cs} + \frac{{n}_{SRS}^{cs , m ax} ( {\overline{p}}_{i} - 1000 )}{{\overline{N}}_{ap}^{SRS}} ) mod {n}_{SRS}^{cs , ma x} ,$$

and in this regard,

$${n}_{SRS}^{cs} ∈ \{ 0 , 1 , … , {n}_{SRS}^{cs , ma x} - 1 \}$$

may be configured by higher layer signaling. For example, in a case of

$${n}_{SRS}^{cs} = 0 ,$$

cyclic shift values for the antenna ports 1000, 1001, and 1002 may be 0, 4, and 8, respectively. Hereinafter, in calculation of cyclic shift gap between antenna ports, a characteristic in which, when a cyclic shift value reaches a maximum value, the cyclic shift value returns back to 0 may be used. In more detail, when the maximum value of the cyclic shift value is 12, the cyclic shift value may return back to 0 after 0, 1, 2, 3, 4, 5, 6, 7, 8, 9, 10, and 11. In this case, as a gap between two antenna ports among 3 antenna ports may be equally 4 (i.e., when calculating a cyclic shift gap between ports 1002 and 1000, a cyclic shift value of the port 1000 at which the cyclic shift value is 0 is assumed to be 12), channel estimation performance between antenna ports may be similar.
According to an embodiment of the disclosure, the UE may define

$${k}_{TC}^{( {p}_{i} )} = ( {\overline{k}}_{TC} + {K}_{TC} / 2 ) mod {K}_{TC}$$

in a case of pᵢ ∈ {1001}, and may define

$${k}_{TC}^{( {p}_{i} )} = {\overline{k}}_{TC}$$

in a case of pᵢ ∈ {1000,1002}. For example, the UE may distinguish and transmit antenna ports 1000 and 1002 on the same RE location by using different cyclic shift values, and may transmit antenna port 1001 on a different RE location, so that, although a frequency resource is used twice as much, a cyclic shift gap between two antenna ports allocated in the same RE may be maximized. With respect to a cyclic shift value for p̅ᵢ ∈ {1000,1001,1002}, the UE may define and use

$${n}_{SRS}^{cs , i} = ( {n}_{SRS}^{c s} + \frac{{n}_{SRS}^{cs , max} ⌊ ( {\overline{p}}_{i} - 10 \; 00 ) / 2 ⌋}{⌈ {\overline{N}}_{ap}^{SRS} / 2 ⌉} ) mod {n}_{SRS}^{cs , max} .$$

For example, in a case of

$${\overline{k}}_{TC} = 0 , {n}_{SRS}^{cs} = 0 ,$$

cyclic shift values for antenna ports 1000 and 1002 at comb offset 0 location may be 0 and 6, respectively, and a cyclic shift value for an antenna port 1001 at comb offset 2 location may be 0. In this case, a cyclic shift gap between the antenna ports 1000 and 1002 is 6, and when different SRS transmission allocation from the BS does not exist, a different cyclic shift value is not allocated to the antenna port 1001, and thus, channel estimation performance between antenna ports may vary.

According to an embodiment of the disclosure, in a case of pᵢ ∈ {1000,1001,1002}, the UE may define

$${k}_{TC}^{( {p}_{i} )} = ( {\overline{k}}_{TC} + ⌊ \frac{{K}_{TC}}{3} ⌋ ( {p}_{i} - 1000 ) )$$

mod K_{TC}. For example, the UE uses an RE resource by transmitting an SRS at different comb offset locations for antenna ports, respectively, however, as there is no other antenna port allocated in the same RE, the BS may appropriately perform cyclic shift allocation with respect to other SRS transmission, and thus, a cyclic shift gap may be maximized. The UE may define and use a cyclic shift value for pᵢ ∈ {1000,1001,1002}as

$${n}_{SRS}^{cs , i} = {n}_{SRS}^{cs} .$$

For example, in a case of k̅_{TC}=0,

$${n}_{SRS}^{cs} = 0 ,$$

cyclic shift values for antenna ports 1000, 1001, and 1002 at comb offset 0, 1, and 2 locations may be all 0. In this case, when different SRS transmission allocation from the BS does not exist, a different cyclic shift value is not allocated to the antenna ports 1000, 1001, and 1002, and thus, when the BS uniformly performs different SRS transmission allocation for each RE, channel estimation performance between antenna ports may be similar. In addition, even when an SRS is transmitted at a different comb offset location, as a gap between comb offsets is only one, that cyclic shift values for the antenna ports 1000, 1001, and 1002 are equal as 0 at comb offsets 0, 1, and 2 may make distinguishment between antenna ports difficult in channel estimation. Therefore, when the UE defines and uses a cyclic shift value of pᵢ ∈ {1000,1001,1002}as

$${n}_{SRS}^{cs , i} = ( {n}_{SRS}^{cs} + \frac{{n}_{SRS}^{cs , max} ( {\overline{p}}_{i} - 1000 )}{{\overline{N}}_{ap}^{SRS}} ) mod {n}_{SRS}^{cs , max} ,$$

in a case of k̅_{TC}=0,

$${n}_{SRS}^{cs} = 0 ,$$

cyclic shift values for the antenna ports 1000, 1001, and 1002 at comb offset 0, 1, 2 locations may be 0, 4, and 8, respectively, and thus, even when comb offset difference is one, cyclic shift values at respective comb offsets are allocated not to overlap each other, and clear distinguishment between antenna ports in channel estimation may be possible.

According to an embodiment of the disclosure, when comb size is 8 (e.g., K_{TC}=8, that is,

$${n}_{SRS}^{cs , max} = 6$$

according to Table 30 above), the UE may determine comb offset values of antenna ports 1000, 1001, and 1002 by using a combination of at least one of embodiments below.

According to an embodiment of the disclosure, in a case of pᵢ ∈ {1000,1001,1002}, the UE may define

$${k}_{TC}^{( {p}_{i} )} = {\overline{k}}_{TC} ,$$

and in this regard, k̅_{TC} ∈ {0,1, . . . , K_{TC}−1} may be configured by higher layer signaling. For example, the UE is capable of distinguishing and transmitting 3 antenna ports 1000, 1001, and 1002 on the same RE by using different cyclic shift values, and thus, excellent frequency resource allocation efficiency may be guaranteed. With respect to a cyclic shift value for p̅ᵢ ∈ {1000,1001,1002}, the UE may define and use

$${n}_{SRS}^{cs , i} = ( {n}_{SRS}^{cs} + \frac{{n}_{SRS}^{cs , max} ( {\overline{p}}_{i} - 1000 )}{{\overline{N}}_{ap}^{SRS}} ) mod {n}_{SRS}^{cs , max} ,$$

and in this regard,

$${n}_{SRS}^{cs} ∈ \{ 0 , 1 , … , {n}_{SRS}^{cs , max} - 1 \}$$

may be configured by higher layer signaling. For example, in a case of n_{SRS}^{cs}=0, cyclic shift values for the antenna ports 1000, 1001, and 1002 may be 0, 2, and 4, respectively. In this case, as a gap between two antenna ports among 3 antenna ports may be equally 2, channel estimation performance between antenna ports may be similar.

According to an embodiment of the disclosure, the UE may define

$${k}_{TC}^{( {p}_{i} )} = ( {\overline{k}}_{TC} + {K}_{TC} / 2 ) mod {K}_{TC}$$

in a case of p̅ᵢ ∈ {1001}, and may define

$${k}_{TC}^{( {p}_{i} )} = {\overline{k}}_{TC}$$

in a case of p̅ᵢ ∈ {1000,1002}. For example, the UE may distinguish and transmit antenna ports 1000 and 1002 on the same RE location by using different cyclic shift values, and may transmit antenna port 1001 on a different RE location, so that, although a frequency resource is used twice as much, a cyclic shift gap between two antenna ports allocated in the same RE may be maximized. With respect to a cyclic shift value for p̅ᵢ ∈ {1000,1001,1002}, the UE may define and use

$${n}_{SRS}^{cs , i} = ( {n}_{SRS}^{c s} + \frac{{n}_{SRS}^{cs , max} ⌊ ( {\overline{p}}_{i} - 10 \; 00 ) / 2 ⌋}{⌈ {\overline{N}}_{a p}^{SRS} / 2 ⌉} ) mod {n}_{S R S}^{cs , max} .$$

For example, in a case of k̅_{TC}=0,

$${n}_{SRS}^{c s} = 0 ,$$

cyclic shift values for antenna ports 1000 and 1002 at comb offset 0 location may be 0 and 3, respectively, and a cyclic shift value for an antenna port 1001 at comb offset 4 location may be 0. In this case, a cyclic shift gap between the antenna ports 1000 and 1002 is 3, and when different SRS transmission allocation from the BS does not exist, a different cyclic shift value is not allocated to the antenna port 1001, and thus, channel estimation performance may vary in antenna ports.

According to an embodiment of the disclosure, in a case of pᵢ ∈ {1000,1001,1002}, the UE may define,

$${k}_{T C}^{( {p}_{i} )} = ( {\overline{k}}_{T C} + ⌊ \frac{{K}_{T C}}{3} ⌋ ( {p}_{i} - 1000 ) ) mod {K}_{TC} .$$

For example, the UE uses RE resources three times as much by transmitting an SRS at different comb offset locations for antenna ports, respectively, however, as there is no other antenna port allocated in the same RE, the BS may appropriately perform cyclic shift allocation with respect to other SRS transmission, and thus, a cyclic shift gap may be maximized. The UE may define and use a cyclic shift value for pᵢ ∈ {1000,1001,1002}as

$${n}_{S R S}^{cs , i} = {n}_{S R S}^{c s} .$$

For example, in a case of k̅_{TC}=0,

$${n}_{SRS}^{c s} = 0 ,$$

cyclic shift values for antenna ports 1000, 1001, and 1002 at comb offset 0, 2, and 4 locations may be all 0. In this case, when different SRS transmission allocation from the BS does not exist, a different cyclic shift value is not allocated to the antenna ports 1000, 1001, and 1002, and thus, when the BS uniformly performs different SRS transmission allocation for each RE, channel estimation performance between antenna ports may be similar. In addition, even when an SRS is transmitted at a different comb offset location, as a gap between comb offsets is only two, that cyclic shift values for the antenna ports 1000, 1001, and 1002 are equal as 0 at comb offsets 0, 1, and 2 may make distinguishment between antenna ports difficult in channel estimation. Therefore, when the UE defines and uses a cyclic shift value of pig ∈ {1000,1001,1002}as

$${n}_{S R S}^{cs , i} = ( {n}_{S R S}^{cs} + \frac{{n}_{S R S}^{cs , max} ( {\overline{p}}_{i} - 1000 )}{{\overline{N}}_{ap}^{SRS}} ) mod {n}_{S R S}^{cs , max} ,$$

in a case of k̅_{TC}=0

$${n}_{SRS}^{cs} = 0 ,$$

cyclic shift values for the antenna ports 1000, 1001, and 1002 at comb offset 0, 1, 2 locations may be 0, 2, and 4, respectively, and thus, even when comb offset difference is two, cyclic shift values at respective comb offsets are allocated not to overlap each other, and clear distinguishment between antenna ports in channel estimation may be possible.

### Method 1-4

According to an embodiment of the disclosure, the UE may perform UL channel estimation for 3 antenna ports by defining an SRS resource configured with 3 antenna ports so as to perform codebook based PUSCH transmission via 3 antenna ports. For example, the SRS resource configured with 3 antenna ports may be defined/configured and an SRS may be transmitted to the BS via 3 antenna ports on one SRS resource configured with 3 antenna ports, and the BS may perform UL channel estimation by using the SRS transmitted via 3 antenna ports on one SRS resource. In this regard, 3 antenna ports that may be included in the SRS resource may be 1000, 1001, and 1002, respectively. The UE may expect, in an SRS resource set in which ‘usage’ is set to ‘codebook’, configuration of up to two SRS resources, each being configured with 3 antenna ports.

The UE may be configured with a plurality of comb offsets and cyclic shift values for each of 3 antenna ports.

If the UE is configured with two comb offsets and two cyclic shift values, the UE may apply first comb offset and a first cyclic shift value with respect to one antenna port (e.g., antenna port 1001) among 3 antenna ports by using a method of allocating comb offset and cyclic shift with respect to each antenna port on an SRS resource being configurable with one antenna port by using the first comb offset and the first cyclic shift value, and may apply second comb offset and a second cyclic shift value with respect to two antenna ports (e.g., antenna ports 1000 and 1002) among 3 antenna ports by using a method of allocating comb offset and cyclic shift with respect to each antenna port on an SRS resource being configurable with two antenna ports by using the second comb offset and the second cyclic shift value.

If the UE is configured with three comb offsets and three cyclic shift values, the UE may apply first comb offset and a first cyclic shift value with respect to one antenna port (e.g., antenna port 1000) among 3 antenna ports by using a method of allocating comb offset and cyclic shift with respect to each antenna port on an SRS resource being configurable with one antenna port by using the first comb offset and the first cyclic shift value, may apply second comb offset and a second cyclic shift value with respect to one antenna port (e.g., antenna port 1001) among 3 antenna ports by using a method of allocating comb offset and cyclic shift with respect to each antenna port on an SRS resource being configurable with one antenna port by using the second comb offset and the second cyclic shift value, and may apply third comb offset and a third cyclic shift value with respect to one antenna port (e.g., antenna port 1002) among 3 antenna ports by using a method of allocating comb offset and cyclic shift with respect to each antenna port on an SRS resource being configurable with one antenna port by using the third comb offset and the third cyclic shift value.

The UE may expect that a combination of at least one of Method 1-1 to Method 1-4 above is notified from the BS by a combination of at least one of higher layer signaling, MAC-CE signaling or L1 signaling, or a combination of at least one of Method 1-1 to Method 1-4 above is fixedly defined in the standard. Additionally, if the UE is notified of a particular combination of one or more methods from the BS by the combination of at least one of higher layer signaling, MAC-CE signaling or L1 signaling, it may mean that the UE is unable to support the other combinations of the methods. For example, the UE may expect that Method 1-1 above is fixedly defined in the standard, and may assume to use Method 1-1 above for SRS resource configuration in codebook based PUSCH transmission via 3 antenna ports. As another example, the UE may be notified with respect to Method 1-4 above from the BS by a combination of at least one of higher layer signaling, MAC-CE signaling or L1 signaling, and in this case, the UE may regard that the BS notifies that Method 1-1 above is not supported.

The UE may report, in the UE capability to the BS, whether the UE is able to support a combination of at least one of Method 1-1 to Method 1-4 above. Here, w hen the UE reports to the BS that the UE is able to support a particular combination of one or more methods in the UE capability, it may be regarded that the UE also reports that the UE is unable to support the other combinations. For example, the UE may report to the BS whether the UE is able to support Method 1-1 above. As another example, the UE may report to the BS that the UE is able to support Method 1-4 above, and this UE capability report may indicate that the UE is unable to support Method 1-1.

### Second Embodiment: Method of Defining UL Codebook for UE Supporting 3 Transmission Antennas

According to an embodiment of the disclosure, a method of defining UL codebook for a UE that supports 3 transmission antennas will now be described. The embodiment may be operated by being combined with at least one another embodiment described in the disclosure.

The UE that supports 3 transmission antennas may report, in UE capability to the BS, that the UE is able to perform codebook based PUSCH transmission using 3 antenna ports. Here, the UE may report to the BS that the UE is able to perform only non-coherent transmission. For a codebook based PUSCH transmission scheme, the UE may be indicated from the BS with TPMI corresponding to 3 antenna ports. When the UE supports 3 transmission antennas, the UE may support non-coherent codebook. In this regard, non-coherent precoding matrix W for 1, 2, and 3 layer transmission by the UE using 3 antenna ports may be defined in each of Tables 32, 33, and 34 below.

In Table 32 below, the UE may be indicated from the BS with a matrix in which an order of two columns of each of TPMI 0, 1, and 2 is changed. For example, the UE may be indicated from the BS with a matrix, such as

$$\frac{1}{\sqrt{6}} [ \begin{matrix}0 & 1 \\ 1 & 0 \\ 0 & 0\end{matrix} ]$$

in which two columns of TPMI 0 are changed in Table 33 below. When including the matrix in which an order of two columns of TPMI 0 is changed with a matrix in which an order of two columns of TPMI 1 is changed and a matrix in which an order of two columns of TPMI 2 is changed, Table 33 may include 5 matrices to which TPMI 0 to 5 are allocated.

Equally, in Table 34 below, the UE may support matrices in which an order of three columns of TPMI 0 is changed. For example, the UE may be indicated from the BS with a matrix, such as

$$\frac{1}{\sqrt{3}} [ \begin{matrix}0 & 0 & 1 \\ 1 & 0 & 0 \\ 0 & 1 & 0\end{matrix} ]$$

in which three columns of TPMI 0 are changed in Table 34 below. In this regard, a total number of cases in which three different columns may be arranged in different orders is 6(3!=3*2*1=6), and thus, Table 34 that is codebook for 3—port and 3—layer transmission may include 6 matrices in which TPMI 0 to 5 are allocated.

TABLE 32

| TPMI | W (TPMI indices are allocated in ascending | | |
|---|---|---|---|
| index | order from the left to the right) | | |
| 0-2 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ |

TABLE 33

| TPMI | W (TPMI indices are allocated in ascending | | |
|---|---|---|---|
| index | order from the left to the right) | | |
| 0-2 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ |

TABLE 34

| TPMI index | W |
|---|---|
| 0 | $\frac{1}{\sqrt{3}} [ \begin{matrix}1 & 0 & 0 \\ 0 & 1 & 0 \\ 0 & 0 & 1\end{matrix} ]$ |

### Third Embodiment: Method of Supporting SRS for Non-Codebook Use for UE Supporting 3 Transmission Antennas

According to an embodiment of the disclosure, a method of supporting an SRS for non-codebook use for a UE that supports 3 transmission antennas will now be described. The embodiment may be operated by being combined with at least one another embodiment described in the disclosure.

According to an embodiment of the disclosure, for non-codebook based PUSCH transmission, the UE that supports 3 transmission antennas may be configured with non-codebook in txConfig of higher layer signaling. In addition, the UE that supports 3 transmission antennas may be configured by the BS with a SRS resource set in which higher layer signaling ‘usage’ is set to ‘non-codebook’, and may be configured with up to three SRS resources in the configured SRS resource set. In this regard, each SRS resource in an SRS resource set may be configured with (may include) one antenna port.

According to an embodiment of the disclosure, the UE may receive an SRI field from the BS, and the received SRI field may be configured with

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits ,$$

where N_{SRS} may mean the number of SRS resources configured in an SRS resource set and may be available up to 3 as described above.

If the UE is configured with maxMIMO-Layers in PUSCH-ServingCellConfig that is higher layer signaling, Lₘₐₓ may follow a value configured by maxMIMO-Layers, and otherwise, Lₘₐₓ may follow a maximum number of layers applicable to PUSCH operation for non-codebook use reported by the UE.

The UE may report an additional combination of one or more of 3, 5, 6, 7, and 8, as well as 1, 2, and 4, as a maximum number of layers for UL transmission. Here, the UE may report maximum numbers of supportable layers, which are respectively for codebook based PUSCH transmission and non-codebook based PUSCH transmission. For example, information about a maximum number of supportable layers for codebook based PUSCH transmission and information about a maximum number of supportable layers for non-codebook based PUSCH transmission may be separately reported.

According to an embodiment of the disclosure, when the UE is configured with one of cri-RSRP-Index, ssb-Index-RSRP-Index, cri-SINR-Index, and ssb-Index-SINR-Index as reportQuantity in CSI-ReportConfig that is higher layer signaling, the UE may report capabilityIndex in addition to L1-RSRP or L1-SINR report, and capabilityIndex may mean a maximum number of SRS antenna ports supported by the UE and a value of capabilityIndex may be associated with a particular panel of the UE (i.e., association relation may be configured). Based on association/connection relation between the value of capabilityIndex and the particular panel of the UE which are reported with L1-RSRP or L1-SINR report, the BS may assume from which panel of the UE a L1-RSRP or L1-SINR value reported by the UE was measured based on a received reference signal. For example, when the particular panel of the UE supports up to two SRS antenna ports and the UE reports L1-RSRP received via the panel supporting up to two SRS antenna ports, if the UE has been configured with cri-RSRP-Index as reportQuantity, the UE may report 2 as the value of capabilityIndex.

According to an embodiment of the disclosure, the UE may report UE capability on UE capability value reporting to the BS. Here, the UE capability report on UE capability value reporting may be a report on candidate values that may be used as a capabilityIndex value meaning a maximum number of SRS antenna ports supported by the UE. For example, in a case w here {X, Y} are reported according to UE capability value reporting, when the UE reports capabilityIndex, capabilityIndex may be reported as a value of one of X or Y. In this regard, the UE may report, to the BS, maximum four values as the UE capability report on UE capability value reporting, and each reported value may be selected as a different value among {1, 2, 4}. For example, the UE may report three values to the BS, and the reported values may be 1, 2, and 4, respectively. As another example, the UE may report two values to the BS, and the reported values may be 2 and 4 (or, {1 and 2}, or {1 and 4}), respectively. In addition, the UE capability report on UE capability value reporting may be reported for each frequency band. In particular, a case in which the UE may report, to the BS, maximum four values as the UE capability report on UE capability value reporting, but each reported value is selected as different values among {1, 2, 4}corresponds to a case in which maximum three different values may be actually reported, and thus, may be a case in which UE capability is not maximally used.

According to an embodiment of the disclosure, if the UE that supports 3 transmission antennas reports the UE capability on UE capability value reporting to the BS, the UE may use a combination of one or more embodiments to be described below.

### Method 3-1

According to an embodiment of the disclosure, when the UE that supports 3 transmission antennas reports UE capability on UE capability value reporting to the BS, the UE may report maximum four values to the BS, and each reported value may be selected as different values among {1, 2, 3}. For example, the UE may report three values of 1, 2, and 3 to the BS, and after the BS receives the report on three values including 1, 2, and 3 from the UE, the BS may expect the UE to report capabilityIndex as one of the three values by using two bits. For example, codepoint ‘00’ of two bits may correspond to 1, codepoint ‘01′ may correspond to 2, codepoint ‘10′ may correspond to 3, and codepoint ‘11′ may be reserved. In this regard, a value of 3 reported by the UE may mean that a maximum number of SRS ports of the UE is 3, and when the maximum number of SRS ports is reported as 3, for SRS transmission, the UE supporting 3 transmission antenna may use a method of not transmitting one of antenna ports of an SRS resource configured with 4 antenna ports, as in Method 1-1 above, may use both an SRS resource configured with one antenna port and an SRS resource configured with two antenna ports, as in Method 1-2, may use an SRS resource configured with 3 antenna ports, as in Method 1-3 and Method 1-4 above, or may use a method according to a combination of one or more of Method 1-1 to Method 1-4 above.

### Method 3-2

According to an embodiment of the disclosure, when the UE that supports 3 transmission antennas reports UE capability on UE capability value reporting to the BS, the UE may report maximum four values to the BS, and each reported value may be selected as different values among {1, 2, 4}. For example, the UE may report three values of 1, 2, and 4 to the BS, and the BS may expect the UE to report capability Index as one of the three values by using two bits. For example, codepoint ‘00’ of two bits may correspond to 1, codepoint ‘01′ may correspond to 2, codepoint ‘10′ may correspond to 4, and codepoint ‘11′ may be reserved. In this regard, a value of 4 reported by the UE may mean that a maximum number of SRS ports of the UE is 3. For example, even when the UE has reported 4, the BS may regard reported 4 as 3 with respect to the UE that supports 3 transmission antennas. This interpretation may be applied to a case in which the UE that supports 3 transmission antennas uses the method of not transmitting one of antenna reports of an SRS resource configured with 4 antenna ports, as in Method 1-1 above.

In addition, when the UE that supports 4 transmission antennas reports UE capability on UE capability value reporting to the BS, the UE may report maximum four values to the BS, and each reported value may be selected as different values among {1, 2, 3, 4}. For example, the UE may report four values of 1, 2, 3, and 4 to the BS, and the BS may expect the UE to report capabilityIndex as one of the four values by using two bits. For example, codepoint ‘00’ of two bits may correspond to 1, codepoint ‘01′ may correspond to 2, codepoint ‘10′ may correspond to 3, and codepoint ‘11′ may correspond to 4. In this regard, a value of 4 reported by the UE may mean that a maximum number of SRS ports of the UE is 4, and a value of 3 reported by the UE may mean that a maximum number of SRS ports of the UE is 3.

In addition, when the UE that supports 4 transmission antennas reports UE capability on UE capability value reporting to the BS, the UE may report maximum four values to the BS, each reported value may be selected as different values among {1, 2, 4}, and 4 may be reported up to two times. For example, the UE may report four values of 1, 2, 4, and 4 to the BS, and the BS may expect the UE to report capabilityIndex as one of the four values by using two bits. For example, codepoint ‘00’ of two bits may correspond to 1, codepoint ‘01’ may correspond to 2, codepoint ‘10’ may correspond to 4, and codepoint ‘11′ may correspond to 4. Here, when the UE has reported codepoints mapped to 4 in the report, a value of 4 mapped to smaller codepoint (i.e., ‘10′) among codepoints mapped to 4 may mean that a maximum number of SRS ports is 3, and a value of 4 mapped to codepoint whose value is greater may mean that a maximum number of SRS ports is 4.

In addition, when the UE that supports 4 transmission antennas reports UE capability on UE capability value reporting to the BS, the UE may report maximum four values to the BS, and each reported value may be selected as different values among {1, 2, 4}. For example, the UE may report three values of 1, 2, and 4 to the BS, and the B S may expect the UE to report capabilityIndex as one of the three values by using two bits. For example, codepoint ‘00’ of two bits may correspond to 1, codepoint ‘01′ may correspond to 2, codepoint ‘10’ may correspond to 4, and codepoint ‘11′ may correspond to 4. In this regard, a value of 4 reported by the UE may mean that a maximum number of SRS ports of the UE is 4. For example, the UE that supports 4 transmission antennas may not support a value of 3 in a UE capability report on UE capability value reporting, and that the value of 3 is not supported in the UE capability report on UE capability value reporting may mean that the UE does not perform SRS transmission represented by 3 antenna ports.

According to an embodiment of the disclosure, in a case in which the UE has up to 8 transmission antennas, the UE may also report a combination of one or more of 5, 6, 7, and 8, in addition to 1, 2, 3, and 4 in UE capability value reporting, and if a candidate value is greater than 4, a capability index value reported by the UE may be represented using 3 bits.

According to an embodiment of the disclosure, the UE may report to the BS a reduced number of MIMO layer which is preferred by the UE to address an overheating issue or reduce UE-power consumption, by reducedMIMO-LayersFR1-DL, reducedMIMO-LayersFR1-UL, reducedMIMO-LayersFR2-DL, reducedMIMO-LayersFR2-UL, reducedMIMO-LayersFR2—2—DL, or reducedMIMO-LayersFR2—2-UL in UEAssistanceInformation that is higher layer signaling transmittable by the UE. If the UE has 3 transmission antennas, the UE may report, to the BS, one natural number value among 1 to 3 with respect to reducedMIMO-LayersFR1-UL, reducedMIMO-LayersFR2-UL, or reducedMIMO-LayersFR2—2-UL. When the UE has 3 transmission antennas, the BS may not expect that the UE reports, to the BS, a value of 4 by reducedMIMO-LayersFR1-UL, reducedMIMO-LayersFR2-UL, or reducedMIMO-LayersFR2—2-UL. If the UE has 8 transmission antennas, the UE may report, to the BS, one natural number value among 1 to 8 with respect to reducedMIMO-LayersFR1-UL, reducedMIMO-LayersFR2-UL, or reducedMIMO-LayersFR2—2-UL.

According to an embodiment of the disclosure, the UE may expect that a combination of at least one of Method 3-1 or Method 3-2 above is notified from the BS by a combination of at least one of higher layer signaling, MAC-CE signaling or L1 signaling, or a combination of at least one of Method 3-1 or Method 3-2 above is fixedly defined in the standard. Additionally, when the UE is notified of a particular combination of one or more methods from the BS by the combination of at least one of higher layer signaling, MAC-CE signaling or L1 signaling, it may mean that the UE is unable to support the other combinations of the methods. For example, the UE may expect that the Method 3-1 is fixedly defined in the standard, and the UE may assume the use of the Method 3-1 for UE capability value reporting. In another example, the UE may be notified of the Method 3-2 from the BS by a combination of at least one of higher layer signaling, MAC-CE signaling or L1 signaling, in which case it may be regarded that the UE has been notified from the BS that the Method 3—i is not supported. [00412 According to an embodiment of the disclosure, the UE may report, in the UE capability to the BS, whether the UE is able to support a combination of at least one of Method 3-1 or Method 3-2 above. Here, when the UE reports to the BS that the UE is able to support a particular combination of one or more methods in the UE capability, it may be regarded that the UE also reports that the UE is unable to support the other combinations. For example, the UE may report to the BS whether the UE is able to support Method 3-1 above. As another example, the UE may report to the BS that the UE is able to support Method 3-2 above, and this UE capability report may indicate that the UE is unable to support Method 3-1.

### Fourth Embodiment: Method of Transmitting PTRS for UE Supporting 3 Transmission Antennas

Hereinafter, according to an embodiment of the disclosure, methods by which the UE being able to transmit a UL signal via 3 transmission antennas transmits a PTRS will now be described in detail.

The UE transmits a UL signal via 3 transmission antennas, and before a DCI field for indicating a DMRS associated with a PTRS transmitted in the UL signal transmitted by the UE is defined, a rule for a DMRS port that may be associated with each PTRS port is first defined. The UL signal via the 3 transmission antennas may be transmitted together with one or two PTRS ports. If codebook based PUSCH transmission is supported, a pre-rule for each PTRS port may be defined to associate a layer transmitted via a particular PUSCH antenna port with a certain PTRS port, or a PTRS port may be associated with any layer without a separate rule. For example, if only one PTRS port is configured (e.g., a case in which maxNrofPorts in PTRS-UplinkConfig is configured as ‘n1′), one PTRS port may be associated with one of certain layers, and there is no need to consider a condition for whether a layer is transmitted via a particular PUSCH antenna port. If the number of scheduled (or schedulable) layers of a PUSCH is greater than 1, the UE may associate a DMRS port (layer) indicated by a particular DCI field (e.g., PTRS-DMRS association field, PTRS-DMRS association field) included in DCI with a PTRS port, and may transmit a PTRS. If it is configured in such a manner that two PTRS ports are usable (e.g., a case in which maxNrofPorts in PTRS-UplinkConfig is configured as ‘n2′), a DMRS port that may be associated with a PTRS port of a PUSCH transmitted based on codebook may be determined by using methods below.

Method 1—A layer (DMRS port) transmitted via a particular PUSCH antenna port may be associated with a UL PTRS port. For example, PTRS port 0 may be associated with a layer (or DMRS port) transmitted via PUSCH antenna port 1000 and/or PUSCH antenna port 1002, and PTRS port 1 may be associated with a layer (or DMRS port) transmitted via PUSCH antenna port 1001 and/or PUSCH antenna port 1003. If the UE that supports 3 transmission antennas does not support PUSCH antenna port 1003 (or any one port among PUSCH antenna port 1000 to PUSCH antenna port 1003), PTRS port 1 may be associated with a layer (or DMRS port) transmitted via PUSCH antenna port 1001. A particular example for describing Method 1 is merely an example, and PTRS port 0 may be associated with a layer (or DMRS port) transmitted via PUSCH antenna port 1001, and PTRS port 1 may be associated with a layer (or DMRS port) transmitted via PUSCH antenna port 1000 and/or PUSCH antenna port 1002. Alternatively, an association relation between a PTRS port and a layer transmitted via a PUSCH antenna port may be defined based on a different combination, and then, PUSCH and PTRS may be transmitted.

Method 2—A UL PTRS port may be associated with a layer (or DMRS port) transmitted via a certain PUSCH antenna port. In Method 2, a PTRS port may be associated with a certain layer (or DMRS port) without limitation, and the UE may determine a DMRS port associated with a PTRS port transmitted together with a scheduled PUSCH according to a PTRS-DMRS association field indicated by scheduling DCI. Alternatively, in a case of configured grant PUSCH, a PTRS-DRM S association relation indicated according to a defined rule may be determined (e.g., when configured grant type 1 PUSCH is scheduled, the UE may regard a PTRS-DMRS association field as ‘0‘ or ‘00’, and may determine a DMRS port associated with a transmitted PTRS port.

The UE may determine a DMRS port associated with a PTRS port transmitted with a scheduled codebook based PUSCH, based on one of Method 1 or Method 2. Hereinafter, in an embodiment of the disclosure, for convenience of descriptions, it is assumed that a DMRS port associated with a PTRS port transmitted together in transmission of a codebook based PUSCH is determined.

If the UE that supports 3 transmission antennas supports non-codebook based PUSCH transmission, ptrs-PortIndex may be configured as n0 or n1 in higher layer configuration of an SRS resource in an SRS resource set in which ‘usage’ is set to ‘nonCodebook’. If only one UL PTRS port is supported, a higher layer parameter of ptrs-PortIndex may be configured as n0 (or n1). If two UL PTRS ports are supported, a higher layer parameter of ptrs-PortIndex may be configured as n0 or n1.

Next, a method of determining a layer (or DMRS port) associated with a PTRS port among up to three layers (or DMRS ports) according to the number of supported UL PTRS ports, when the UE that supports 3 transmission antennas supports one or two UL PTRS ports, will now be described in detail.

If the UE that supports 3 transmission antennas supports two UL PTRS ports, the number of required bits for each number of PUSCH layers for determining a layer (or DMRS port) associated with a PTRS port may be as below.
If the number of layers of a scheduled codebook based PUSCH is 1: the UE associates a PTRS port associated with one PUSCH layer with corresponding one layer and transmits the PTRS port. For example, when one PUSCH layer is transmitted via PUSCH antenna port 1000 and/or PUSCH antenna port 1002, PTRS port 0 may be transmitted by being associated with a corresponding PUSCH layer (or DMRS port with respect to corresponding PUSCH transmission). Here, according to a port index of a DMRS port indicated with respect to the corresponding PUSCH layer and an RRC parameter (e.g., resourceElementOffset) configured by a higher layer, an index

$${k}_{ref}^{RE}$$

of a subcarrier in an resource block (RB) on which the PTRS port is transmitted is determined. If one PUSCH layer is transmitted via PUSCH antenna port 1001, PTRS port 1 may be transmitted by being associated with a corresponding PUSCH layer (or DMRS port with respect to corresponding PUSCH transmission). Here, according to a port index of a DMRS port indicated with respect to the corresponding PUSCH layer and an RRC parameter (e.g., resourceElementOffset) configured by a higher layer, an index

$${k}_{ref}^{RE}$$

of a subcarrier in an RB on which the PTRS port is transmitted is determined.

If the number of layers of a scheduled non-codebook based PUSCH is 1: the UE associates a PTRS port associated with one PUSCH layer with corresponding one layer and transmits the PTRS port. For example, when one PUSCH layer is transmitted based on an SRS resource in which a higher layer parameter of ptrs-PortIndex is configured as n0 (i.e., when a PUSCH is scheduled by indicating the corresponding SRS resource by an SRI field in DCI or a higher layer parameter of srs-Resourcelndicator), PTRS port 0 may be transmitted by being associated with the corresponding PUSCH layer (or DMRS port with respect to the corresponding PUSCH transmission). Here, according to a port index of a DMRS port indicated with respect to the corresponding PUSCH layer and an RRC parameter (e.g., resourceElementOffset) configured by a higher layer, an index

$${k}_{ref}^{RE}$$

of a subcarrier in an RB on which the PTRS port is transmitted is determined. If one PUSCH layer is transmitted based on an SRS resource in which a higher layer parameter of ptrs-PortIndex is configured as n1 (i.e., when a PUSCH is scheduled by indicating the corresponding SRS resource by an SRI field in DCI or a higher layer parameter of srs-Resourcelndicator), PTRS port 1 may be transmitted by being associated with the corresponding PUSCH layer (or DMRS port with respect to the corresponding PUSCH transmission). Here, according to a port index of a DMRS port indicated with respect to the corresponding PUSCH layer and an RRC parameter (e.g., resourceElementOffset) configured by a higher layer, an index

$${k}_{ref}^{RE}$$

of a subcarrier in an RB on which the PTRS port is transmitted is determined.
If the number of layers of a scheduled codebook based PUSCH is 2: the UE determines PTRS ports associated with two layers according to the number of actual PTRS ports according to a TPMI (or precoder configured by a higher layer parameter of precodingAndNumberOfLayers) to be applied to the scheduled PUSCH, associates one PTRS port with one of the two layers and transmits the PTRS port (a case in which the number of actual PTRS ports is 1) or respectively associates two PTRS ports with the two layers and transmits the two PTRS ports (a case in which the number of actual PTRS ports is 2). In a particular example, if precoder indicates that a PUSCH of the two layers is transmitted via PUSCH antenna port 1000 or PUSCH antenna port 1002, the UE determines the number of actual PTRS ports as 1, and transmits only PTRS port 0 with the scheduled PUSCH. Here, in order to determine a layer (or DMRS port) associated with PTRS port 0 among the scheduled two layers, the UE may refer to MSB 1 bit of a PTRS-DMRS association field included in DCI for scheduling a PUSCH or may regard the PTRS-DMRS association field as ‘00’ in a case of a configured grant based PUSCH. In this regard, the UE may ignore LSB 1 bit of the PTRS-DMRS association field included in the DCI for scheduling a PUSCH. In another particular example, if precoder indicates that a PUSCH of the two layers is transmitted via PUSCH antenna port 1003, the UE determines the number of actual PTRS ports as 1, and transmits only PTRS port 1 with the scheduled PUSCH. Here, in order to determine a layer (or DMRS port) associated with PTRS port 1 among the scheduled two layers, the UE may refer to LSB 1 bit of a PTRS-DMRS association field included in DCI for scheduling a PUSCH or may regard the PTRS-DMRS association field as ‘00’ in a case of a configured grant based PUSCH. In this regard, the UE may ignore MSB 1 bit of the PTRS-DMRS association field included in the DCI for scheduling a PUSCH. In another particular example, if precoder indicates that one layer is transmitted via PUSCH antenna port 1000 and/or PUSCH antenna port 1002 and the other layer is transmitted via PUSCH antenna port 1001, the UE determines the number of actual PT RS ports as 2, associates PTRS port 0 with the layer (or DMRS port) transmitted via PUSCH antenna port 1000 and/or PUSCH antenna port 1002 and transmits the PTRS port 0, and associates PTRS port 1 with the layer (or DMRS port) transmitted via PUSCH antenna port 1001 and transmits the PTRS port 1. Here, the UE may ignore all two bits of a PTRS-DMRS association field included in DCI for scheduling a PUSCH or may expect that the BS configures the PTRS-DMRS association as ‘00’.
If the number of layers of a scheduled non-codebook based PUSCH is 2: the UE determines PTRS ports associated with two layers according to the number of actual PTRS ports according to an SRI (or a higher layer parameter of srs-Resourcelndicator) to be applied to a scheduled PUSCH, associates one PTRS port with one of the two layers and transmits the PTRS port (a case in which the number of actual PTRS ports is 1) or respectively associates two PTRS ports with the two layers and transmits the two PTRS ports (a case in which the number of actual PTRS ports is 2). In a particular example, if the SRI indicates that a PUSCH of the two layers is transmitted on two SRS resources in which a higher layer parameter of ptrs-PortIndex is configured as n0, the UE determines the number of actual PTRS ports as 1, and transmits only PTRS port 0 with the scheduled PUSCH. Here, in order to determine a layer (or DMRS port) associated with PTRS port 0 among the scheduled two layers, the UE may refer to MSB 1 bit of a PTRS-DMRS association field included in DCI for scheduling a PUSCH or may regard the PTRS-DMRS association field as ‘00’ in a case of a configured grant based PUSCH. In this regard, the UE may ignore L SB 1 bit of the PTRS-DMRS association field included in the DCI for scheduling a PUSCH. In another particular example, if the SRI indicates that a PUSCH of the two layers is transmitted on two SRS resources in which a higher layer parameter of ptrs-PortIndex is configured as n1, the UE determines the number of actual PTRS ports as 1, and transmits only PTRS port 1 with the scheduled PUSCH. Here, in order to determine a layer (or DMRS port) associated with PTRS port 1 among the scheduled two layers, the UE may refer to LSB 1 bit of a PTRS-DMRS association field included in DCI for scheduling a PUSCH or may regard the PTRS-DMRS association field as ‘00’ in a case of a configured grant based PUSCH. In this regard, the UE may ignore MSB 1 bit of the PTRS-DMRS association field included in the DCI for scheduling a PUSCH. In another particular example, if the SRI indicates one SRS resource in which a higher layer parameter of ptrs-PortIndex is configured as n0 and one SRS resource in which a higher layer parameter of ptrs-PortIndex is configured as n1, the UE determines the number of actual PTRS ports as 2, associates PTRS port 0 with a layer transmitted according to the SRS resource in which ptrs-PortIndex is configured as n0 and transmits the PTRS port 0, and associates PTRS port 1 with a layer transmitted according to the SRS resource in which ptrs-PortIndex is configured as n1 and transmits the PTRS port 1. Here, the UE may ignore all two bits of a PTRS-DMRS association field included in DCI for scheduling a PUSCH or may expect that the BS configures the PTRS-DMRS association as ‘00’.
If the number of layers of a scheduled codebook based PUSCH is 3: the UE may determine the number of actual PTRS ports as 2 according to a TPMI (or precoder configured by a higher layer parameter of precodingAndNumberOfLayers) to be applied to a scheduled PUSCH, and may identify that one PTRS port among the two PTRS ports may be associated with two layers and the other PTRS port may be associated with one layer. In order to determine a layer (or DMRS port) associated with PTRS port that may be associated with the two layers, the UE may refer to a PTRS-DMRS association field included in scheduling DCIH or may regard the PTRS-DMRS association field as ‘00’ in a case of a configured grant based PUSCH. In a particular example, if precoder indicates that the two layers are transmitted via PUSCH antenna port 1000 or PUSCH antenna port 1002 and one layer is transmitted via PUSCH antenna port 1001, the UE may determine the number of actual PTRS ports as 2, may associate PTRS port 0 with one of the two layers transmitted via PUSCH antenna port 1000 or PUSCH antenna port 1002 and transmit the PTRS port 0, and may associate PTRS port 1 with one layer transmitted via PUSCH antenna port 1001 and transmit the PTRS port 1. Here, in order to determine a layer (or DMRS port) associated with PTRS port 0 among the two layers, the UE may refer to MSB 1 bit of a PTRS-DMRS association field included in DCI for scheduling a PUSCH or may regard the PTRS-DMRS association field as ‘00’ in a case of a configured grant based PUSCH. In this regard, the UE may ignore LSB 1 bit of the PTRS-DMRS association field included in the DCI for scheduling a PUSCH. In another particular example, if precoder indicates that one layer is transmitted via PUSCH antenna port 1000 or PUSCH antenna port 1002 and the two layers are transmitted via PUSCH antenna port 1001, the UE may determine the number of actual PTRS ports as 2, may associate PTRS port 0 with one layer transmitted via PUSCH antenna port 1000 or PUSCH antenna port 1002 and transmit the PTRS port 0, and may associate PTRS port 1 with one of the two layers transmitted via PUSCH antenna port 1001 and transmit the PTRS port 1. Here, in order to determine a layer (or DMRS port) associated with PTRS port 1 among the two layers, the UE may refer to LSB 1 bit of a PTRS-DMRS association field included in DCI for scheduling a PUSCH or may regard the PTRS-DMRS association field as ‘00’ in a case of a configured grant based PUSCH. In this regard, the UE may ignore MSB 1 bit of the PTRS-DMRS association field included in the DCI for scheduling a PUSCH.
If the number of layers of a scheduled non-codebook based PUSCH is 3: the UE may determine the number of actual PTRS ports as 2 according to an SRI to be applied to a scheduled PUSCH, and may identify that one PTRS port among the two PTRS ports may be associated with two layers and the other PTRS port may be associated with one layer. In order to determine a layer (or DMRS port) associated with PTRS port that may be associated with the two layers, the UE may refer to a PTRS-DMRS association field included in scheduling DCIH or may regard the PTRS-DMRS association field as ‘00’ in a case of a configured grant based PUSCH. In a particular example, if the SRI indicates that two layers are transmitted on two SRS resources in which a higher layer parameter of ptrs-PortIndex is configured as n0, and one layer is transmitted on one SRS resource in which a higher layer parameter of ptrs-PortIndex is configured as n1, the UE may determine the number of actual PTRS ports as 2, may associate PTRS port 0 with one of the two layers transmitted on the two SRS resources in which ptrs-PortIndex is configured as n0 and transmit the PTRS port 0, and may transmit PTRS port 1 with one layer transmitted on the one SRS resource in which ptrs-PortIndex is configured as n1 and may transmit the PTRS port 1. Here, in order to determine a layer (or DMRS port) associated with PTRS port 0 among the two layers, the UE may refer to MSB 1 bit of a PTRS-DMRS association field included in DCI for scheduling a PUSCH or may regard the PTRS-DMRS association field as ‘00’ in a case of a configured grant based PUSCH. In this regard, the UE may ignore L SB 1 bit of the PTRS-DMRS association field included in the DCI for scheduling a PUSCH. In another particular example, if the SRI indicates that one layer is transmitted on one SRS resource in which a higher layer parameter of ptrs-PortIndex is configured as n0, and two layers are transmitted on two SRS resources in which a higher layer parameter of ptrs-PortIndex is configured as n1, the UE may determine the number of actual PTRS ports as 2, may associate PTRS port 0 with one layer transmitted on the SRS resource in which ptrs-PortIndex is configured as n0 and transmit the PTRS port 0, and may transmit PTRS port 1 with one of the two layers transmitted on the two SRS resources in which ptrs-PortIndex is configured as n1 and may transmit the PTRS port 1. Here, in order to determine a layer (or DMRS port) associated with PTRS port 1 among the two layers, the UE may refer to LSB 1 bit of a PTRS-DMRS association field included in DCI for scheduling a PUSCH or may regard the PTRS-DMRS association field as ‘00’ in a case of a configured grant based PUSCH. In this regard, the UE may ignore MSB 1 bitofthePTRS-DMRS association field included in the DCI for scheduling a PUSCH.

With respect to the six cases described above, the UE may identify that a maximum of one DCI bit is only requested to determine a layer (or DMRS port) associated with a UL PTRS. For example, when two UL PTRS ports are supported for the UE that supports 3 transmission antennas, the UE may identify that the UE may skip other ignorable bits except for one bit necessary to determine a DMRS port associated with a PTRS port.

If it is possible to indicate a DMRS port associated with a PTRS by a 1—bit PTRS-DMRS association field even fora case where one UL PTRS port is supported for the UE that supports 3 transmission antennas, the BS and the UE may configure a 1-bit PTRS-DMRS association field in DCI for a case of supporting 3 UE transmission antennas. For example, when a higher layer parameter for supporting 3 UE transmission antennas is configured, a bit size of the PTRS-DMRS association field in the DCI may be configured to be 1. In order to use the 1-bit PTRS-DMRS association field, a method of determining one layer among a plurality of layers, the one layer being associated with a PTRS port (or DMRS port), when one UL PTRS port is supported for the UE that supports 3 transmission antennas, will now be described below.

If a separate additional method for determining a DMRS associated with a PTRS is not considered, and one UL PTRS port is supported for the UE that supports 3 transmission antennas, the number of required bits for each number of PUSCH layers for determining a layer (or DMRS port) associated with a PTRS port may be as below.
If the number of layers of a scheduled PUSCH is 1: the UE associates one UL PTRS port with one PUSCH layer (or DMRS port), and transmits the one UL PTRS port, regardless of whether a PTRS-DMRS association field is indicated. In this regard, the UE may ignore a 2-bit PTRS-DMRS association field.
If the number of layers of a scheduled PUSCH is 2: the UE refers to a PTRS-DMRS association field, associates one PT RS port with one of two layers and transmits the one PTRS port. In this regard, in order to select one layer among the two layers, two codepoints among four codepoints that may be indicated by a 2-bit PTRS-DMRS association field may be used. For example, the remaining two codepoints may be reserved, and this may be interpreted that only 1 bit in the 2-bit PTRS-DMRS association field is required.
If the number of layers of a scheduled PUSCH is 3: the UE refers to a PTRS-DMRS association field, associates one PTRS port with one of three layers and transmits the one PTRS port. In this regard, in order to select one layer among the three layers, three codepoints among four codepoints that may be indicated by a 2-bit PTRS-DMRS association field may be used. For example, the remaining one codepoint may be reserved, and this may be interpreted that 2 bits in the 2-bit PTRS-DMRS association field are all required.

For example, as described in the aforementioned example, when a separate additional method for determining a DMRS associated with a PTRS is not considered, a 2-bit indication field is required to select one layer to be associated with one UL PTRS port, based on the number of all layers schedulable for the UE that supports 3 transmission antennas. For example, as described above, when two UL PTRS ports are supported for the UE that supports 3 transmission antennas, only 1 bit is required to determine a DMRS port associated with a PTRS port, whereas 2 bits may be required to determine a DMRS port associated with a PTRS port for a case in which one UL PTRS port is supported for the UE that supports 3 transmission antennas. If it is possible to indicate a DMRS port associated with a PTRS port by using only bit equal to or less than l for a case where one UL PTRS port is supported for the UE that supports 3 transmission antennas, the number of bits in a PTRS-DMRS association field included in DCI for scheduling a PUSCH may be decreased from 2 bits to 1 bit. Alternatively, when 2 bits for a PTRS-DMRS association field are configured, 1 bit may be configured in the PTRS-DMRS association field, and a reserved bit in other field in DCI may be used as the other 1 bit, such that 2 bits may be configured.

A DCI field below may be considered as other field that may include the reserved bit in the DCI which may be used to decrease the number of bits in a PTRS-DMRS association area, based on the characteristic above:
‘Antenna ports' field (indicating a field included in DCI format 0_1 or DCI format 0_2) is a field for indicating a DMRS port of a scheduled PUSCH. A bit size of the ‘antenna ports' field may be determined according to a DMRS type (configured by a higher layer parameter of dmrs-Type, a DMRS symbol length (configured by a higher layer parameter of maxLength), and whether an enhanced DMRS type is configured (configured by a higher layer parameter of enhanced-dmrs-Type). When a transform precoder is not configured, a PUSCH of a 1^{st} to maxRank (when codebook based PUSCH transmission is supported) or 1^{st} to maxMIMO-Layer (when non-codebook based PUSCH transmission is supported) may be scheduled, and the UE may receive DMRS port information indicated by the antenna port field, based on a rank (or layer) of the scheduled PUSCH and a table according to the DMRS configuration (the DMRS type, the DMRS symbol length, etc.). In this regard, as the number of bits of the antenna port field is determined by considering a total number of layers that may be scheduled to the UE, only some bits (or codepoints) may be used for the antenna port field for indicating a DMRS port for a PUSCH scheduled for a particular layer, and remaining bits (or codepoints) may be reserved. For example, when the transform precoder is not usable (disabled), dmrs-Type is 1, enhanced-dmrs-Type is not configured, and maxLength is configured as 1, the number of bits of the antenna port field in DCI format 0_1 (or, 0_2, while DCI format 0_1 is described for convenience of descriptions, this may be equally applied to a PUSCH scheduled by DCI format 0_2) may be determined as 3. If DCI format 0_1 received by the UE schedules rank 1 (rank1 or layer 1) PUSCH, 6 codepoints in a 3-bit antenna port field may be used to indicate a DMRS port, and 2 codepoints may be reserved. Alternatively, if DCI format 0_1 received by the UE schedules rank 2 (rank2 or layer 2) PUSCH, 4 codepoints in a 3-bit antenna port field may be used to indicate a DMRS port, and 4 codepoints may be reserved. Alternatively, if DCI format 0_1 received by the UE schedules rank 3 (rank3 or layer 3) PUSCH, 1 codepoint in a 3-bit antenna port field may be used to indicate a DMRS port, and 7 codepoints may be reserved. As described in the example of a PUSCH scheduled for the three different ranks, the number of codepoints to be reserved may vary according to the number of ranks of a scheduled PUSCH with respect to the antenna port field.

As such, one UL PTRS port may be supported for the UE that supports 3 transmission antennas, and in order to use a reserved bit or codepoint in the antenna port field so as to indicate a DMRS port associated with one UL PTRS port, options below may be used.

Option 1—A DMRS port associated with one PTRS port may be determined by combining a 1-bit PTRS-DMRS association field and new codepoint indicated by the antenna port field.

The DMRS port that is scheduled by the antenna port field, and in addition, the PTRS-DMRS association field may indicate candidate layers to be applied. For example, a plurality of codepoints may be configured for the antenna port field to equally/uniformly indicate a certain DMRS CDM group and a certain DMRS port and a certain front-load symbol number, the antenna port field being for indicating a DMRS port of a PUSCH scheduled for a certain rank. When one codepoint for indicating the same DMRS port among a plurality of codepoints is indicated by the antenna port field, the UE may identify candidates of a DMRS port to be associated with a PTRS port as some DMRS ports (e.g., one DMRS port or two DMRS ports among a total of three DMRS ports) of all DMRS ports. Afterward, the UE may determine and associate one DMRS port with a PTRS port, the one DMRS port being among some DMRS ports (e.g., two DMRS ports) identified by referring to a PTRS-DMRS association field configured with a certain number of bits (e.g., 1 bit less than 2 bits).

For example, a table may be configured as below, in which DMRS ports indicated by an antenna port field are defined. Table 35 indicates a table for determining a DMRS port for a case in which a 4-bit antenna port field in which the transform precoder is configured to be disable, dmrs-Type is configured as 1, enhanced-dmrs-Type is not configured, and maxLength is configured as 2 is indicated by DCI, and a rank of a PUSCH scheduled by the same DCI including the antenna port field is 3.

TABLE 35

| | Number of | | | PUSCH antenna |
|---|---|---|---|---|
| | DMRS CDM | | Number of | port group |
| | group(s) | DMRS | front-load | associated |
| Value | without data | port(s) | symbols | with PTRS |
| 0 | 2 | 0-2 | 1 | 1 |
| 1 | 2 | 0, 1, 4 | 2 | 1 |
| 2 | 2 | 2, 3, 6 | 2 | 1 |
| 3 | 2 | 0-2 | 1 | 2 |
| 4 | 2 | 0, 1, 4 | 2 | 2 |
| 5 | 2 | 2, 3, 6 | 2 | 2 |
| 6-15 | Reserved | Reserved | Reserved | Reserved |

Codepoint for indicating that a DMRS CDM group without data is 2, DMRS ports 0 to 2, and the number of front-load symbols is 1 may be defined as 0 and 3. For example, when the antenna port field indicates codepoint 0 or codepoint 3, the UE may configure a DMRS port of a PUSCH scheduled by DCI including the antenna port field as DMRS ports 0 to 2 according to the two DMRS CDM groups with 1—symbol front-load DMRS. Here, if the antenna port field indicates codepoint 0, and the UE transmits codebook based PUSCH and supports one UL PTRS port, it may be understood that the UE associates the one UL PTRS port with a DMRS port (or layer) transmitted via PUSCH antenna port 1000 and/or PUSCH antenna port 1002, and transmits the one UL PTRS port. If codebook based PUSCH transmission is supported, PUSCH antenna port group 1 associated with PTRS of Table 35 may be defined as a PUSCH antenna port group including PUSCH antenna port 1000 and/or PUSCH antenna port 1002. Alternatively, a separate PUSCH antenna port group is not defined as a table but may be implicitly determined according to a certain rule pre-defined between the BS and the UE. When two layers of a scheduled PUSCH are transmitted via PUSCH antenna port 1000 and/or PUSCH antenna port 1002, the UE may select one DMRS port by referring to a 1-bit PTRS-DMRS association field. If the antenna port field indicates codepoint 3, and the UE transmits codebook based PUSCH and supports one UL PTRS port, it may be understood that the UE associates and transmits the one UL PTRS port with a DMRS port (or layer) transmitted via PUSCH antenna port 1001. PUSCH antenna port group 2 associated with PTRS of Table 35 may be defined as PUSCH antenna port 1001. Alternatively, a separate PUSCH antenna port group is not defined as a table but may be implicitly determined according to a certain rule pre-defined between the BS and the UE. When a scheduled PUSCH is transmitted via PUSCH antenna port 1001, the UE may select one DMRS port by referring to or ignoring a 1-bit PTRS-DMRS association field.

If non-codebook based PUSCH transmission is supported, PUSCH antenna port group 1 associated with PTRS of Table 35 may be defined as a layer (or DMRS port) transmitted according to an SRS resource in which a value of a new parameter (e.g., it may be PUSCH PortGroup or a certain parameter that performs the same function as PUSCHPortGroup) in the SRS resource that is a higher layer parameter is configured as ‘1′. Alternatively, a separate PUSCH antenna port group may not be defined with the new parameter (e.g., PUSCH PortGroup) but may be implicitly determined according to a certain rule (e.g., DMRS port transmitted according to first N SRS resources among a plurality of SRS resources configured in SRS resource set) pre-defined between the BS and the UE. Similarly, if non-codebook based PUSCH transmission is supported, PUSCH antenna port group 2 associated with PTRS of Table 35 may be defined as a layer (or DMRS port) transmitted according to an SRS resource in which a value of a new parameter (e.g., it may be PUSCHPortGroup or a certain parameter that performs the same function as PUSCHPortGroup) in the SRS resource that is a higher layer parameter is configured as ‘2′. Alternatively, a separate PUSCH antenna port group may not be defined with the new parameter (e.g., PUSCH PortGroup) but may be implicitly determined according to a certain rule (e.g., DMRS port transmitted according to last N or N+1 or M (where M indicates the number of all SRS resources in an SRS resource set in which ‘usage’ is set to ‘nonCodebook’ SRS resources among a plurality of SRS resources configured in SRS resource set) pre-defined between the BS and the UE.

Table 35 is merely an example of a high layer parameter described above, and codepoints may be configured to indicate the same DMRS port and a different PUSCH antenna port group associated with a PTRS with respect to other high layer parameter configuration.

If codepoint for this configuration is insufficient, codepoints for indicating some DMRS ports may be defined as a plurality of codepoints for indicating different PUSCH antenna port groups. According to descriptions based on the example of Table 35, only DMRS ports 0 to 2 with the number of DMRS CDM groups without data being 2 and the number of front-load symbols being 1 may be indicated by two different codepoint 0 and codepoint 3, and other DMRS port (e.g., DMRS port indicated by codepoint 1 and codepoint 2) may be indicated by only one codepoint.

Option 2—A DMRS port associated with one PTRS port may be determined by using only an antenna port field without a PTRS-DMRS association field. The DMRS port associated with a PTRS port may be determined by referring to only codepoint indicated by the antenna port field.

The DMRS port of a scheduled PUSCH may be indicated by the antenna port field, and in addition, the DMRS port associated with a PTRS may also be indicated. For example, a plurality of codepoints may be configured for the antenna port field to equally/uniformly indicate a certain DMRS CDM group and a certain DMRS port and a certain front-load symbol number, the antenna port field being for indicating a DMRS port of a PUSCH scheduled for a certain rank. When one codepoint for indicating the same DMRS port among a plurality of codepoints is indicated by the antenna port field, the UE may identify candidates of a DMRS port to be associated with a PTRS port as one DMRS port (e.g., one DMRS port among a total of three DMRS ports) of all DMRS ports. Afterward, the UE may not receive a separate PT RS-D M IRS association field and may associate one DMRS port with a PTRS port.

For example, a table maybe configured as below, in which DMRS ports indicated by an antenna port field are defined. Table 36 indicates a table for determining a DMRS port for a case in which a 5-bit antenna port field in which the transform precoder is configured to be disable, dmrs-Type is configured as 2, enhanced-dmrs-Type is not configured, and maxLength is configured as 2 is indicated by DCI, and a rank of a PUSCH scheduled by the same DCI including the antenna port field is 3.

TABLE 36

| | Number of | | | |
|---|---|---|---|---|
| | DMRS CDM | | Number of | DMRS port |
| | group(s) | DMRS | front-load | associated |
| Value | without data | port(s) | symbols | with PTRS |
| 0 | 2 | 0-2 | 1 | 1^{st} |
| 1 | 3 | 0-2 | 1 | 1^{st} |
| 2 | 3 | 3-5 | 1 | 1^{st} |
| 3 | 3 | 0, 1, 6 | 2 | 1^{st} |
| 4 | 3 | 2, 3, 8 | 2 | 1^{st} |
| 5 | 3 | 4, 5, 10 | 2 | 1^{st} |
| 6 | 2 | 0-2 | 1 | 2^{nd} |
| 7 | 3 | 0-2 | 1 | 2^{nd} |
| 8 | 3 | 3-5 | 1 | 2^{nd} |
| 9 | 3 | 0, 1, 6 | 2 | 2^{nd} |
| 10 | 3 | 2, 3, 8 | 2 | 2^{nd} |
| 11 | 3 | 4, 5, 10 | 2 | 2^{nd} |
| 12 | 2 | 0-2 | 1 | 3^{rd} |
| 13 | 3 | 0-2 | 1 | 3^{rd} |
| 14 | 3 | 3-5 | 1 | 3^{rd} |
| 15 | 3 | 0, 1, 6 | 2 | 3^{rd} |
| 16 | 3 | 2, 3, 8 | 2 | 3^{rd} |
| 17 | 3 | 4, 5, 10 | 2 | 3^{rd} |
| 18-31 | Reserved | Reserved | Reserved | Reserved |

Codepoint for indicating that a DMRS CDM group without data is 3, DMRS port 4 and DMRS port 5 and DMRS port 10, and the number of front-load symbols is 2 may be defined as 5 and 11 and 17. For example, when the antenna port field indicates codepoint 5 or codepoint 11 or codepoint 17, the UE may configure a DMRS port of a PUSCH scheduled by DCI including the antenna port field as DMRS port 4 and DMRS port 5 and DMRS port 10 according to the three DMRS CDM groups with 2—symbol front-load DMRS. In this regard, if the antenna port field indicates codepoint 5, the UE may associate one UL PTRS port with first DMRS port 4 and transmit the one UL PTRS port. Alternatively, if the antenna port field indicates codepoint 5, the UE may associate one UL PTRS port with a DMRS port (or layer) transmitted via PUSCH antenna port 1000 and may transmit the one UL PTRS port. If the antenna port field indicates codepoint 11, the UE may associate one UL PTRS port with second DMRS port 5 and may transmit the one UL PTRS port. Alternatively, if the antenna port field indicates codepoint 11, the UE may associate one UL PTRS port with a DMRS port (or layer) transmitted via PUSCH antenna port 1001 and may transmit the one UL PTRS port. If the antenna port field indicates codepoint 17, the UE may associate one UL PTRS port with second DMRS port 10 and may transmit the one UL PTRS port. Alternatively, if the antenna port field indicates codepoint 17, the UE may associate one UL PTRS port with a DMRS port (or layer) transmitted via PUSCH antenna port 1002 and may transmit the one UL PTRS port. Table 36 is merely an example of a high layer parameter described above, and codepoints may be configured to indicate the same DMRS port and a different PUSCH antenna port group associated with a PTRS with respect to other high layer parameter configuration. If codepoint for this configuration is insufficient, codepoints for indicating some DMRS ports may be defined as a plurality of codepoints for indicating different PUSCH antenna port groups.

Option 2 may be used not only in a case of supporting one PTRS port but may also be used in determining a DMRS port associated with one PTRS port that may be associated with a plurality of DMRS ports in a case of supporting two PTRS ports.

The UE may identify that one PTRS port among two PTRS ports may be associated with two layers and the other PTRS port may be associated with one layer. In order to determine a layer (or DMRS port) associated with a PTRS port that may be associated with two layers, the UE may refer to a Table for DMRS port indication which may be configured as Option 2.

In a particular example, it is assumed that a DMRS port is determined according to Table 36 as described above, and when a precoder applied to scheduled codebook based PUSCH is indicated as

$$\frac{1}{\sqrt{3}} [ \begin{matrix}1 & 0 & 0 \\ 0 & 1 & 0 \\ 0 & 0 & 1\end{matrix} ] ,$$

as defined in Table 34, a first layer and a third layer may be associated w ith PTRS port 0 according to Method 1 described above regarding PTRS port that may be associated according to PUSCH antenna port, and a second layer may be associated with PTRS port 1 according to Method 1. In this regard, as PTRS port 1 is transmitted by being associated with the second layer, there is no need to indicate separate PTRS-DMRS association. However, PTRS port 0 has to be transmitted by being associated with one of the first layer or the third layer, Table 36 may be referred to indicate an association relation. For example, when an antenna port field in the same DCI that schedules a PUSCH indicates codepoint 3, it may indicate that a DMRS CDM group without data is 3, DMRS port 0 and DMRS port 1 and DMRS port 6, and the number of front-load symbols is 2, and PTRS port 0 may be transmitted by being associated with the first layer among the first layer and the third layer. This is because the first layer is the first one among two layer that may be associated with PTRS port 0. If an antenna port field in the same DCI that schedules a PUSCH indicates codepoint 9, it may indicate that a DMRS CDM group without data is 3, DMRS port 0 and DMRS port 1 and DMRS port 6, and the number of front-load symbols is 2, and PTRS port 0 may be transmitted by being associated with the third layer among the first layer and the third layer. This is because the third layer is the second one among two layer that may be associated with PTRS port 0. In this manner, when two PTRS ports are supported for the UE and a DMRS port is indicated based on Table 36, codepoint 12 to codepoint 17 may not be used but may be reserved. Alternatively, when two PTRS ports are supported for the UE, and a 5-bit antenna port field in which the transform precoder is configured to be disable, dmrs-Type is configured as 2, enhanced-dmrs-Type is not configured, and maxLength is configured as 2 is indicated by DCI, a table may be defined to determine a DMRS port for a case in which a rank of a PUSCH scheduled by the same DCI including the antenna port field is 3.

TABLE 37

| | Number of | | | |
|---|---|---|---|---|
| | DMRS CDM | | Number of | DMRS port |
| | group(s) | DMRS | front-load | associated |
| Value | without data | port(s) | symbols | with PTRS |
| 0 | 2 | 0-2 | 1 | 1^{st} |
| 1 | 3 | 0-2 | 1 | 1^{st} |
| 2 | 3 | 3-5 | 1 | 1^{st} |
| 3 | 3 | 0, 1, 6 | 2 | 1^{st} |
| 4 | 3 | 2, 3, 8 | 2 | 1^{st} |
| 5 | 3 | 4, 5, 10 | 2 | 1^{st} |
| 6 | 2 | 0-2 | 1 | 2^{nd} |
| 7 | 3 | 0-2 | 1 | 2^{nd} |
| 8 | 3 | 3-5 | 1 | 2^{nd} |
| 9 | 3 | 0, 1, 6 | 2 | 2^{nd} |
| 10 | 3 | 2, 3, 8 | 2 | 2^{nd} |
| 11 | 3 | 4, 5, 10 | 2 | 2^{nd} |
| 12-31 | Reserved | Reserved | Reserved | Reserved |

Alternatively, a DMRS port is indicated by using Table 36 in a same manner as a case in which the number of supported PTRS ports is 1, and if an antenna port field in the same DCI that schedules a PUSCH indicates codepoint 15, it may indicate that a DMRS CDM group without data is 3, DMRS port 0 and DMRS port 1 and DMRS port 6, and the number of front-load symbols is 2, and PTRS port 0 may be transmitted by being associated with the third layer among the first layer and the third layer. When a DMRS port associated with PTRS port 0 is determined as described above, codepoint 6 to codepoint 11 may not be used but may be reserved.

Option 3—The UE may determine a DMRS port to be associated with a PTRS, by using a reserved bit of an antenna port field as a PTRS-DMRS association field or by using a reserved bit of an antenna port field with a PTRS-DMRS association field.

Some codepoints among codepoints indicated by the antenna port field according to a layer of a scheduled PUSCH may not indicate a DMRS port but may be reserved. For example, when two PTRS ports are supported for the UE, and a 5-bit antenna port field in which the transform precoder is configured to be disable, dmrs-Type is configured as 2, enhanced-dmrs-Type is not configured, and maxLength is configured as 2 is indicated by DCI, a table may be defined to determine a DMRS port fora case in which a rank of a PUSCH scheduled by the same DCI including the antenna port field is 3, codepoint 0 to codepoint 5 are used to indicate a DMRS port, and codepoint 6 to codepoint 31 are reserved. For example, it may be identified that only 3 bits among 5 bits are used to indicate a DMRS port of a 3—layer PUSCH, and 2 bits are reserved. As described above, a bit that may be reserved may be used for a PTRS-DMRS association field, and only remaining antenna port field may be used to indicate a DMRS port. Obviously, when the number of layers of a scheduled PUSCH is not 3, the number of bits of an antenna port field to be used is defined according to the number of scheduled layers, and only remaining reserved bits are used to indicate PTRS-DMRS association. For example, when a higher layer parameter is equally configured as in the example above (the transform precoder is configured to be disable, dmrs-Type is configured as 2, enhanced-dmrs-Type is not configured, and maxLength is configured as 2), and the number of layers of a scheduled PUSCH is 1, 5 bits of the antenna port field may be all used to indicate a DMRS port, and bits are not allocated to indicate PTRS-DMRS association. If it is not possible to allocate a reserved bit among bits of the antenna port field in a particular scheduling situation, the reserved bit may be allocated without using codepoint for indicating some DMRS ports.

Fifth Element: Method of Transmitting PTRS with Respect to Single DCI Based Multi-TRP UL Transmission Scheme

Hereinafter, according to an embodiment of the disclosure, methods of determining and transmitting a PTRS according to single DCI based single transmit/receive point (TRP) transmitted by the UE or a single DCI based multi-TRP UL transmission scheme, when the UE is enabled for UL transmission using 3 transmission antennas, will now be described in detail.

As the single DCI based multi-TRP UL transmission scheme (hereinafter, the DCI based mTRP UL transmission scheme), methods below may be considered.

Single DCI based multi-TRP UL transmission scheme 1: sDCI mTRP PUSCH repetition—The UE may support sDCI mTRP PUSCH repetition for repeatedly transmitting a PUSCH to a plurality of TRPs via sDCI. If the UE supports sDCI mTRP PUSCH repetition, the UE may repeatedly transmit PUSCH repetition for same TB transmission to a plurality of TRPs in a time domain, and may repeatedly transmit a PUSCH to a plurality of TRPs for a next transmission pattern:
If the number of PUSCH repetitions is 2, the UE may transmit first PUSCH repetition to first TRP (TRP1) or second TRP (TRP2), and may transmit second PUSCH repetition to second TRP (TRP2) or first TRP (TRP1).
If the number of PUSCH repetitions is greater than 2, and
a sequential mapping scheme is supported, the UE may transmit first and second PUSCH repetitions to first TRP (TRP1) or second TRP (TRP2), and may transmit third and fourth PUSCH repetitions to second TRP (TRP2) or first TRP (TRP1). Similarly, in a case where the number of repetitions is greater than 4 or is 3, the UE may transmit repetition two times to one TRP and then may transmit a PUSCH to another TRP.
When a cyclic mapping scheme is supported, the UE may transmit first PUSCH repetition to first TRP (TRP1) or second TRP (TRP2), and may transmit second PUSCH repetition to second TRP (TRP2) or first TRP (TRP1). Similarly, in a case where the number of repetitions is greater than 4 or is 3, the UE may transmit repetition one time to one TRP and then may transmit a PUSCH to another TRP.

sDCI based mTRP UL transmission scheme 2: sDCI mTRP PUSCH STxM P SDM—The UE may transmit a PUSCH by performing spatial division multiplexing (SDM) to a plurality of TRPs using a plurality of panels via sDCI. For example, when the UE transmits a 4—layer PUSCH, the UE may transmit first and second layers to first TRP using a first panel, and may transmit third and fourth layers to second TRP using a second panel. In this regard, PUSCH s transmitted by using the first panel and the second panel are scheduled to be transmitted on a resource of the same time and frequency domains. Similarly, even when the UE transmits a 2—layer or 3—layer PUSCH, the UE may divide and transmit layers to respective TR Ps. In order to support an sDCI mTRP PUSCH simultaneous transmission with multi-panel (STxM P) SDM transmission scheme, the BS has to configure additional RRC parameters for the UE. For example, the BS may configure RRC parameter multipanelSchemeSDM to support the sDCI mTRP PUSCH STxM P SDM transmission scheme. The BS may configure the UE with RRC parameter maxRankSDM to indicate a maximum transmission rank with which the UE may transmit by using each panel. In this regard, the BS configures maxR ankSDM as a certain value (e.g., 1 or 2), based on UE capability reported by the UE.

sDCI based mTRP UL transmission scheme 3: sDCI mTRP PUSCH STxM P SFN—The UE may transmit a PUSCH in a single frequency network (SFN) scheme to a plurality of TRPs using a plurality of panels via sDCI. For example, when the UE transmits a 2—layer PUSCH, the UE transmits the same 2—layer PUSCH by using a first panel and a second panel on a resource of the same time and frequency domains. Similarly, even when the UE transmits a 1—layer PUSCH, the UE may repeatedly transmit a PUSCH of the same layer to two TRPs on the same time and frequency resource. In order to support the sDCI mTRP PUSCH STxM P SFN transmission scheme, the BS has to configure additional RRC parameters for the UE. For example, the BS may configure RRC parameter multipanelSchemeSFN to support the sDCI mTRP PUSCH STxM P SFN transmission scheme. The BS may configure the UE with RRC parameter maxRankSFN to indicate a maximum transmission rank with which the UE may transmit by using each panel. In this regard, the BS configures maxRankSFN as a certain value (e.g., 1 or 2), based on UE capability reported by the UE.

In order to support the aforementioned sDCI based mTRP UL transmission scheme to the UE, the BS may configure the UE with an SRS resource set in which a plurality of usages corresponding to respective TRPs are set to ‘codebook’ or ‘nonCodebook’. For example, in order to support the sDCI based mTRP UL transmission scheme, the BS may configure a support-target UE with two SRS resource sets in which ‘usage’ is set to ‘codebook’ or ‘nonCodebook’ (hereinafter, referred to as the two SRS resource sets, for convenience of descriptions). In this regard, the BS and the UE may have an implicit agreement in which a first SRS resource set (e.g., the SRS resource set having a smaller SRS-ResourceSetID value among the two SRS resource sets in which ‘usage’ is set to ‘codebook’ or ‘nonCodebook’) is used to support first TRP (e.g., TRP1) among two TRPs, and a second SRS resource set (e.g., the SRS resource set having a greater SRS-ResourceSetID value among the two SRS resource sets in which ‘usage’ is set to ‘codebook’ or‘nonCodebook’) is used to support second TRP (e.g., TRP2) among the two TRPs. If the BS configures the UE with the two SRS resource sets to support the sDCI based mTRP UL transmission scheme, the BS may indicate the configuration to the UE by including a 2-bit SRS resource set indicator in a DCI format (e.g., DCI format 0_1 or DCI format 0_2, etc.) for scheduling a UL channel (e.g., PUSCH).

The sDCI based mTRP UL transmission scheme may be scheduled with dynamic switching with the sDCI based single TRP (sTRP) transmission scheme. For example, the BS may perform scheduling, via a certain field in DCI that schedules UL transmission, so that the UE transmits a UL signal based on one of a sTRP transmission scheme or an mTRP transmission scheme. The BS may indicate one of the sTRP transmission scheme or the mTRP transmission scheme to the UE via a 2-bit SRS resource set indicator field included in the DCI. In detail, combinations of the sTRP transmission scheme and the mTRP transmission scheme which may be indicated by the BS via the 2-bit SRS resource set indicator field included in the DCI areas below:

Indication one of sDCI sTRP transmission scheme or sDCI mTRP PUSCH repetition—If the BS and the UE support the sDCI sTRP transmission scheme and the sDCI mTRP PUSCH repetition transmission scheme, one of the two schemes may be indicated via a 2-bit SRS resource set indicator field. Transmission schemes the BS may indicate via an SRS resource set indicator in DCI for scheduling a PUSCH are as below:

If the SRS resource set indicator is indicated as ‘00’, the UE transmits a PUSCH to the BS by using the sDCI sTRP transmission scheme. In this regard, the UE transmits a PUSCH based on an SRI field (e.g., a first SRI field) in DCI and/or a TPMI field (e.g., a first TPMI field) in the DCI, which are associated with a first SRS resource set among two SRS resource sets.

If the SRS resource set indicator is indicated as ‘01′, the UE transmits a PUSCH to the BS by using the sDCI sTRP transmission scheme. In this regard, the UE transmits a PUSCH based on an SRI field (e.g., a second SRI field) in DCI and/or a TPMI field (e.g., a second TPMI field) in the DCI, which are associated with a second SRS resource set among the two SRS resource sets.

If the SRS resource set indicator is indicated as ‘10′, the UE repeatedly transmits a PUSCH to two TRPs via an sDCI mTRP PUSCH repetition transmission scheme. In this regard, the UE first transmits a PUSCH based on an SRI field (e.g., a first SRI field) in DCI and/or a TPMI field (e.g., a first TPMI field) in the DCI, which are associated with a first SRS resource set among two SRS resource sets, and then transmits the PUSCH based on an SRI field (e.g., a second SRI field) in DCI and/or a TPMI field (e.g., a second TPMI field) in the DCI, which are associated with a second SRS resource set among the two SRS resource sets.
If the SRS resource set indicator is indicated as ‘11′, the UE repeatedly transmits a PUSCH to two TRPs via an sDCI mTRP PUSCH repetition transmission scheme. In this regard, the UE first transmits a PUSCH based on an SRI field (e.g., a second SRI field) in DCI and/or a TPMI field (e.g., a second TPMI field) in the DCI, which are associated with a second SRS resource set among the two SRS resource sets, and then transmits a PUSCH based on an SRI field (e.g., a first SR I field) in DCI and/or a TPMI field (e.g., a first TPMI field) in the DCI, which are associated with a first SRS resource set among two SRS resource sets and/or a TPMI field.

Indication of one of sDCI sTRP transmission scheme or sDCI mTRP PUSCH STxM P SDM—If the BS and the UE support an sDCI sTRP transmission scheme and a sDCI mTRP PUSCH STxM P SDM transmission scheme, one scheme among the two schemes may be indicated via a 2-bit SRS resource set indicator field. Transmission schemes the BS may indicate via an SRS resource set indicator in DCI for scheduling a PUSCH are as below:
If the SRS resource set indicator is indicated as ‘00’, the UE transmits a PUSCH to the BS by using the sDCI sTRP transmission scheme. In this regard, the UE transmits a PUSCH based on an SRI field (e.g., a first SRI field) in DCI and/or a TPMI field (e.g., a first TPMI field) in the DCI, which are associated with a first SRS resource set among two SRS resource sets.
If the SRS resource set indicator is indicated as ‘01′, the UE transmits a PUSCH to the BS by using the sDCI sTRP transmission scheme. In this regard, the UE transmits a PUSCH based on an SRI field (e.g., a second SRI field) in DCI and/or a TPMI field (e.g., a second TPMI field) in the DCI, which are associated with a second SRS resource set among the two SRS resource sets.
If the SRS resource set indicator is indicated as ‘10′, the UE divides a plurality of layers of the PUSCH and simultaneously transmits the divided layers to two TRPs via the sDCI mTRP PUSCH STxM P SDM transmission scheme. In this regard, the UE transmits some layers of a PUSCH (e.g., layers starting from a first layer up to a layer whose count number is indicated by a first SRI or a first TPMI, from among all scheduled layers) based on an SRI field (e.g., a first SRI field) in DCI and/or a TPMI field (e.g., a first TPMI field) in the DCI, which are associated with a first SRS resource set among two SRS resource sets, and then transmits remaining layers of the PUSCH (e.g., which indicate the remaining layers excluding the number of layers indicated by the first SRI or the first TPMI among the scheduled layers, and which may be defined to correspond to a same number of layers indicated by a second SRI or a second TPMI) based on an SRI field (e.g., a second SRI field) in DCI and/or a TPMI field (e.g., a second TPMI field) in the DCI, which are associated with a second SRS resource set among the two SRS resource sets.

If the SRS resource set indicator is indicated as ‘11′, the corresponding 2-bit value is reserved.

Indication of one of sDCI sTRP transmission scheme or sDCI mTRP PUSCH STxM P SFN—If the BS and the UE support an sDCI sTRP transmission scheme and an sDCI mTRP PUSCH STxM P SFN transmission scheme, one scheme among the two schemes may be indicated via a 2-bit SRS resource set indicator field. Transmission schemes the BS may indicate via an SRS resource set indicator in DCI for scheduling a PUSCH are as below:

If the SRS resource set indicator is indicated as ‘00’, the UE transmits a PUSCH to the BS by using the sDCI sTRP transmission scheme. In this regard, the UE transmits a PUSCH based on an SRI field (e.g., a first SRI field) in DCI and/or a TPMI field (e.g., a first TPMI field) in the DCI, which are associated with a first SRS resource set among two SRS resource sets.

If the SRS resource set indicator is indicated as ‘01′, the UE transmits a PUSCH to the BS by using the sDCI sTRP transmission scheme. In this regard, the UE transmits a PUSCH based on an SRI field (e.g., a second SRI field) in DCI and/or a TPMI field (e.g., a second TPMI field) in the DCI, which are associated with a second SRS resource set among the two SRS resource sets.

If the SRS resource set indicator is indicated as ‘10′, the UE repeatedly and simultaneously transmit the PUSCH to two TRPs via the sDCI mTRP PUSCH STxM P SFN transmission scheme. In this regard, the UE transmits a PUSCH based on an SRI field (e.g., a first SRI field) in DCI and/or a TPMI field (e.g., a first TPMI field) in the DCI, which are associated with a first SRS resource set among two SRS resource sets, and transmits the same PUSCH based on an SRI field (e.g., a second SRI field) in DCI and/or a TPMI field (e.g., a second TPMI field) in the DCI, which are associated with a second SRS resource set among the two SRS resource sets and/or a TPMI field. In this regard, the same PUSCH transmitted by being associated with the two SRS resource sets is transmitted on the same time and frequency resource.

If the SRS resource set indicator is indicated as ‘11′, the corresponding 2-bit value is reserved.

In this manner, the UE may identify that it is possible to transmit a PUSCH by using different PUSCH transmission schemes according to RRC parameter configuration and DCI for scheduling the PUSCH. If the UE is capable of performing transmission based on 3Tx ports by using various PUSCH transmission schemes, it is requested to define not only a method of indicating SRI and/or TPMI for transmitting up to 3 layers but also define a method of indicating a DMRS port and indication of PTRS-DMRS association field for indicating a DMRS associated with a PTRS. With a fifth-1 embodiment of the disclosure, a method of configuring and indicating a PTRS-DMRS association field for associating a PTRS port with respect to up to three layers, based on dynamic switching, when sDCI based mTRP PUSCH repetition using 3 transmission antennas is supported, will now be described. With a fifth-2 embodiment of the disclosure, a method of configuring and indicating a PTRS-DMRS association field for associating a PTRS port for each panel, based on dynamic switching, when sDCI based mTRP STxM P using a plurality of panels including 3 transmission antennas is supported, will now be described. Here, when the PTRS-DMRS association field for the 5—1 embodiment and the 5—2 embodiment is configured, factors below have to be considered.

The number of bits of the PTRS-DMRS association field has to be determined based on a configured RRC parameter.

The number of bits of the PTRS-DMRS association field shall not vary according to a value indicated by another DCI field (e.g., an SRS resource set indicator (SRSI)) in the same DCI format including the PTRS-DMRS association field.

### Fifth-1 Embodiment: Method of Transmitting PTRS with Respect to sDCI Based mTRP PUSCH Repetition Transmission Scheme

Hereinafter, according to an embodiment of the disclosure, methods of determining and transmitting a PTRS according to sDCI based single TRP or sDCI based mTRP PUSCH repetition transmission, which is transmitted by the UE, when the UE is enabled for UL transmission using 3 transmission antennas, w ill now be described in detail.

If the UE capable of using 3 transmission antennas supports sDCI based mTRP PUSCH repetition, a PTRS-DMRS association field may be defined as below, based on RRC parameters configured for the UE by the BS. In this regard, the BS may configure the UE with the RRC parameters as below:
To set a plurality of SRS resource sets (e.g., two sets) in which ‘usage’ is set to ‘codebook’ or ‘nonCodebook’.
To configure maxRank as 1 or 2 or 3 so as to indicate a maximum number of transmission layers of the UE (when codebook based PUSCH is supported)
To configure maxMIMO-Layers as 1 or 2 or 3 so as to indicate a maximum number of transmission layers of the UE (when noncodebook based PUSCH is supported)
To or not to configure maxNrofPorts in PTRS-UplinkConfig as n1 or n2 so as to indicate a maximum number of UL PTRS ports of the UE

To configure a new RRC parameter for transmitting a PUSCH by using 3 Tx ports. For example, a new RRC parameter 3TxPortPUSCH may be configured to be enable in PUSCH—Config. As another example, when a new RRC parameter, such as disable 4 Ports for indicating non-use of a fourth SRS port is configured in an SRS resource set for PUSCH transmission, or usage of the SRS resource set is nonCodebook, 3 SRS resources may be configured in the SRS resource set. Hereinafter, in the disclosure, the expression of ‘an RRC parameter for 3Tx PUSCH transmission is configured’ means that the BS has configured the UE with the corresponding RRC parameter for supporting 3Tx PUSCH transmission according to one the examples above.

Hereinafter, it is assumed that the BS has configured the UE with a plurality of SRS resource sets (e.g., two sets) in which ‘usage’ is set to ‘codebook’ or ‘nonCodebook’ in all methods configured in the fifth-1 embodiment.

According to maxNrofPorts in PTRS-UplinkConfig configured for the UE by the BS, the number of bits of a PTRS-DMRS association field included in DCI format (e.g., DCI format 0_1 or 0_2) for scheduling a PUSCH, and existence of a second PTRS-DMRS association field may be determined.

A case in which PTRS-UplinkConfig is not configured indicates a case in which UL PTRS is not supported, and in this case, the number of bits of the PTRS-DMRS association field in the DCI format for scheduling the PUSCH is determined to be 0.

When maxNRofPorts in PTRS-UplinkConfig is configured as n1, and a 2-bit SRSI field exists in the DCI because the two SRS resource sets (in which ‘usage’ is set to codebook or nonCodebook) are configured, the number of bits of the PTRS-DMRS association field may be defined as below:
When one PTRS port is configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multi panel Scheme SDM or multipanelSchemeSFN, etc.) for supporting STxM P scheme is not configured, the number of bits of a first PTRS-DMRS association field is defined to be 2. As will be described below, if the number of bits of a second PTRS-DMRS association field is defined to be greater than 0 so as to support sDCI mTRP PUSCH repetition, when the SRSI field is indicated as ‘00‘ or ‘01’ as described above, the UE may ignore the second PTRS-DMRS association field being greater than 0.
When one PTRS port is configured by maxNRofPorts in PTRS-UplinkConfig, an SRSI field exists, the SRSI field is equal to ‘10’ or ‘11’, RRC parameter maxRank (or maxMIMO-Layers) is 2, and an RRC parameter (e.g., multipanelSchemeSDM or multipanelSchemeSFN, etc.) for supporting STxM P scheme is not configured, the number of a first PTRS-DMRS association field is defined to be 2. An MSB bit of a 2-bit first PTRS-DMRS association field is used to indicate an association relation between a DMRS port and a PTRS port corresponding to a first SRI and/or a first TPMI, and an LSB bit is used to indicate an association relation between a DMRS port and a PTRS port corresponding to a second SRI and/or a second TPMI. When one PTRS port is configured by maxNRofPorts in PTRS-UplinkConfig, an SRSI field exists, the SRSI field is equal to ‘10’ or ‘11’, RRC parameter maxRank (or maxMIMO-Layers) is 2, and an RRC parameter (e.g., multi panel SchemeSDM or multipanelSchemeSFN, etc.) for supporting STxM P scheme is not configured, the number of bits of a second PTRS-DMRS association field is defined to be 0, and thus, a second PTRS-DMRS association area may not exist.
When one PTRS port is configured by maxNRofPorts in PTRS-UplinkConfig, an SRSI field exists, the SRSI field is equal to ‘10’ or ‘11’, RRC parameter maxRank (or maxMIMO-Layers) is 3, and an RRC parameter (e.g., multipanel SchemeSDM or multipanelSchemeSFN, etc.) for supporting STxM P scheme is not configured, the number of a first PTRS-DMRS association field is defined to be 2.A 2-bit first PTRS-DMRS association field is used to indicate an association relation between a DMRS port and a PTRS port corresponding to a first SRI and/or a first TPMI. One PTRS port is set by maxNRofPorts in PTRS-UplinkConfig, an SRSI field exists, the SRSI field is equal to ‘10’ or ‘11’, RRC parameter maxRank (or maxMIMG-Layers) is 3, and an RRC parameter (e.g., multipanelSchemeSDM or multipanelSchemeSFN, etc.) for supporting STxM P scheme is not configured, a second PTRS-DMRS association field is defined to be 2 bits. A 2-bit second PTRS-DMRS association field is used to indicate an association relation between a DMRS port and a PTRS port corresponding to a second SRI and/or a second TPMI.

When maxNRofPorts in PTRS-UplinkConfig is configured as n2, and a 2-bit SRSI field exists in the DCI because the two SRS resource sets (in which ‘usage’ is set to codebook or nonCodebook) are configured, the number of bits of the PTRS-DMRS association field may be defined by two approach methods. According to a first method, as described in the fourth embodiment of the disclosure, the number of bits of a first PTRS-DMRS association field may be defined to be 1 bit, and a second PTRS-DMRS association field may be introduced, based on dynamic switching between the sDCI based mTRP PUSCH repetition scheme and the sDCI based sTRP PUSCH repetition scheme. According to a second method, unlike to the description on the fourth embodiment of the disclosure, even when maxNRofPorts in PTRS-UplinkConfig is configured as n2 for the UE capable of supporting 3Tx ports, a PTRS-DMRS association field of 2 bits, not 1 bit, may be configured. The first method and the second method will now be described in detail.

Method of configuring two PTRS-DMRS association fields defined by 1 bit

Case 1-1) When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter for 3Tx PUSCH transmission is configured, and an RRC parameter (e.g., multipanelSchemeSDM or multipanelSchemeSFN, etc.) for supporting STxM P scheme is not configured, the number of bits of a first PTRS-DMRS association field is defined to be 1. As described in the fourth embodiment of the disclosure, if codebook based 3 Tx port PUSCH transmission is supported, when a PUSCH of 3 layers is scheduled, only one layer may be transmitted via antenna port 1001, and as PTRS port 1 may be associated with only a layer transmitted via antenna port 1001, only one layer associated with PTRS port 0 among two layers transmitted via remaining antenna port 1000 or 1002 shall be indicated. Similarly, even when noncodebook based 3 Tx port PUSCH transmission is supported, two SRS resources among three SRS resources may be associated with PTRS port 0 (or PTRS port 1), and remaining one SRS resource may be associated with PTRS port 1 (or PTRS port 0), and thus, one layer among two layers that may be associated with one PTRS port 0 (or PTRS port 1) shall be indicated, and a 1-bit PTRS-DMRS association field may be defined. For example, the BS may indicate an association relation between PTRS and DMRS for sDCI based sTRP PUSCH transmission by using the 1-bit first PTRS-DMRS association field to the UE. As will be described below, if the number of bits of a second PTRS-DMRS association field is defined to be greater than 0 so as to support sDCI mTRP PUSCH repetition, when the SRSI field is indicated as ‘00‘ or ‘01’ as described above, the UE may ignore the second PTRS-DMRS association field being greater than 0.
Case 1-2) Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 2, an RRC parameter (e.g., multi panel SchemeSDM or multipanelSchemeSFN, etc.) for supporting STxM P scheme is not configured, and an RRC parameter for 3Tx PUSCH transmission is configured, the number of bits of a first PTRS-DMRS association field is defined to be l and the number of bits of a second PTRS-DMRS association field is also defined to be 1. A 1-bit first PTRS-DMRS association field is used to indicate an association relation between a DMRS port and a PTRS port corresponding to a first SRI and/or a first TPMI. A 1-bit second PTRS-DMRS association field is used to indicate an association relation between a DMRS port and a PTRS port corresponding to a second SRI and/or a second TPMI.

Case 1-3) Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 3, an RRC parameter (e.g., multi panel SchemeSDM or multipanelSchemeSFN, etc.) for supporting STxM P scheme is not configured, and an RRC parameter for 3Tx PUSCH transmission is configured, the number of bits of a first PTRS-DMRS association field is defined to be 1 and the number of bits of a second PTRS-DMRS association field is also defined to be 1. A 1-bit first PTRS-DMRS association field is used to indicate an association relation between a DMRS port and a PTRS port corresponding to a first SRI and/or a first TPMI. A 1-bit second PTRS-DMRS association field is used to indicate an association relation between a DMRS port and a PTRS port corresponding to a second SRI and/or a second TPMI.

Case 1-4) Rules may be defined by considering all of Case 1-2 and Case 1-3 described above. For example, when two TRS ports are configured by maxNRofPorts in PTRS-UplinkConfig, an SRSI field exists, the SRSI field is equal to ‘10’ or ‘11’, RRC parameter maxRank (or maxMIMO-Layers) is 2 or 3, an RRC parameter (e.g., multipanelSchemeSDM or multipanelSchemeSFN, etc.) for supporting STxM P scheme is not configured, and an RRC parameter for 3Tx PUSCH transmission is configured, the number of bits of a first PTRS-DMRS association field is defined to be 1 and the number of bits of a second PTRS-DMRS association field is also defined to be 1. A 1-bit first PTRS-DMRS association field is used to indicate an association relation between a DMRS port and a PTRS port corresponding to a first SRI and/or a first TPMI. A 1-bit second PTRS-DMRS association field is used to indicate an association relation between a DMRS port and a PTRS port corresponding to a second SRI and/or a second T PM 1.

Method of configuring one PTRS-DMRS association field defined by 2 bits
Case 2—1) When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter for 3Tx PUSCH transmission is configured (or a condition on whether the RRC parameter for 3Tx PUSCH transmission is configured may be skipped), the number of bits of a PTRS-DMRS association field is defined to be 2. In this regard, the UE may identify a DMRS port associated with a PTRS by referring to only 1 bit (e.g., LSB 1 bit or MSB 1 bit) among 2 bits and may ignore remaining bit, or may identify a DMRS port associated with a PTRS by referring to only two codepoints (e.g., first two codepoints) among four codepoints and may ignore remaining codepoints.
Case 2—2) Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 2, an RRC parameter (e.g., multipanel SchemeSDM or multipanelSchemeSFN, etc.) for supporting STxM P scheme is not configured, and an RRC parameter for 3Tx PUSCH transmission is configured (or a condition on whether the RRC parameter for 3Tx PUSCH transmission is configured may be skipped), the number of bits of a PTRS-DMRS association field is defined to be 2. An MSB bit of a 2-bit PTRS-DMRS association field is used to indicate an association relation between a DMRS port and a PTRS port corresponding to a first SRI and/or a first TPMI, and an LSB bit is used to indicate an association relation between a DMRS port and a PTRS port corresponding to a second SRI and/or a second TPM1. Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 2, an RRC parameter (e.g., multipanelSchemeSDM or multipanelSchemeSFN, etc.) for supporting STxM P scheme is not configured, and an RRC parameter for 3Tx PUSCH transmission is configured (or a condition on whether the RRC parameter for 3Tx PUSCH transmission is configured may be skipped), the number of bits of a second PTRS-DMRS association field is defined to be 0, and thus, a second PTRS-DMRS association area may not exist.
Case 2—3) Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 3, an RRC parameter (e.g., multi panel SchemeSDM or multipanelSchemeSFN, etc.) for supporting STxM P scheme is not configured, and an RRC parameter for 3Tx PUSCH transmission is configured, the number of bits of a PTRS-DMRS association field is defined to be 2. An MSB bit of a 2-bit PTRS-DMRS association field is used to indicate an association relation between a DMRS port and a PTRS port corresponding to a first SRI and/or a first TPMI, and an LSB bit is used to indicate an association relation between a DMRS port and a PTRS port corresponding to a second SRI and/or a second TPMI. Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 3, an RRC parameter (e.g., multipanelSchemeSDM or multipanelSchemeSFN, etc.) for supporting STxM P scheme is not configured, and an RRC parameter for 3Tx PUSCH transmission is configured, the number of bits of a second PTRS-DMRS association field is defined to be 0, and thus, a second PTRS-DMRS association area may not exist.
Case 2—4) R ules may be defined by considering all of Case 2—2 and Case 2-3 described above. For example, two TRS ports are configured by maxNRofPorts in PTRS-UplinkConfig, an SRSI field exists, the SRSI field is equal to ‘10’ or ‘11’, RRC parameter maxRank (or maxMIMO-Layers) is 2 or 3, an RRC parameter (e.g., multipanel SchemeSDM or multipanelSchemeSFN, etc.) for supporting STxM P scheme is not configured, and an RRC parameter for 3Tx PUSCH transmission is configured, the number of bits of a PTRS-DMRS association field is defined to be 2. An MSB bit of a 2-bit PTRS-DMRS association field is used to indicate an association relation between a DMRS port and a PTRS port corresponding to a first SRI and/or a first TPMI, and an LSB bit is used to indicate an association relation between a DMRS port and a PTRS port corresponding to a second SRI and/or a second TPMI. Two TRS ports are configured by maxNRofPorts in PTRS-UplinkConfig, an SRSI field exists, the SRSI field is equal to ‘10’ or ‘11’, RRC parameter maxRank (or maxMIMO-Layers) is 2 or 3, an RRC parameter (e.g., multipanelSchemeSDM or multipanelSchemeSFN, etc.) for supporting STxM P scheme is not configured, and an RRC parameter for 3Tx PUSCH transmission is configured, the number of bits of a second PTRS-DMRS association field is defined to be 0, and thus, a second PTRS-DMRS association area may not exist.

In this manner, according to one method among the two approach methods, a PTRS-DMRS association indication method for which sDCI based mTRP PUSCH repetition and dynamic switching are all considered may be supported for the UE supporting 3Tx ports. In this regard, it is possible to identify that the number of bits of a first PTRS-DMRS association field and the number of bits of a second PTRS-DMRS association field are designed to be fixed according to RRC parameter configuration, regardless of a value indicated by other DCI field (i.e., SRSI field) included in the same DCI including the PTRS-DMRS association field.

In the aforementioned descriptions, a first TPMI means ‘precoding information and number of layers’, and a second TPMI means ‘second Precoding information’. In the aforementioned descriptions, a first SRI means ‘first SRS resource indicator’, and a second SRI means ‘second SRS resource indicator’. [00513]<Fifth-2 embodiment: Method of transmitting PTRS with respect to sDCI based mTRP PUSCH simultaneous transmission with multi-panel>

Hereinafter, according to an embodiment of the disclosure, methods of determining and transmitting a PTRS according to sDCI based single TRP PUSCH transmission or sDCI based mTRP PUSCH simultaneous transmission with multi-panel (STxM P), which is transmitted by the UE, when the UE is enabled for UL transmission using 3 transmission antennas, will now be described in detail.

If the UE capable of using 3 transmission antennas supports sDCI based mTRP PUSCH STxM P, a PTRS-DMRS association field may be defined as below, based on RRC parameters configured for the UE by the BS. In this regard, the BS may configure the UE with the RRC parameters as below:
To set a plurality of SRS resource sets (e.g., two sets) in which ‘usage’ is set to ‘codebook’ or ‘nonCodebook’.
To configure maxRank as 1 or 2 or 3 so as to indicate a maximum number of transmission layers of the UE (when codebook based PUSCH is supported)
To configure maxMIMO-Layers as 1 or 2 or 3 so as to indicate a maximum number of transmission layers of the UE (when noncodebook based PUSCH is supported)
To or not to configure maxNrofPorts in PTRS-UplinkConfig as n1 or n2 so as to indicate a maximum number of UL PTRS ports of the UE
To configure a new RRC parameter for transmitting a PUSCH by using 3 Tx ports. For example, a new RRC parameter 3TxPortPUSCH may be configured to be enable in PUSCH—Config. As another example, when a new RRC parameter, such as disable 4Ports for indicating non-use of a fourth SRS port is configured in an SRS resource set for PUSCH transmission, or usage of the SRS resource set is nonCodebook, 3 SRS resources may be configured in the SRS resource set. Hereinafter, in the disclosure, the expression of ‘an RRC parameter for 3Tx PUSCH transmission is configured’ means that the BS has configured the UE with the corresponding RRC parameter for supporting 3Tx PUSCH transmission according to one the examples above.
When STxM P SDM or STxM P SFN is supported, maxRankSDM (or maxRankSDM—DCI-0-2) or maxRankSFN (or maxRankSFN-DCI-0-2) is configured as 1 or 2 to indicate a maximum number of transmission layers for each panel of the UE (when codebook based PUSCH is supported)
When STxM P SDM or STxM P SFN is supported, maxMIMO-Layers for SDM (or maxMIMO-Layers for SDM—DCI-0-2) or maxMIMO-LayersforSFN (or maxMIMO-LayersforSFN-DCI-0-2) is configured as 1 or 2 to indicate a maximum number of transmission layers for each panel of the UE (when noncodebook based PUSCH is supported)
To configure an RRC parameter (e.g., multipanelSchemeSDM or multipanelSchemeSFN, etc.) for supporting a STxM P scheme

To configure maxNrofPorts-SDM in PTRS-UplinkConfig as n1 or n2 to indicate a maximum number of UL PTRS ports

Hereinafter, it is assumed that the BS has configured the UE with a plurality of SRS resource sets (e.g., two sets) in which ‘usage’ is set to ‘codebook’ or ‘nonCodebook’ in all methods configured in the fifth-2 embodiment.

According to maxNrofPorts in PTRS-UplinkConfig configured for the UE by the BS, the number of bits of a PTRS-DMRS association field included in DCI format (e.g., DCI format 0_1 or 0_2) for scheduling a PUSCH, and existence of a second PTRS-DMRS association field may be determined.

A case in which PTRS-UplinkConfig is not configured indicates a case in which UL PTRS is not supported, and in this case, the number of bits of the PTRS-DMRS association field in the DCI format for scheduling the PUSCH is determined to be 0.

When two SRS resource sets (in which ‘usage’ is set to codebook or nonCodebook) are configured, and thus, a 2-bit SRSI field exists in DCI, maxNRofPorts-SDM IN PTRS-UplinkConfig is configured as n1, maxNRofPorts in PTRS-UplinkConfig is configured as n1, and a STxM P SDM scheme is supported, the number of bits of a PTRS-DMRS association field may be defined as below:
When one PTRS port is configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 2.
When one PTRS port is configured by maxNRofPorts-SDM in PTRS-UplinkConfig, an SRSI field exists, the SRSI field is equal to ‘10′, an RRC parameter (e.g., multipanelSchemeSDM) for supporting a STxM P SDM scheme is configured, and an RRC parameter for 3Tx PUSCH transmission is configured, the number of bits of a first PTRS-DMRS association field is defined to be 2. This DCI field is used to indicate an association relation between a DMRS port and a PTRS port which correspond to first and second SRI fields and/or first and second TPMI fields.

When two SRS resource sets (in which ‘usage’ is set to codebook or nonCodebook) are configured, and thus, a 2-bit SRSI field exists in DCI, maxNRofPorts-SDM IN PTRS-UplinkConfig is configured as n2, maxNRofPorts in PTRS-UplinkConfig is configured as n2, and a STxM P SDM scheme is supported, the number of bits of a PTRS-DMRS association field may be defined as below. In this regard, it is assumed that, when the UE supports a STxM P SDM transmission scheme by using a plurality of panels of 3 Tx ports, the UE may transmit up to 2 layers for each panel, and may support a maximum of 2+2=4 layers.
When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 2. In this regard, the UE may identify a DMRS port associated with a PTRS by referring to 1 bit (e.g., LSB 1 bit or MSB 1 bit) among 2 bits and may ignore remaining bit, or may identify a DMRS port associated with a PTRS by referring to two codepoints (e.g., first two codepoints) among four codepoints and may ignore remaining codepoints.
When two PTRS ports are configured by maxNRofPorts-SDM in PTRS-UplinkConfig, an SRSI field exists, the SRSI field is equal to ‘10′, an RRC parameter (e.g., multipanelSchemeSDM) for supporting a STxM P SDM scheme is configured, and an RRC parameter for 3Tx PUSCH transmission is configured, the number of bits of a first PTRS-DMRS association field is defined to be 2. An MSB bit of a 2-bit PTRS-DMRS association field is used to indicate an association relation between a DMRS port and a PTRS port 0 corresponding to a first SRI and/or a first TPMI, and an LSB bit is used to indicate an association relation between a DMRS port and a PTRS port 1 corresponding to a second SRI and/or a second TPMI.

When two SRS resource sets (in which ‘usage’ is set to codebook or nonCodebook) are configured, and thus, a 2-bit SRSI field exists in DCI, maxNRofPorts-SDM IN PTRS-UplinkConfig is configured as n2, maxNRofPorts in PTRS-UplinkConfig is configured as n2, and a STxM P SDM scheme is supported, the number of bits of a PTRS-DMRS association field may be differently defined as below. In this regard, it is assumed that, when the UE supports a STxM P SDM transmission scheme by using a plurality of panels of 3 Tx ports, the UE may transmit up to 2 layers for each panel, and may support a maximum of 2+2=4 layers.

When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 1. As will be described below, if the number of bits of a second PTRS-DMRS association field is defined to be greater than 0 so as to support sDCI mTRP STxM P SDM, when the SRSI field is indicated as ‘00‘ or ‘01’ as described above, the UE may ignore the second PTRS-DMRS association field being greater than 0.

When two PTRS ports are configured by maxNRofPorts-SDM in PTRS-UplinkConfig, an SRSI field exists, the SRSI field is equal to ‘10′, an RRC parameter (e.g., multipanelSchemeSDM) for supporting a STxM P SDM scheme is configured, and an RRC parameter for 3Tx PUSCH transmission is configured, the number of bits of a first PTRS-DMRS association field is defined to be 1, and the number of bits of a second PTRS-DMRS association field is also defined to be 1. A 1—bit first PTRS-DMRS association field is used to indicate an association relation between a DMRS port and a PTRS port 0 corresponding to a first SRI and/or a first TPMI. A 1-bit second PTRS-DMRS association field is used to indicate an association relation between a DMRS port and a PTRS port 1 corresponding to a second SRI and/or a second TPMI.

When two SRS resource sets (in which ‘usage’ is set to codebook or nonCodebook) are configured, and thus, a 2-bit SRSI field exists in DCI, maxNRofPorts-SDM IN PTRS-UplinkConfig is configured as n2, maxNRofPorts in PTRS-UplinkConfig is configured as n2, and a STxM P SDM scheme is supported, the number of bits of a PTRS-DMRS association field may be defined as below. In this regard, a case is assumed, in which, when the UE supports a STxM P SDM transmission scheme by using a plurality of panels of 3 Tx ports, the UE may transmit up to 2 layers for each panel but a total sum of layers transmitted via two panels is limited to 3 layers (e.g., 2+1 layers or 1+2 layers).

When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 1.
When two PTRS ports are configured by maxNRofPorts-SDM in PTRS-UplinkConfig, an SRSI field exists, the SRSI field is equal to ‘10′, an RRC parameter (e.g., multipanelSchemeSDM) for supporting a STxM P SDM scheme is configured, and an RRC parameter for 3Tx PUSCH transmission is configured, the number of bits of a first PTRS-DMRS association field is defined to be 1. As a combination of schedulable layers of two panels is limited to 1+1 or 1+2 or 2+1 when the STxM P SDM scheme is supported, the BS may indicate one layer to the UE via only 1 bit, the one layer being among two layers transmitted via one panel and being associated with a PTRS port.

When two SRS resource sets (in which ‘usage’ is set to codebook or nonCodebook) are configured, and thus, a 2-bit SRSI field exists in DCI, maxNRofPorts-SDM IN PTRS-UplinkConfig is configured as n1, maxNRofPorts in PTRS-UplinkConfig is configured as n2, and a STxM P SDM scheme is supported, the number of bits of a PTRS-DMRS association field may be defined as below:
When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 2. In this regard, the UE may identify a DMRS port associated with a PTRS by referring to 1 bit (e.g., LSB 1 bit or MSB 1 bit) among 2 bits and may ignore remaining bit, or may identify a DMRS port associated with a PTRS by referring to two codepoints (e.g., first two codepoints) among four codepoints and may ignore remaining codepoints.
When one PTRS port is configured by maxNRofPorts-SDM in PTRS-UplinkConfig, an SRSI field exists, the SRSI field is equal to ‘10′, an RRC parameter (e.g., multipanel SchemeSDM) for supporting a STxM P SDM scheme is configured, and an RRC parameter for 3Tx PUSCH transmission is configured, the number of bits of a first PTRS-DMRS association field is defined to be 2. This DCI field is used to indicate an association relation between a DMRS port and a PTRS port which correspond to first and second SRI fields and/or first and second TPMI fields.

When two SRS resource sets (in which ‘usage’ is set to codebook or nonCodebook) are configured, and thus, a 2-bit SRSI field exists in DCI, maxNRofPorts-SDM IN PTRS-UplinkConfig is configured as n2, maxNRofPorts in PTRS-UplinkConfig is configured as n1, and a STxM P SDM scheme is supported, the number of bits of a PTRS-DMRS association field may be defined as below.
When one PTRS port is configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 2.
When two PTRS ports are configured by maxNRofPorts-SDM in PTRS-UplinkConfig, an SRSI field exists, the SRSI field is equal to ‘10′, an RRC parameter (e.g., multipanelSchemeSDM) for supporting a STxM P SDM scheme is configured, and an RRC parameter for 3Tx PUSCH transmission is configured, the number of bits of a first PTRS-DMRS association field is defined to be 2. An MSB bit of a 2-bit PTRS-DMRS association field is used to indicate an association relation between a DMRS port and a PTRS port 0 corresponding to a first SRI and/or a first TPMI, and an LSB bit is used to indicate an association relation between a DMRS port and a PTRS port 1 corresponding to a second SRI and/or a second TPMI.

When two SRS resource sets (in which ‘usage’ is set to codebook or nonCodebook) are configured, and thus, a 2-bit SRSI field exists in DCI, maxNRofPorts in PTRS-UplinkConfig is configured as n1, and a STxM P SFN scheme is supported, the number of bits of a PTRS-DMRS association field may be defined as below:
When one PTRS port is configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 2.

When one PTRS port is configured by maxNRofPorts in PTRS-UplinkConfig, an SRSI field exists, the SRSI field is equal to ‘10′, and an RRC parameter (e.g., multipanelSchemeSFN) for supporting a STxM P SFN scheme is configured, and an RRC parameter for 3Tx PUSCH transmission is configured, the number of bits of a first PTRS-DMRS association field is defined to be 2. This DCI field is used to indicate an association relation between a DMRS port and a PTRS port which correspond to a first SRI field and/or a first TPMI field.

When two SRS resource sets (in which ‘usage’ is set to codebook or nonCodebook) are configured, and thus, a 2-bit SRSI field exists in DCI, maxNRofPorts in PTRS-UplinkConfig is configured as n2, and a STxM P SFN scheme is supported, the number of bits of a PTRS-DMRS association field may be defined as below:
When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 2. In this regard, the UE may identify a DMRS port associated with a PTRS by referring to only 1 bit (e.g., LSB 1 bit or MSB 1 bit) among 2 bits and may ignore remaining bit, or may identify a DMRS port associated with a PTRS by referring to only two codepoints (e.g., first two codepoints) among four codepoints and may ignore remaining codepoints.

When two PTRS ports are configured by maxNRofPorts in PTRS-UplinkConfig, an SRSI field exists, the SRSI field is equal to ‘10′, an RRC parameter (e.g., multipanelSchemeSDM) for supporting a STxM P SF N scheme is configured, and an RRC parameter for 3Tx PUSCH transmission is configured, the number of bits of a first PTRS-DMRS association field is defined to be 2. This DCI field is used to indicate an association relation between a DMRS port and a PTRS port which correspond to a first SRI field and/or a first TPMI field. [0052 When two SRS resource sets (in which ‘usage’ is set to codebook or nonCodebook) are configured, and thus, a 2-bit SRSI field exists in DCI, maxNRofPorts in PTRS-UplinkConfig is configured as n2, and a STxM P SFN scheme is supported, the number of bits of a PTRS-DMRS association field may be differently defined as below:
When two PTRS ports are configured by maxNRofPorts in PTRS-UplinkConfig, an SRSI field exists, the SRSI field is equal to ‘00‘ or ‘01’, and RRC parameter maxRank (or maxMIMO-Layers) is 2 or 3, and an RRC parameter (e.g., multipanelSchemeSDM or multipanelSchemeSFN, etc.) for supporting STxM P scheme is not configured, the number of bits of a first PTRS-DMRS association field is defined to be 1.

When two PTRS ports are configured by maxNRofPorts in PTRS-UplinkConfig, an SRSI field exists, the SRSI field is equal to ‘10′, an RRC parameter (e.g., multipanelSchemeSDM) for supporting a STxM P SF N scheme is configured, and an RRC parameter for 3Tx PUSCH transmission is configured, the number of bits of a first PTRS-DMRS association field is defined to be 1. This DCI field is used to indicate an association relation between a DMRS port and a PTRS port which correspond to a first SRI field and/or a first TPMI field.

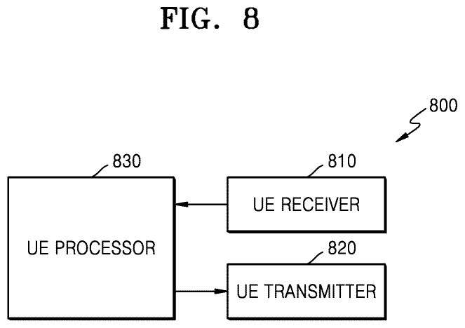

FIG. 8 is a diagram illustrating a structure of a UE in a wireless communication system according to an embodiment of the disclosure.

Referring to FIG. 8, a UE 800 may include a transceiver collectively referring to a UE receiver 810 and a UE transmitter 820, memory (not shown), and a UE processor (or a UE controller or a processor) 830. According to the communication method of the UE described above, the receiver 810 or the transmitter 820, the memory, and the UE processor 830 of the UE 800 may operate. However, elements of the UE 800 are not limited to the example above. For example, the UE 800 may include more elements than those described above or may include fewer elements than those described above. In addition, the receiver 810 or the transmitter 820, the memory, and the processor 830 may be implemented as one chip.

The receiver 810 or the transmitter 820 may transmit/receive signals to/from a BS 900. Here, the signal may include control information and data. To this end, the receiver 810 or the transmitter 820 may include a radio frequency (RF) transmitter for up-converting and amplifying a frequency of signals to be transmitted, and an RF receiver for low-noise-amplifying and down-converting a frequency of received signals. However, this is merely an example of the receiver 810 or the transmitter 820, and elements of the receiver 810 or the transmitter 820 are not limited to the RF transmitter and the RF receiver.

In addition, the receiver 810 or the transmitter 820 may receive signals via wireless channels and output the signals to the processor 830, and may transmit signals output from the processor 830, via wireless channels.

The memory may store programs and data required for the UE 800 to operate. In addition, the memory may store control information or data included in a signal transmitted or received by the UE. The memory may include any or a combination of storage media, such as read-only memory (ROM), random access memory (RAM), hard disk, compact disc (CD)-ROM, digital versatile disc (DVD), or the like. In addition, the memory may include a plurality of memories.

In addition, the processor 830 may control a series of processes to allow the UE 800 to operate according to the embodiments of the disclosure. For example, the processor 830 may control elements of the UE 800 to receive DCI consisting of two layers so as to simultaneously receive a plurality of PDSCHs. The processor 830 may be provided in a multiple number, and may perform an element control operation of the UE 800 by executing a program stored in the memory.

The at least one processor 830 may include various processing circuitry and/or a plurality of processors. For example, the term “processor” used herein including claims may include various processing circuitry including at least one processor. One or more processors in the at least one processor 830 may be configured to individually in a distributed manner or collectively perform various functions to be described here. As used herein, “processor”, “at least one processor”, and “one or more processors” may be configured to perform various functions. However, the recited terms cover, without limitation, a situation in which one processor performs a part of functions and other processor(s) performs the other part of the functions, and a situation in which one processor may perform all functions. In addition, the at least one processor 830 may include a combination of processors configured to perform a variety of the disclosed functions in a distributed manner. The at least one processor 830 may execute program instructions to achieve or perform various functions.

In an embodiment of the disclosure, the at least one processor 830 may each be a general-purpose processor, such as a central processing unit (CPU), an application processor (AP), a digital signal processor (DSP), or the like, a graphics-dedicated processor, such as a graphics processing unit (GPU), a vision processing unit (V PU) or the like, or an A I-dedicated processor, such as a neural processing unit (N PU). When each of the one or more processors is an A I-dedicated processor, the A I-dedicated processor may be designed to have a hardware structure specialized for processing of a particular AI model.

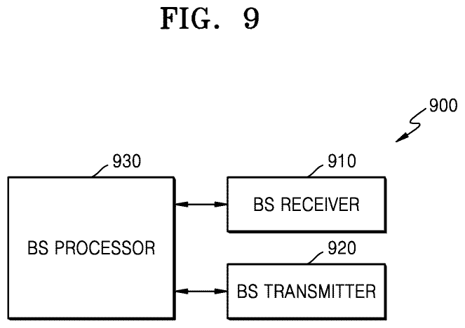

FIG. 9 is a diagram illustrating a structure of a BS in a wireless communication system according to an embodiment of the disclosure.

Referring to FIG. 9, a BS 900 may include a transceiver collectively referring to a BS receiver 910 and a BS transmitter 920, memory (not shown), and a BS processor (or a BS controller or a processor) 930. According to the communication method of the BS described above, the receiver 910 or the transmitter 920, the memory, and the BS processor 930 of the BS 900 may operate. However, elements of the BS 900 are not limited to the example above. For example, the BS 900 may include more elements than those described above or may include fewer elements than those described above. In addition, the receiver 910 or the transmitter 920, the memory, and the processor 930 may be implemented as one chip.

The receiver 910 or the transmitter 920 may transmit/receive signals to/from the UE 800. Here, the signal may include control information and data. To this end, the receiver 910 or the transmitter 920 may include a RF transmitter for up-converting and amplifying a frequency of signals to be transmitted, and an RF receiver for low-noise-amplifying and down-converting a frequency of received signals. However, this is merely an example of the receiver 910 or the transmitter 920, and elements of the receiver 910 or the transmitter 920 are not limited to the RF transmitter and the RF receiver.

In addition, the receiver 910 or the transmitter 920 may receive signals via wireless channels and output the signals to the processor 930, and may transmit signals output from the processor 930, via wireless channels.

The memory may store programs and data required for the BS 900 to operate. In addition, the memory may store control information or data included in a signal transmitted or received by the BS 900. The memory may include any or a combination of storage media, such as ROM, RAM, hard disk, CD-ROM, DVD, or the like. In addition, the memory may include a plurality of memories.

In addition, the processor 930 may control a series of processes to allow the BS 900 to operate according to the embodiments of the disclosure. For example, the processor 930 may configure a plurality of pieces of DCI consisting of two layers and including allocation information associated with a plurality of PDSCHs, and may control each element to transmit the DCI. The processor 930 may be provided in a multiple number, and may perform an element control operation of the BS 900 by executing a program stored in the memory.

The at least one processor 930 may include various processing circuitry and/or a plurality of processors. For example, the term “processor” used herein including claims may include various processing circuitry including at least one processor. One or more processors in the at least one processor 930 may be configured to individually in a distributed manner or collectively perform various functions to be described here. As used herein, “processor”, “at least one processor”, and “one or more processors” may be configured to perform various functions. However, the recited terms cover, without limitation, a situation in which one processor performs a part of functions and other processor(s) performs the other part of the functions, and a situation in which one processor may perform all functions. In addition, the at least one processor 930 may include a combination of processors configured to perform a variety of the disclosed functions in a distributed manner. The at least one processor 930 may execute program instructions to achieve or perform various functions.

In an embodiment of the disclosure, the at least one processor 930 may each be a general-purpose processor, such as a CPU, an AP, a DSP, or the like, a graphics-dedicated processor, such as a GPU, a VPU or the like, or an Al-dedicated processor, such as a N PU. When each of the one or more processors is an A I-dedicated processor, the AI-dedicated processor may be designed to have a hardware structure specialized for processing of a particular AI model.

The methods according to the embodiments of the disclosure as described in claims or specification may be implemented as hardware, software, or a combination of hardware and software.

When implemented as software, a computer-readable storage medium which stores one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including random access memory (RAM) or flash memory, read only memory (ROM), electrically erasable programmable read only memory (EEPROM), a magnetic disc storage device, compact disc (CD)—ROM, digital versatile disc (DVD), another optical storage device, or magnetic cassette. Alternatively, the programs may be stored in memory including a combination of some or all of the above-mentioned storage media. In addition, a plurality of such memories may be included.

In addition, the programs may be stored in an attachable storage device accessible through any or a combination of communication networks, such as Internet, an intranet, a local area network (LAN), a wide LAN (WLAN), a storage area network (SAN), or the like. Such a storage device may access, via an external port, a device performing the embodiments of the disclosure. Furthermore, a separate storage device on the communication network may access the electronic device performing the embodiments of the disclosure.

In the afore-described embodiments of the disclosure, elements included in the disclosure are expressed in a singular or plural form according to the embodiments of the disclosure. However, the singular or plural form is appropriately selected for convenience of explanation and the disclosure is not limited thereto. As such, an element expressed in a plural form may also be configured as a single element, and an element expressed in a singular form may also be configured as plural elements.

The embodiments of the disclosure described with reference to the specification and the drawings are merely illustrative of specific examples to easily facilitate description and understanding of the disclosure, and are not intended to limit the scope of the disclosure. In other words, it will be apparent to one of ordinary skill in the art that other modifications based on the technical ideas of the disclosure are feasible. In addition, the embodiments of the disclosure may be combined to be implemented, when required. For example, the BS and the UE may be operated in a manner that portions of an embodiment of the disclosure are combined with portions of another embodiment of the disclosure. For example, the BS and the UE may be operated in a manner that portions of a first embodiment of the disclosure are combined with portions of a second embodiment of the disclosure. In addition, although the embodiments are described based on a frequency division duplexing (FDD) LTE system, modifications based on the technical scope of the embodiments may be applied to other communication systems, such as a time division duplexing (TDD) LTE system, a 5G or NR system, or the like.

The description order of the method of the disclosure as in the drawings may not exactly correspond to actual execution order, but may be performed reversely or in parallel.

In the drawings for describing the methods of the disclosure, some elements may be omitted and only some elements may be shown within a range that does not deviate the scope of the disclosure.

In the disclosure, a method may be performed by combining some or all of the contents included in each of the embodiments of the disclosure within the scope of the disclosure.

Various embodiments of the disclosure are described above. The aforementioned embodiments of the disclosure are merely for illustration, and are not limited thereto. It is obvious to one of ordinary skill in the art that the disclosure may be easily embodied in many different forms without changing the technical concept or essential features of the disclosure. The scope of the disclosure is defined by the appended claims, rather than defined by the aforementioned detailed descriptions, and all differences and modifications that can be derived from the meanings and scope of the claims and other equivalent embodiments therefrom will be construed as being included in the disclosure.

A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored. According to an embodiment of the disclosure, the method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)) or may be distributed (e.g., downloaded or uploaded) online through an application store or directly between two user apparatuses (e.g., smartphones). In a case of online distribution, at least a portion of the computer program product (e.g., a downloadable application) may be at least temporarily stored or temporarily generated in a machine-readable storage medium, such as a manufacturer's server, a server of an application store, or memory of a relay server.

According to various embodiments of the disclosure, an apparatus and method for effectively providing a service in a wireless communication system may be provided.

According to various embodiments of the disclosure, a method of configuring and simultaneously transmitting a plurality of UL channels with a phase tracking reference signal via a plurality of panels in a wireless communication system and an apparatus for performing the method may be provided.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RA M), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, via a radio resource control (RRC) signaling, information related to sounding reference signal (SRS) resource set and phase tracking reference signal (PTRS) uplink configuration information including a parameter indicating a maximum number of uplink (UL) PTRS ports;
receiving a downlink control information (DCI) format 0_1 including a SRS resource set indicator (SRSI) field and a first PTRS-demodulation reference signal (DMRS) association field;
when two SRS resource sets associated with a usage of value ‘nonCodeBook’ or ‘CodeBook’ are configured based on the information related to SRS resource set, determining a number of bits of the SRSI field as 2bits; and
based on the 2bits SRSI field and the parameter indicating the maximum number of ports, determining a number of bits of the first PTRS-DMRS association field as 1 bit or 2 bits.

2. The method of claim 1, wherein the number of bits of the first PTRS-DMRS association field is determined as 2 bits, when:
one PTRS port is configured based on the parameter indicating the maximum number of ports included in the PTRS uplink configuration information;
the SRSI field is present and equals “00” or “01”;
a maximum rank or a maximum number of multiple input multiple output (MIMO) layers configured for the UE is 2 or 3; and
a parameter related to multi panel scheme is not configured for the UE.

3. The method of claim 1, wherein the number of bits of the first PTRS-DMRS association field is determined as 2 bits, when:
one PTRS port is configured based on the parameter indicating the maximum number of ports included in the PTRS uplink configuration information;
the SRSI field is present and equals “10” or “11”;
a maximum rank or a maximum number of MIMO layers configured for the UE is 2; and
a parameter related to multi panel scheme is not configured for the UE.

4. The method of claim 3,
wherein a most significant bit (MSB) of the first PTRS-DMRS association field indicates an association between PTRS port and DMRS port corresponding to a first SRS resource indicator (SRI) and/or a first precoding information, and
wherein a least significant Bit (LSB) of the first PTRS-DMRS association field indicates an association between PTRS port and DMRS port corresponding to a second SRI and/or a second precoding information.

5. The method of claim 1, wherein the number of bits of the first PTRS-DMRS association field is determined as 2 bits, and a number of bits of a second PTRS-DMRS association field is determined as 2 bits, when:
one PTRS port is configured based on the parameter indicating the maximum number of ports included in the PTRS uplink configuration information;
the SRSI field is present and equals “10” or “11”;
a maximum rank or a maximum number of MIMO layers configured for the UE is 3; and
a parameter related to multi panel scheme is not configured for the UE.

6. The method of claim 5,
wherein the first PTRS-DMRS association field indicates an association between PTRS port and DMRS port corresponding to a first SRI and/or a first precoding information, and
wherein the second PTRS-DMRS association field indicates an association between PTRS port and DMRS port corresponding to a second SRI and/or a second precoding information.

7. The method of claim 1, wherein the number of bits of the first PTRS-DMRS association field is determined as 1 bit, when:
two PTRS ports are configured based on the parameter indicating the maximum number of ports included in the PTRS uplink configuration information;
the SRSI field is present and equals “00” or “01”;
a maximum rank or a maximum number of MIMO layers configured for the UE is 2 or 3; and
a parameter related to multi panel scheme is not configured for the UE.

8. The method of claim 1, wherein the number of bits of the first PTRS-DMRS association field is determined as 1 bit, and a number of bits of a second PTRS-DMRS association field is determined as 1 bit, when:
two PTRS ports are configured based on the parameter indicating the maximum number of ports included in the PTRS uplink configuration information;
the SRSI field is present and equals “10” or “11”;
a maximum rank or a maximum number of MIMO layers configured for the UE is 2 or 3; and
a parameter related to multi panel scheme is not configured for the UE.

9. The method of claim 8,
wherein the first PTRS-DMRS association field indicates an association between PTRS port and DMRS port corresponding to a first SRI and/or a first precoding information, and
wherein the second PTRS-DMRS association field indicates an association between PTRS port and DMRS port corresponding to a second SRI and/or a second precoding information.

10. A method performed by a base station in a wireless communication system, the method comprising:
transmitting, to a user equipment (UE), via a radio resource control (RRC) signaling, information related to sounding reference signal (SRS) resource set and phase tracking reference signal (PTRS) uplink configuration information including a parameter indicating a maximum number of uplink (UL) PTRS ports;
transmitting, to the UE, a downlink control information (DCI) format 0_1 including a SRS resource set indicator (SRSI) field and a first PTRS-demodulation reference signal (DMRS) association field;
when two SRS resource sets associated with a usage of value ‘nonCodeBook’ or ‘CodeBook’ are configured based on the information related to SRS resource set, determining a number of bits of the SRSI field as 2bits; and
based on the 2bits SRSI field and the parameter indicating the maximum number of ports, determining a number of bits of the first PTRS-DMRS association field as 1 bit or 2 bits.

11. A user equipment (UE) in a wireless communication system, the UE comprising:
memory storing a program or one or more instructions; and
at least one processor configured to execute the program or the one or more instructions to cause the UE to:
receive, from a base station, via a radio resource control (RRC) signaling, information related to sounding reference signal (SRS) resource set and phase tracking reference signal (PTRS) uplink configuration information including a parameter indicating a maximum number of UL PTRS ports,
receive a downlink control information (DCI) format 0_1 including a SRS resource set indicator (SRSI) field and a first PTRS-Demodulation Reference Signal (DMRS) association field,
when two SRS resource sets associated with a usage of value ‘nonCodeBook’ or ‘CodeBook’ are configured based on the information related to SRS resource set, determine a number of bits of the SRSI field as 2bits, and
based on the 2bits SRSI field and the parameter indicating the maximum number of ports, determine a number of bits of the first PTRS-DMRS association field as 1 bit or 2 bits.

12. The UE of claim 11, wherein the number of bits of the first PTRS-DMRS association field is determined as 2 bits, when:
one PTRS port is configured based on the parameter indicating the maximum number of ports included in the PTRS uplink configuration information;
the SRSI field is present and equals “00” or “01”;
a maximum rank or a maximum number of multiple input multiple output (MIMO) layers configured for the UE is 2 or 3; and
a parameter related to multi panel scheme is not configured for the UE.

13. The UE of claim 11, wherein the number of bits of the first PTRS-DMRS association field is determined as 2 bits, when:
one PTRS port is configured based on the parameter indicating the maximum number of ports included in the PTRS uplink configuration information;
the SRSI field is present and equals “10” or “11”;
a maximum rank or a maximum number of MIMO layers configured for the UE is 2; and
a parameter related to multi panel scheme is not configured for the UE.

14. The UE of claim 13,
wherein a most significant Bit (MSB) of the first PTRS-DMRS association field indicates an association between PTRS port and DMRS port corresponding to a first SRS resource indicator (SRI) and/or a first precoding information, and
wherein a least significant bit (LSB) of the first PTRS-DMRS association field indicates an association between PTRS port and DMRS port corresponding to a second SRI and/or a second precoding information.

15. The UE of claim 11, wherein the number of bits of the first PTRS-DMRS association field is determined as 2 bits, and a number of bits of a second PTRS-DMRS association field is determined as 2 bits, when:
one PTRS port is configured based on the parameter indicating the maximum number of ports included in the PTRS uplink configuration information;
the SRSI field is present and equals “10” or “11”;
a maximum rank or a maximum number of MIMO layers configured for the UE is 3; and
a parameter related to multi panel scheme is not configured for the UE.

16. The UE of claim 15,
wherein the first PTRS-DMRS association field indicates an association between PTRS port and DMRS port corresponding to a first SRI and/or a first precoding information, and
wherein the second PTRS-DMRS association field indicates an association between PTRS port and DMRS port corresponding to a second SRI and/or a second precoding information.

17. The UE of claim 11, wherein the number of bits of the first PTRS-DMRS association field is determined as 1 bit, when:
two PTRS ports are configured based on the parameter indicating the maximum number of ports included in the PTRS uplink configuration information;
the SRSI field is present and equals “00” or “01”;
a maximum rank or a maximum number of MIMO layers configured for the UE is 2 or 3; and
a parameter related to multi panel scheme is not configured for the UE.

18. The UE of claim 11, wherein the number of bits of the first PTRS-DMRS association field is determined as 1 bit, and a number of bits of a second PTRS-DMRS association field is determined as 1 bit, when:
two PTRS ports are configured based on the parameter indicating the maximum number of ports included in the PTRS uplink configuration information;
the SRSI field is present and equals “10” or “11”;
a maximum rank or a maximum number of MIMO layers configured for the UE is 2 or 3; and
a parameter related to multi panel scheme is not configured for the UE.

19. The UE of claim 18,
wherein the first PTRS-DMRS association field indicates an association between PTRS port and DMRS port corresponding to a first SRI and/or a first precoding information, and
wherein the second PTRS-DMRS association field indicates an association between PTRS port and DMRS port corresponding to a second SRI and/or a second precoding information.

20. A base station in a wireless communication system, the base station comprising:
memory storing a program or one or more instructions; and
at least one processor configured to execute the program or the one or more instructions to cause the base station to:
transmit, to a user equipment (UE), via a radio resource control (RRC) signaling, information related to sounding reference signal (SRS) resource set and phase tracking reference signal (PTRS) uplink configuration information including a parameter indicating a maximum number of uplink (UL) PTRS ports,
transmit, to the UE, a downlink control information (DCI) format 0_1 including a SRS resource set indicator (SRSI) field and a first PTRS-demodulation reference signal (DMRS) association field,
when two SRS resource sets associated with a usage of value ‘nonCodeBook’ or ‘CodeBook’ are configured based on the information related to SRS resource set, determine a number of bits of the SRSI field as 2bits, and
based on the 2bits SRSI field and the parameter indicating the maximum number of ports, determine a number of bits of the first PTRS-DMRS association field as 1 bit or 2 bits.
